(19) United States
(12) Patent Application Publication
(10) Pub. No.: US 2021/0028452 A1
(43) Pub. Date: Jan. 28, 2021

(54) RECHARGEABLE BATTERY USING IRON NEGATIVE ELECTRODE AND MANGANESE OXIDE POSITIVE ELECTRODE

(71) Applicant: FORM ENERGY INC.,, Somerville, MA (US)

(72) Inventors: Liang SU, Medfield, MA (US); Jarrod David MILSHTEIN, Cambridge, MA (US); William Henry WOODFORD, Cambridge, MA (US); Yet-Ming CHIANG, Weston, MA (US); Jay WHITACRE, Pittsburgh, PA (US); Lucas COHEN, Newtown, PA (US); Rupak CHAKRABORTY, Brookline, MA (US); Andrew Haynes LIOTTA, Cambridge, MA (US); Ian Salmon MCKAY, Seattle, WA (US); Thomas CONRY, San Francisco, CA (US); Michael Andrew GIBSON, Philadelphia, PA (US); Jocelyn Marie NEWHOUSE, Somerville, MA (US); Amelie Nina KHAREY, Cambridge, MA (US); Annelise Christine THOMPSON, Medford, MA (US); Weston SMITH, Boston, MA (US); Joseph Anthony PANTANO, Canton, MA (US); Isabella CARUSO, Cambridge, MA (US); Benjamin Thomas HULTMAN, Somerville, MA (US); Max Rae CHU, Brookline, MA (US); Nicholas PERKINS, Cambridge, MA (US); Florian WEHNER, Brookline, MA (US); Rebecca EISENACH, Somerville, MA (US); Mitchell Terrance WESTWOOD, Cambridge, MA (US); Tristan GILBERT, Evergreen, CO (US); Rachel Elizabeth MUMMA, Somerville, MA (US); Brandon UBER, Boston, MA (US); Eric WEBER, Pittsburgh, PA (US); Danielle Cassidy SMITH, Cambridge, MA (US); Brooke WOJESKI, Somerville, MA (US)

(21) Appl. No.: 16/938,924

(22) Filed: Jul. 25, 2020

Related U.S. Application Data
(60) Provisional application No. 62/879,126, filed on Jul. 26, 2019.
(60) Provisional application No. 62/879,153, filed on Jul. 26, 2019.
(60) Provisional application No. 63/021,267, filed on May 7, 2020.
(60) Provisional application No. 63/021,566, filed on May 7, 2020.
(60) Provisional application No. 63/021,610, filed on May 7, 2020.

(51) Int. Cl. H01M 4/505; H01M 4/131; H01M 4/58; H01M 4/36; H01M 4/525; H01M 4/134; H01M 4/133; H01M 4/62; H01M 4/38; H01M 10/0525

(52) U.S. Cl. CPC H01M 4/505; H01M 4/131; H01M 4/58; H01M 4/364; H01M 4/525; H01M 2004/021; H01M 4/133; H01M 4/623; H01M 4/382; H01M 10/0525; H01M 4/134

(57) ABSTRACT

Materials, designs, and methods of fabrication for iron-manganese oxide electrochemical cells are disclosed. In various embodiments, the negative electrode is comprised of pelletized, briquetted, or pressed iron-bearing components, including metallic iron or iron-based compounds (oxides, hydroxides, sulfides, or combinations thereof), collectively called “iron negative electrode.” In various embodiments, the positive electrode is comprised of pelletized, briquetted, or pressed manganese-bearing components, including manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or combinations thereof, collectively called “manganese oxide positive electrode.” In various embodiments, electrolyte is comprised of aqueous alkali metal hydroxide including lithium hydroxide (LiOH), sodium hydroxide (NaOH), potassium hydroxide (KOH), cesium hydroxide (CsOH), or combinations thereof. In various embodiments, battery components are assembled in prismatic configuration or cylindrical configuration.

### RELATED APPLICATIONS

This application claims the benefit of priority to U.S. Provisional Patent Application No. 62/879,153 entitled “Rechargeable Battery Using Iron Negative Electrode and Manganese Oxide Positive Electrode” filed Jul. 26, 2019 and U.S. Provisional Patent Application No. 63/021,267 entitled “Rechargeable Battery Using Iron Negative Electrode and Manganese Oxide Positive Electrode” filed May 7, 2020 and the entire contents of both applications are hereby incorporated by reference for all purposes. This application also claims the benefit of priority to U.S. Provisional Patent Application No. 62/879,126 entitled “Low Cost Metal Electrodes” filed Jul. 26, 2019 and U.S. Provisional Patent Application No. 63/021,566 entitled “Low Cost Metal Electrodes” filed May 7, 2020 and the entire contents of both applications are hereby incorporated by reference for all purposes. This application also claims the benefit of priority to U.S. Provisional Patent Application No. 63/021,610 entitled “Iron-Bearing Electrodes for Electrochemical Cells” filed May 7, 2020 the entire contents of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

### SUMMARY

Materials, designs, and methods of fabrication for iron-manganese oxide electrochemical cells are disclosed. In various embodiments, the negative electrode is comprised of pelletized, briquetted, pressed or sintered iron-bearing components, including metallic iron or iron-based compounds (oxides, hydroxides, sulfides, or combinations thereof), collectively called “iron negative electrode.” In various embodiments, the positive electrode is comprised of pelletized, briquetted, pressed or sintered manganese-bearing components, including manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or combinations thereof, collectively called “manganese oxide positive electrode.” In various embodiments, electrolyte is comprised of aqueous alkali metal hydroxide including lithium hydroxide (LiOH), sodium hydroxide (NaOH), potassium hydroxide (KOH), cesium hydroxide (CsOH), or combinations thereof. In various embodiments, battery components are assembled in prismatic configuration or cylindrical configuration. In various embodiments, a separator may be added.

Materials, designs, and methods of fabrication for electrodes for electrochemical cells are disclosed. In various embodiments, the electrode comprises iron.

Various embodiments include a battery, comprising: a first electrode, comprising a manganese oxide; an electrolyte; and a second electrode, comprising iron. In some embodiments, the iron comprises direct reduced iron (DRI). In some embodiments, the electrolyte is a liquid electrolyte. In some embodiments, the electrolyte comprises an alkali metal hydroxide comprising lithium hydroxide (LiOH), sodium hydroxide (NaOH), potassium hydroxide (KOH), cesium hydroxide (CsOH), or mixtures thereof. In some embodiments, the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof. In some embodiments, the second electrode is pelletized and comprises a multimodal distribution. In some embodiments, the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof. In some embodiments, the second electrode further comprises iron oxides, hydroxides, sulfides or mixtures thereof. In some embodiments, the second electrode further comprises one or more secondary phases including silica (SiO₂) or silicates, calcium oxide (CaO), magnesium oxide (MgO) or mixtures thereof. In some embodiments, the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof. In some embodiments, the second electrode further comprises one or more hydrogen evolution reaction suppressants. In some embodiments, the first electrode has a specific surface area less than about 50 m²/g. In some embodiments, the first electrode has a specific surface area less than about 1 m²/g. In some embodiments, the second electrode has a specific surface area less than about 5 m²/g. In some embodiments, the second electrode has a specific surface area less than about 1 m²/g. In some embodiments, the first electrode comprises a binder comprising polytetrafluoroethylene (PTFE), polyvinylidene difluoride (PVdF), polypropylene (PP), polyethylene (PE), fluorinated ethylene propylene (FEP), polyacrylonitrile, styrene butadiene rubber, carboxymethyl cellulose (CMC), sodium carboxymethyl cellulose (Na-CMC), polyvinyl alcohol (PVA), polypyrrole (PPy), or combinations thereof. In some embodiments, the first electrode comprises an additive comprising bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof. In some embodiments, a separator material is used between the first electrode and the second electrode. In some embodiments, the iron comprises concentrate. In some embodiments, the iron comprises at least one form of iron selected from the group consisting of pellets, BF grade pellets, DR grade pellets, hematite, magnetite, wustite, martite, goethite, limonite, siderite, pyrite, ilmenite, or spinel manganese ferrite. In some embodiments, the iron comprises iron ore. In some embodiments, the iron ore comprises at least 0.1% SiO₂ by mass. In some embodiments, the iron ore comprises at least 0.1% CaO by mass. In some embodiments, the iron comprises atomized iron powder. In some embodiments, the iron comprises iron agglomerates. In some embodiments, the iron agglomerates have an average length ranging from about 50 um to about 50 mm. In some embodiments, the iron agglomerates have an average internal porosity ranging from about 10% to about 90% by volume. In some embodiments, the iron agglomerates have an average specific surface area ranging from about 0.1 m²/g to about 25 m²/g. In some embodiments, the electrolyte comprises a molybdate anion and a sulfide anion. In various embodiments, the various embodiment batteries may be included in a stack of one or more batteries of a bulk energy storage system. In various embodiments, the bulk energy storage system is a long duration energy storage (LODES) system. Various embodiments may include methods of making batteries comprising: providing a first electrode, comprising a manganese oxide; providing an electrolyte; and providing a second electrode, comprising iron.

### DESCRIPTION OF THE DRAWINGS

FIG. 1A is a schematic of an electrochemical cell, according to various embodiments of the present disclosure with prismatic configuration.

FIG. 1B is a schematic of stacked configuration based on a disclosed electrochemical cell of FIG. 1A.

FIG. 1C is a schematic of stacked configuration using bipolar current collectors connecting electrochemical repeating units.

FIGS. 2A and 2B are schematics of hydrogen recombination electrodes.

FIGS. 2C, 2D, 2E, and 2F are schematics of various arrangements of hydrogen recombination electrodes in a cell.

FIG. 3A is a schematic of the proof-of-concept cell using about 1.3 g iron power as the negative electrode and about 0.8 g positive electrode with about 78 wt % MnO₂.

FIG. 3B is a plot of the cycling data (cell voltage vs. time) and the capacity curve (cell voltage vs. capacity) of selected cycles using the proof-of-concept cell setup in FIG. 3A.

FIG. 3C is a plot of the MnO₂ discharge capacity (mAh/g_{MnO2}) on the left Y-axis and the coulombic efficiency on the right Y-axis at different cycles.

FIG. 3D is a plot of the beginning-of-life (BOL) polarization data (current density vs. positive electrode potential) using the proof-of-concept cell setup in FIG. 3A.

FIG. 3E is the 2nd cycle charge-discharge curves (full cell voltage vs. capacity) of the proof-of-concept EMD/DRI cell.

FIG. 4A is a schematic of stacked prismatic electrochemical cells using pelletized direct reduced iron (DRI) as the negative electrode and a manganese compound based positive electrode based on the stacked configuration of FIG. 1B.

FIG. 4B is a schematic of an electrochemical cell, according to various embodiments of the present disclosure with a cylindrical configuration using pelletized direct reduced iron (DRI) as the negative electrode and a manganese compound based positive electrode.

FIG. 5 illustrates a negative electrode according to various embodiments.

FIG. 6A illustrates an example discharge method.

FIGS. 6B and 6C illustrate aspects of an electrode divided up into horizontal layers contained in a larger vessel.

FIG. 6D illustrates a metal textile with an electrode composed of direct reduced iron pellets.

FIGS. 6E and 6F illustrate example porous mesh container aspects.

FIG. 7 illustrates an example backing plate.

FIG. 8 fastening rail may also serve as a bus bar

FIG. 9 illustrates a direct reduced iron (DRI) marble bed assembly.

FIG. 10 illustrates a module consisting of a rigid side walls.

FIGS. 11A and 11B show fastening techniques according to various embodiments.

FIG. 12 illustrates an expanding material contained within a rigid iron electrode containment assembly.

FIG. 13 illustrates thermal bonding.

FIG. 14 illustrates mechanical interactions of pellets.

FIG. 15 illustrates pellet beds.

FIG. 16 illustrates example current collectors.

FIG. 17 illustrates a mechanically processed pellet.

FIG. 18 compares discharge product distributions.

FIG. 19 is a temperature plot.

FIG. 20 illustrates one example method of evacuating pores.

FIG. 21 illustrates example additive holder configurations.

FIG. 22 illustrates an example additive incorporation process.

FIG. 23 illustrates an electrode formation process.

FIGS. 24-32 illustrate various example systems in which one or more aspects of the various embodiments may be used as part of bulk energy storage systems.

### DETAILED DESCRIPTION

The following examples are provided to illustrate various embodiments of the present systems and methods of the present inventions. These examples are for illustrative purposes, may be prophetic, and should not be viewed as limiting, and do not otherwise limit the scope of the present inventions.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” and the symbol “˜” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

As used herein, unless specified otherwise the terms %, weight % and mass % are used interchangeably and refer to the weight of a first component as a percentage of the weight of the total, e.g., formulation, mixture, particle, pellet, agglomerate, material, structure or product. As used herein, unless specified otherwise “volume %” and “% volume” and similar such terms refer to the volume of a first component as a percentage of the volume of the total, e.g., formulation, mixture, particle, pellet, agglomerate, material, structure or product.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A′, C and D can be used with each other in various combination, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

As used herein, unless specified otherwise, the terms specific gravity, which is also called apparent density, should be given their broadest possible meanings, and generally mean weight per unit until volume of a structure, e.g., volumetric shape of material. This property would include internal porosity of a particle as part of its volume. It can be measured with a low viscosity fluid that wets the particle surface, among other techniques.

As used herein, unless specified otherwise, the terms actual density, which may also be called true density, should be given their broadest possible meanings, and general mean weight per unit volume of a material, when there are no voids present in that material. This measurement and property essentially eliminates any internal porosity from the material, e.g., it does not include any voids in the material.

Thus, a collection of porous foam balls (e.g., Nerf® balls) can be used to illustrate the relationship between the three density properties. The weight of the balls filling a container would be the bulk density for the balls:

$$Bulk Density = \frac{weight of balls}{volume of container filled}$$

The weight of a single ball per the ball's spherical volume would be its apparent density:

$$Apparent Density = \frac{weight of one ball}{volume of that ball}$$

The weight of the material making up the skeleton of the ball, i.e., the ball with all void volume removed, per the remaining volume of that material would be the skeletal density:

$$Skeletal Density = \frac{weight of material}{volume of void free material}$$

As used herein, unless specified otherwise, the term agglomerate and aggregate should be given their broadest possible meanings, and in general mean assemblages of particles in a powder.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when the sunshine is plentiful and solar power generation exceeds power grid requirements, and discharge the stored energy during the winter months, when the sunshine may be insufficient to satisfy power grid requirements.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

According to various embodiments, an electrochemical cell includes a negative electrode, a positive electrode, and an electrolyte. The negative electrode may be an iron material. The positive electrode may be a manganese oxide material. The electrolyte may be an aqueous solution. In certain embodiments the electrolyte may be an alkaline solution (pH>10). In certain embodiments, the electrolyte may be a near-neutral solution (10>pH>4).

According to various embodiments, the half-cell reactions on the negative electrode as occurring on discharge are:

Fe⁰⇄Fe(II)+2e⁻

Fe(II)⇄Fe(III)+e⁻

In one example, half-cell reactions on the negative electrode as occurring on discharge are Fe+2OH⁻⇄Fe(OH)₂+2e⁻ and 3Fe(OH)₂+2OH⁻⇄Fe₃O₄ +4H₂O+2e⁻. The theoretical capacity on the basis of metallic iron according to the negative electrode reactions in this example is 1276 mAh/gFe. During charge, the reversed reactions occur.

According to various embodiments, the possible half-cell reactions on the positive electrode as occurring on discharge are:

Mn(IV)+e⁻⇄Mn(III)

Mn(III)+e⁻⇄Mn(II)

In one example, half-cell reactions on the positive electrode as occurring on discharge are MnO₂+e⁻+H₂O⇄MnOOH+OH⁻ and MnOOH+e⁻+H₂O⇄Mn(OH)₂+OH⁻. The theoretical capacity on the basis of MnO₂ according to the negative electrode reactions in this example is 616 mAh/g_{MnO2}. During charge, the reversed reactions occur.

According to various embodiments, hydroxide anions (OH⁻) are the working ions. In some embodiments, both hydroxide anions and alkali metal cations are the working ions. In other words, the simultaneous migration of hydroxide anions and alkali metal cations along opposite directions carries the ionic current.

In some embodiments, the nominal cell voltage is about 1.2V if the predominant negative electrode reaction is between Fe⁰ and Fe (II) (Mechanism F1) and the predominant positive electrode reaction is between Mn(IV) to Mn(III) (Mechanism M1). In some embodiments, the nominal cell voltage is about 1.0V if the predominant negative electrode reaction is occurring between Fe (II) and Fe (III) (Mechanism F2) and the predominant positive electrode reaction is between Mn(IV) to Mn(III) (Mechanism M1). In some embodiments, the nominal cell voltage is about 0.8V if the predominant negative electrode reaction is between Fe⁰ and Fe (II) (Mechanism F1) and the predominant positive electrode reaction is between Mn(III) to Mn(II) (Mechanism M2). In some embodiments, the nominal cell voltage is about 0.6V if the predominant negative electrode reaction is occurring between Fe (II) and Fe (III) (Mechanism F2) and the predominant positive electrode reaction is between Mn(III) to Mn(II) (Mechanism M2). In certain embodiments, the nominal cell voltage is about 1.0V, or other values between 1.2V and 0.6V, when both Mechanisms F1 and F2 are occurring simultaneously or sequentially on the negative electrode and both Mechanisms M1 and M2 are occurring simultaneously or sequentially on the positive electrode. The residual cell resistance may further decrease the discharge cell voltage under load.

According to various embodiments, the major side reaction on the negative electrode during charge is hydrogen evolution reaction (HER). According to various embodiments, the major side reactions on the positive electrode during charge is oxygen evolution reaction (OER) or carbon oxidation (corrosion) reaction. One key advantage of the Fe—MnO₂ cell is these “self-balancing” side reactions, which significantly mitigate the thermal runaway concerns in the event of a broken negative electrode and/or a broken positive electrode during charge or overcharge. In some embodiments, the positive reaction during charge is Mn(II) to Mn(III) and/or Mn(III) to Mn(IV) and the negative reaction during charge is HER if the iron-based negative electrode materials cannot be charged normally. In some embodiments, the negative reaction during charge is Fe(III) to Fe(II) and/or Fe(II) to Fe⁰ and the positive reaction during charge is OER if the manganese-based positive electrode materials cannot be charged normally. In some embodiments, the positive reaction during charge is OER and the negative reaction during charge is HER if the manganese based positive electrode and the iron based negative electrode cannot be charged normally.

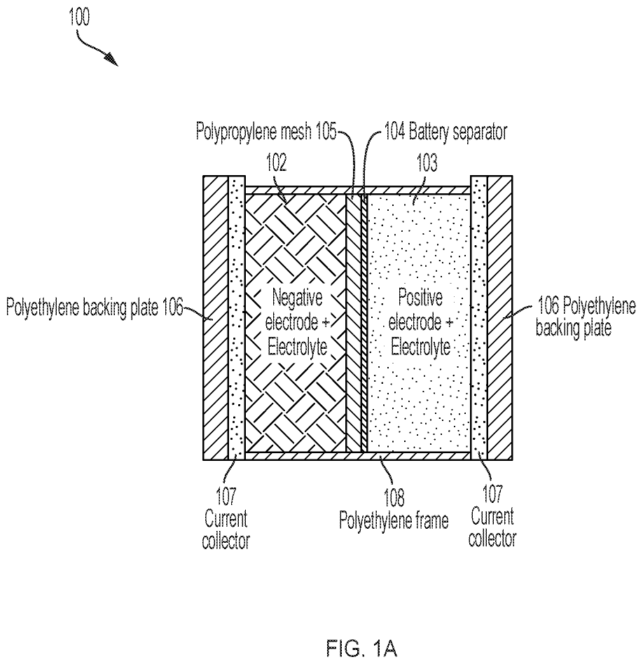

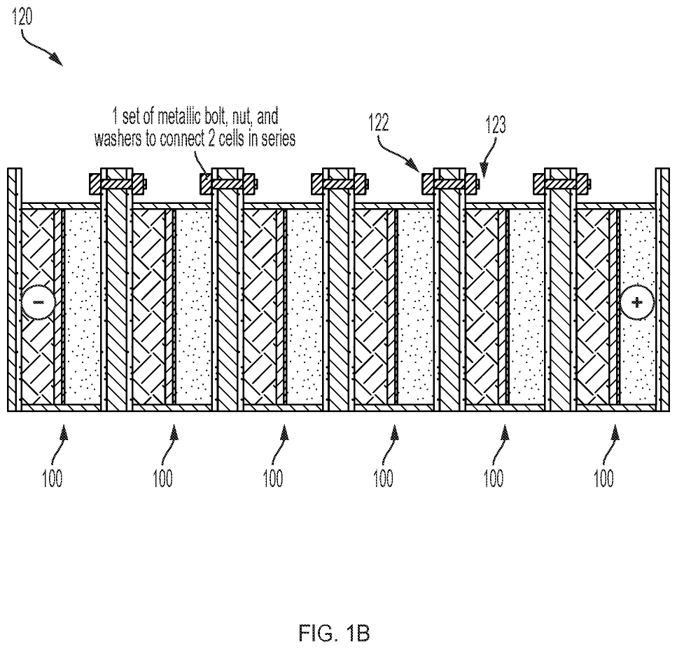

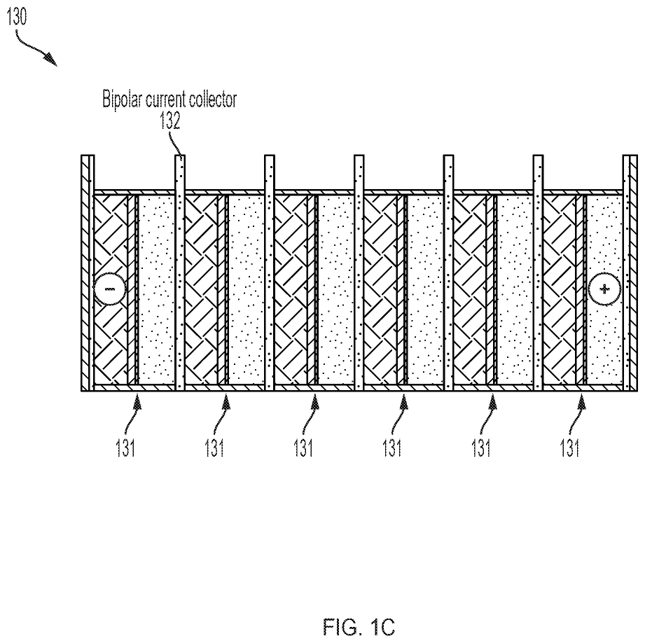

In some embodiments, an electrochemical cell includes a negative electrode, a positive electrode, an electrolyte, and a separator disposed between the positive electrode and the negative electrode (for example as shown in FIG. 1A). FIG. 1A illustrates an electrochemical cell 100 including a negative electrode and electrolyte 102 separated from a positive electrode and electrolyte 103 by a separator 104. The separator 104 may be supported by a polypropylene mesh 105 and a polyethylene frame 108 of the cell 100. Current collectors 107 may be associated with respective ones of the negative electrode 102 and positive electrode 103 and supported by polyethylene backing plates 106.

In some embodiments, a plurality of electrochemical cells 100 in FIG. 1A may be connected electrically in series to form a stack 120, for example as shown in FIG. 1B. For example, cells 100 may be connected in series by metallic bolts 122 passing through the current collectors 107 and polyethylene backing plates 106 secured by metallic nuts 123 to connect one cell 100 to the next cell 100. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

In some embodiments, adjacent electrochemical cells 100 are physically and electrically connected using a set of metallic bolt, nut, and washers as described above (e.g., bolts 122 and nuts 123). In some embodiments, the metallic bolt, nut, washers are stainless steel, carbon steel, aluminum, copper, or combinations thereof. In some embodiments, adjacent electrochemical cells 100 are physically and electrically connected using metallic tabs. In some embodiments, the metallic tabs are connected by welding, brazing or other common metal joining techniques. In some embodiments, adjacent electrochemical cells, such as cells 131, in a stack 130 are electrically connected using bipolar current collectors 132, for example as shown in FIG. 1C. The cells 131 may be similar to cells 100, except that the current collectors 132 may be bipolar current collectors and there may be no polyethylene backing plates 106 between respective cells. In some embodiments, adjacent electrochemical cells 100 in a stack 120 are electrically connected using monopolar current collectors 107, for example as shown in FIG. 1B.

In various embodiments, the cell architecture is in a prismatic shape, for example as shown in FIG. 1A. In some embodiments, the cells are hermetically sealed. In some embodiments, the hermetically sealed cell contains a venting port for gas exchange. In a non-limiting example, the gas may be hydrogen that has evolved on the negative electrode at hydrogen evolution reaction potentials. In some embodiments, the cells are covered with a removable lid.

In various embodiments, the cell architecture is in a cylindrical shape, for example as shown in FIG. 1B. In some embodiments, the cells are hermetically sealed. In some embodiments, the hermetically sealed cell contains a venting port for gas exchange. In a non-limiting example, the gas may be hydrogen that has evolved on the negative electrode at hydrogen evolution reaction potentials. In some embodiments, the cells are covered with a movable lid.

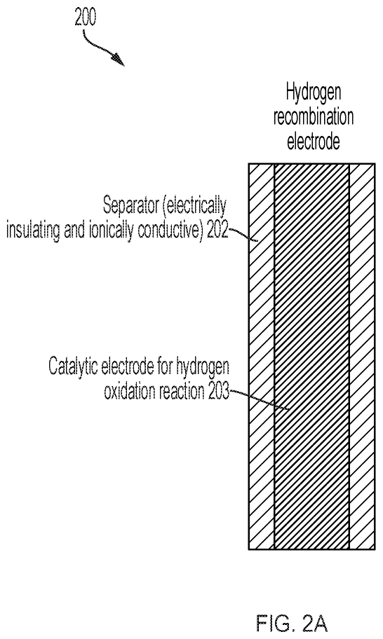

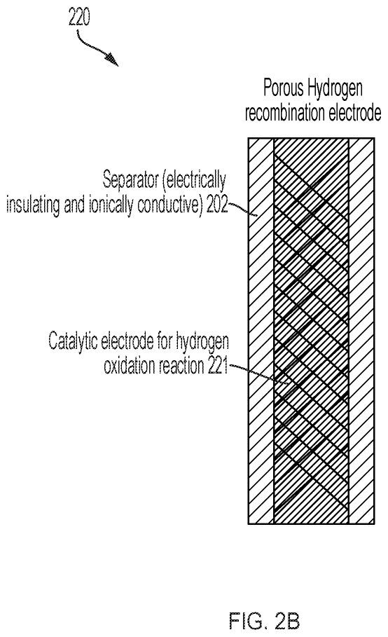

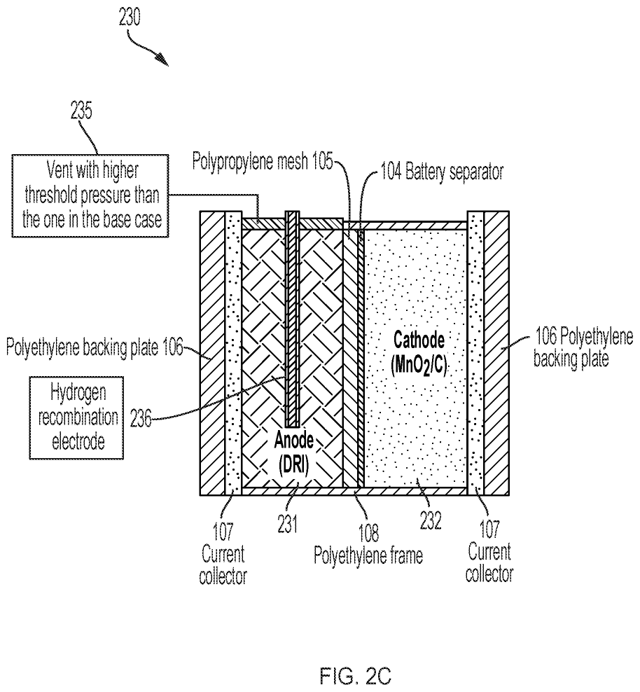

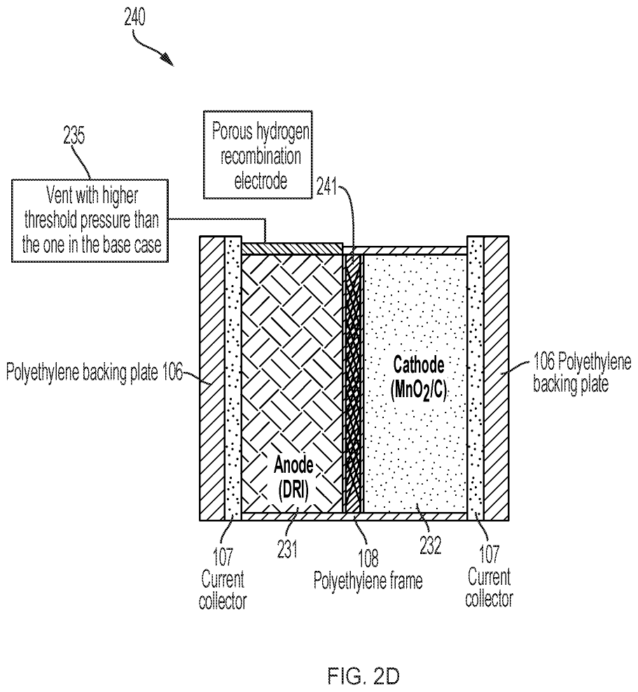

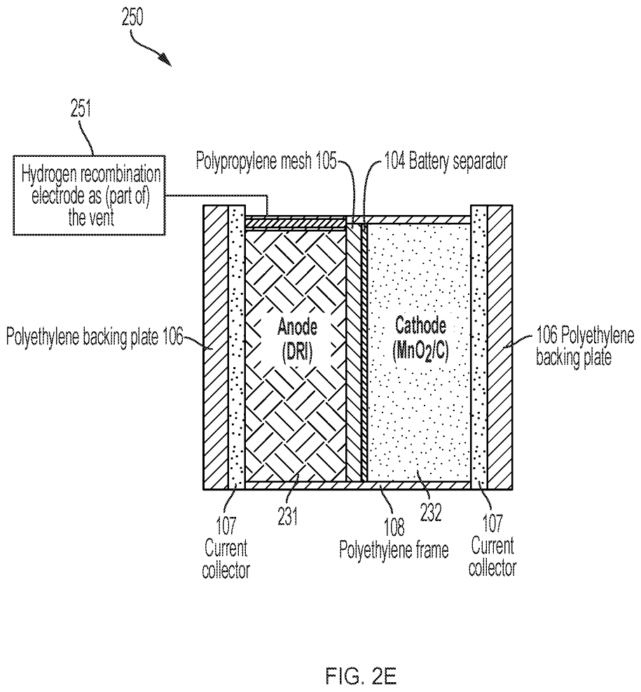

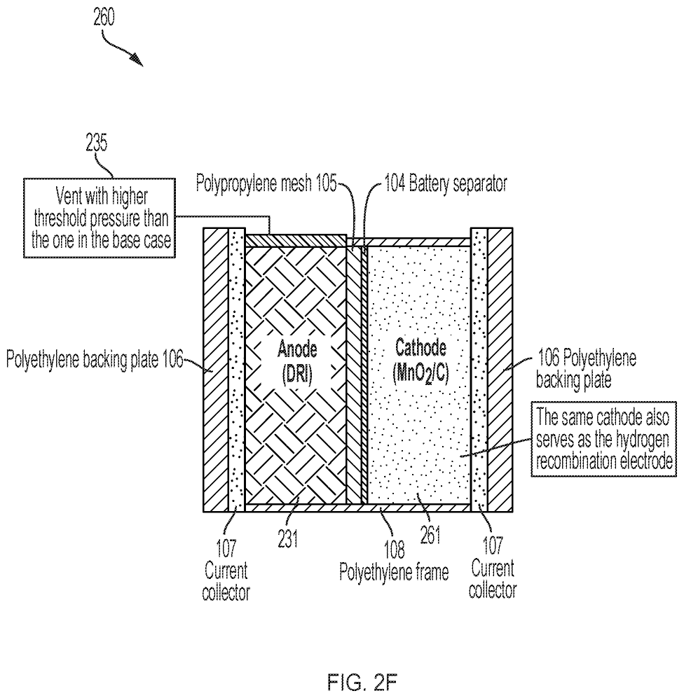

In some embodiments, a hydrogen recombination electrode is placed in the vicinity of the negative electrode (for example as shown in FIGS. 2A-2F).

According to various embodiments, the negative electrode is comprised of pelletized, briquetted, pressed or sintered iron-bearing compounds. Such iron-bearing compounds may comprise one or more forms of iron, ranging from highly reduced (more metallic) iron to highly oxidized (more ionic) iron. In various embodiments, the pellets may include various iron compounds, such as iron oxides, hydroxides, sulfides, or combinations thereof. In various embodiments, the pellets may include one or more secondary phases, such as silica (SiO₂) or silicates, calcium oxide (CaO), magnesium oxide (MgO), etc. In various embodiments, said negative electrode may be sintered iron agglomerates with various shapes. In some embodiments, atomized or sponge iron powders can be used as the feedstock material for forming sintered iron electrodes. In some embodiments, the green body may further contain a binder such as a polymer or inorganic clay-like material. In various embodiments, sintered iron agglomerate pellets may be formed in a furnace, such as a continuous feed calcining furnace, batch feed calcining furnace, shaft furnace, rotary calciner, rotary hearth, etc. In various embodiments, pellets may comprise forms of reduced and/or sintered iron-bearing precursors known to those skilled in the art as direct reduced iron (DRI), and/or its byproduct materials. Various embodiments may include processing pellets, including DRI pellets, using electrical, electrochemical, mechanical, chemical, and/or thermal processes before introducing the pellets into the electrochemical cell.

Various embodiments are discussed in relation to the use of direct reduced iron (DRI) as a material of a battery (or cell), as a component of a battery (or cell) and combinations and variations of these. In various embodiments, the DRI may be produced from, or may be, material which is obtained from the reduction of natural or processed iron ores, without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal (Fe⁰), wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 1 below. As used in the Specification, including Table 1, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass.

TABLE 1

| Material Property | Embodiment Range |
|---|---|
| Specific surface area* | 0.19-0.46 m²/g as received or |
| | 0.19-18 m²/g after performing |
| | a pre-charge formation step |
| True density (as determined by helium (He) | 4.6-7.1 g/cc |
| gas pycnometry) | |
| Porosity | 5-70% |
| Minimum d_{pore, 90% volume}** | 50 nm-50 μm |
| Minimum dpore, 50% surface area*** | 1 nm-10 μm |
| Total Fe (wt %) | 69.9-89.8% |
| Metallic Fe (wt %) | 46.5-85% |
| Metallization (%) | 59.5-96% |
| Carbon (wt %) | <<3.7% |
| Fe²⁺ (wt %) | 1-9% |
| Fe³⁺ (wt %) | 0.9-25% |
| SiO₂ (wt %) | 2-15% |
| Ferrite (wt %, XRD) | 22-97% |
| Wustite (FeO, wt %, XRD) | 0-13% |
| Goethite (FeOOH, wt %, XRD) | 0-23% |
| Cementite (Fe₃C, wt %, XRD) | <<80% |

*As preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (BOMB) adsorption, electrokinetic analysis of complex-ion adsorption’ and a Protein Retention (PR) method may be employed to provide results that can be correlated with BET results
**90% of the pore volume is in pores of diameter greater than d_{pore, 90% volume}.
***50% of free surface area is in pores of diameter greater than dpore, 50% surface area.

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 1A.

TABLE 1A

| | | | | |
|---|---|---|---|---|
| Fe total (wt %) | >50% | >60% | >65% | ~67-69% |
| SiO₂ (wt %) | <2% | <1.5% | <1% | 1.6-0.9% |
| CaO (wt %) | <1.6% | <1% | <0.9% | 1.5-0.8% |
| Cold crushing | >100 | >150 | ~125-275 | ~280 to ~340 |
| Strength^{!} | | | | |
| (daN/p) (where | | | | |
| 1 daN = 10 | | | | |
| N = 1.02 kp) | | | | |
| Cold crush | No more than | No more than | No more than | No more than |
| strength | 10% having | 5% having cold | ~20% having | ~10% having |
| distribution in | cold crush | crush strength | cold crush | cold crush |
| particle | strength below | below 150 daN | strength below | strength below |
| population^{!!} | 200 daN | | average daN | average daN |
| Size (largest | <10 mm | ~5-20 mm | ~10 to ~25 mm | >25 mm |
| cross-sectional | | | | |
| distance, e.g. | | | | |
| for a sphere the | | | | |
| diameter) | | | | |
| Fines | <10% | <5% | 0 to ~15% | <35% |
| Actual Density | ~5 | 4.9-5.3 | ~4.0 to ~6.5 | <7.8 |
| g/cm³ | | | | |
| Apparent | ~3.6 | 2-5 | ~3.4 to ~3.9 | <10 |
| Density g/cm³ | | | | |
| Porosity (%) | >15 | ~20-90 | ~25 to ~35 | >50 |

^{!}Preferably, as determined by ISO 4700:20073 the entire disclosure of which is incorporated herein by reference.
^{!!}Preferably, as determined by ISO 4700:2007 the entire disclosure of which is incorporated herein by reference.

The properties set forth in Table 1, may also be present in embodiments with, in addition to, or instead of the properties in Table 1A. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. Iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 2 below. The use of reduced BF grade DRI may be advantageous due to the lesser input energy required to produce the pellet, which translates to a lower cost of the finished material.

TABLE 2

| Material Property | Embodiment Range |
|---|---|
| Specific surface area* | 0.21-0.46 m²/g as received or |
| | 0.21-18 m²/g after performing a |
| | pre-charge formation step |
| True density (as determined by | 5.5-6.7 g/cc |
| helium (He) gas pycnometry) | |
| Porosity | 57-71% |
| Minimum d_{pore, 90% volume}^{**} | 50 nm-0 μm |
| Minimum dpore, 50% surface area*** | 1 nm-10 μm |
| Total Fe (wt %) | 81.8-89.2% |
| Metallic Fe (wt %) | 68.7-83.2% |
| Metallization (%) | 84-95% |
| Carbon (wt %) | 0.03-0.35% |
| Fe²⁺ (wt %) | 2-8.7% |
| Fe³⁺ (wt %) | 0.9-5.2% |
| SiO₂ (wt %) | 5.5-6.7% |
| Ferrite (wt %, XRD) | 80-96% |
| Wustite (FeO, wt %, XRD) | 2-13% |
| Goethite (FeOOH, wt %, XRD) | 0-11% |
| Cementite (Fe₃C, wt %, XRD) | 0-80% |

*As preferably determined by the Brunauer-Emmett-Teller adsorption method (“BET”), and more preferably as the BET is set forth in ISO 9277 (the entire disclosure of which is incorporated herein by reference), recognizing that other tests, such as methylene blue (MB) staining, ethylene glycol monoethyl ether (EGME) adsorption, electrokinetic analysis of complex-ion adsorption’ and a Protein Retention (PR) method may be employed to provide results that can be correlated with BET results.
^{**}90% of the pore volume is in pores of diameter greater than d_{pore, 90% volume}.
***50% of free surface area is in pores of diameter greater than dpore, 50% surface area.

The properties set forth in Table 2, may also be present in embodiments with, in addition to, or instead of the properties in Tables 1 and/or 1A. Greater and lesser values for these properties may also be present in various embodiments.

In certain embodiments the DRI may be produced by the reduction of a DR Grade pellet, in which case the resulting DRI may have material properties as described in Table 3 below. The use of reduced DR grade DRI may be advantageous due to the higher Fe content in the pellet which increases the energy density of the battery.

TABLE 3

| Material Property | Embodiment Range |
|---|---|
| Specific surface area* | 0.1-0.7 m²/g as received or |
| | 0.19-25 m²/g after performing a |
| | pre-charge formation step |
| True density (as determined by | 4.6-7.1 g/cc |
| helium (He) gas pycnometry) | |
| Porosity | 51-80% |
| Minimum d_{pore, 90% volume}^{**} | 50 nm-50 μm |
| Minimum dpore, 50% surface area*** | 1 nm-10 μm |
| Total Fe (wt %) | 80-94% |
| Metallic Fe (wt %) | 64-94% |
| Metallization (%) | 80-100% |
| Carbon (wt %) | <<3.7% |
| Fe²⁺ (wt %) | 0-8% |
| Fe³⁺ (wt %) | 0-10% |
| SiO₂ (wt %) | 0-4% |
| Ferrite (wt %, XRD) | 22-80% |
| Wustite (FeO, wt %, XRD) | 0-13% |
| Goethite (FeOOH, wt %, XRD) | 0-23% |
| Cementite (Fe₃C, wt %, XRD) | <<80% |

*As preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption’ and a Protein Retention (PR) method may be employed to provide results that can be correlated with BET results,
^{**}90% of the pore volume is in pores of diameter greater than d_{pore, 90% volume}.
***50% of free surface area is in pores of diameter greater than dpore, 50% surface area.

The properties set forth in Table 3, may also be present in embodiments with, in addition to, or instead of the properties in Tables 1, 1A, and/or 2. Greater and lesser values for these properties may also be present in various embodiments.

In various embodiments, a bed of conductive pellets comprise (e.g., function to provide, are a component of, constitute, etc.) an electrode in an energy storage system. In embodiments of this electrode the pellets comprise, an iron containing material, a reduced iron material, iron in a non-oxidized state, iron in a highly oxidized state, iron having a valence state between 0 and 3+ and combinations and variations of these. In embodiments of this electrode the pellets comprise iron having one or more of the features set forth in Tables 1, 1A, 2, and 3. In embodiments the pellets have porosity, for example open pore structures, that can have pore sizes, for example, ranging from a few nanometers to several microns. For example, embodiments may have pore sizes from about 5 nm (nanometers) to about 100 μm (microns), about 50 nm to about 10 μm, about 100 nm to about 1 um, greater than 100, nm, greater than 500 nm, less than 1 μm, less than 10 μm, less than 100 μm and combinations and variations of these pore sizes as well as larger and smaller pores. In some embodiments, the pellets comprise pellets of direct reduced iron (DRI). Embodiments of these electrodes in the energy storage system, and in particular in long duration energy storage systems, may have one or more of these foregoing features.

The packing of pellets creates macro-pores, e.g., openings, spaces, channels, or voids, in between individual pellets. The macro-pores facilitate ion transport through electrodes that in some embodiments have a smallest dimension that is still very thick compared to some other types of battery electrodes, being multi-centimeter in dimension. The micro-pores within the pellets allow the high surface area active material of the pellet to be in contact with electrolyte to enable high utilization of the active material. This electrode structure lends itself specifically to improving the rate capability of extremely thick electrodes for stationary long duration energy storage, where thick electrodes may be required to achieve extremely high areal capacities.

The pellets for these embodiments, and in particular for use in embodiments of electrodes for long duration energy storage systems, can be any volumetric shape, e.g., spheres, discs, pucks, beads, tablets, pills, rings, lenses, disks, panels, cones, frustoconical shapes, square blocks, rectangular blocks, trusses, angles, channels, hollow sealed chambers, hollow spheres, blocks, sheets, films, particulates, beams, rods, slabs, columns, fibers, staple fibers, tubes, cups, pipes, and combinations and various of these and other more complex shapes. The pellets in an electrode can be the same or different shapes. The pellets in an electrode that is one of several electrodes in a long duration energy storage system, can be the same as, or different from, the pellets in the other electrodes in that storage system.

The size of the pellets, unless expressly used otherwise, refers to the largest cross-sectional distance of the pellet, e.g., the diameter of sphere. The pellets can be the same or different sizes. It being recognized that the shape, size and both of the pellets, as well as, typically to a lesser degree the shape and size of the container or housing holding the pellets, determines the nature and size of the macro-pores in the electrode. The pellets can have sizes from about 0.1 mm to about 10 cm, about 5 mm to about 100 mm, 10 mm to about 50 mm, about 20 mm, about 25 mm, about 30 mm, greater than 0.1 mm, greater than 1 mm, greater than 5 mm, greater than 10 mm and greater than 25 mm, and combinations and variations of these.

In embodiments, the pellets as configured in an electrode can provide an electrode having a bulk density of from about 3 g/cm³ to about 6.5 g/cm³, about 0.1 g/cm³ to about 5.5 g/cm³, about 2.3 g/cm³ to about 3.5 g/cm³, 3.2 g/cm³ to about 4.9 g/cm³, greater than about 0.5 g/cm³, greater than about 1 g/cm³, greater than about 2 g/cm³, greater than about 3 g/cm³, and combinations and various of these as well as greater and lesser values.

In certain embodiments a mixture of reduced DR grade and reduced BF grade pellets may be used together. In certain other embodiments, reduced material (DRI) and raw ore materials (DR grade or BF grade) may be used in combination.

In various embodiments, DRI may be produced by the use of an “artificial ore” such as waste or by-product forms of iron oxide. As one non-limiting example, mill scale is a mixed iron oxide formed on the surface of hot rolled steel, which in various embodiments is collected and ground to form an iron oxide powder which is then agglomerated to form a pellet and is subsequently reduced to form DRI. Other waste streams may be similarly utilized to form DRI. As another non-limiting example, pickle liquor is an acidic solution which can be rich in dissolved Fe ions. In various embodiments, Fe-bearing pickle liquor may be neutralized with a base (such as caustic potash or sodium hydroxide) to precipitate iron oxide powder which is then agglomerated to form a pellet and is subsequently reduced to form DRI.

In various embodiments the precursor iron oxides are first reduced and then subsequently formed into a pellet or other agglomerate. In certain non-limiting embodiments iron oxide powder from a natural or artificial ore is reduced to iron metal powder by heat treatment, ranging from 700° C. to 1400° C., ranging from 900° C. to 1300° C., at 900° C., at 1000° C. and/or at 1100° C. under a reducing gas environment such as a linear hearth furnace with a hydrogen atmosphere, ranging from 1% to 100% H₂. In embodiments that use hydrogen as a reducing gas, the cementite (Fe₃C) content of the DRI can be as low as 0 wt %.

In various embodiments, the precursor iron oxides are reduced under conditions to promote swelling or non-densification reduction. In certain non-limiting embodiments, iron oxide powder from a natural or artificial ore is reduced to iron metal powder by heat treatment, ranging from 700° C. to 1400° C., ranging from 900° C. to 1300° C., at 900° C., at 1000° C. and/or at 1100° C. under a reducing gas environment such as a linear hearth furnace with a gaseous atmosphere, such as carbon monoxide mixtures, that promotes enlarged porosity through swelling. In some embodiments, precursor iron oxides may be chosen that have a preferential pellet chemistry to promote swelling, or additives may be used such as limestone.

In various embodiments, DRI pellets or agglomerates are formed in a single process from iron oxide powders by use of a rotary calciner. The rotary motion of the furnace promotes agglomeration of the powder into a pellet or agglomerate, while the high temperature reducing gas environment provides for concurrent reduction of the iron oxide. In various other embodiments a multi-stage rotary calciner may be used in which the agglomerating and reducing steps may be tuned and optimized independently.

In various embodiments, the DRI has a shape that is not spherical. In certain embodiments the DRI may have a shape that is substantially rectilinear or brick-like. In certain embodiments the DRI may have a shape that is substantially cylindrical or rod-like, or disc-like. In certain embodiments the DRI may have a shape that is substantially planar or sheet-like. In certain embodiments the iron oxide powder is dry formed by die compaction into a cylindrical shape or any other shape that is amenable to die pressing. In certain embodiments the iron oxide powder is dry formed into a sheet-like form by roll pressing through a calender roll or powder mill. In certain embodiments the iron oxide powder is blended with a binder such as a clay or polymer and is dry processed into a rod-like shape by extrusion. In certain embodiments the iron oxide powder is blended with a binder such as a clay or polymer and is dry processed into a sheet-like form by roll pressing through a calender roll. Binders may be comprised of a clay, such as bentonite, or a polymer, such as corn starch, polyacrylamide, or polyacrylate. Binders may be comprised of a combination of one or more clays and one or more polymers. In certain embodiments the iron oxide powder is dispersed into a liquid to form a slurry that is then used to wet form into various shapes. In certain embodiments an iron oxide slurry is slip cast into a mold of near-arbitrary shape. In certain embodiments an iron oxide slurry is coated onto a sheet by doctor blading or other similar coating processes.

In various embodiments, a bed of conductive micro-porous pellets comprise an electrode in an energy storage system. In some embodiments, said pellets comprise pellets of direct reduced iron (DRI). The packing of pellets creates macro-pores in between individual pellets. The macro-pores facilitate ion transport through electrodes that in some embodiments have a smallest dimension that is still very thick as compared to some other types of battery electrodes, being of multiple centimeters in dimension. The macropores may form a pore space of low tortuosity compared to the micro-pores within the pellets. The micro-pores within the pellets allow the high surface area active material of the pellet to be in contact with electrolyte to enable high utilization of the active material. This electrode structure lends itself specifically to improving the rate capability of extremely thick electrodes for stationary long duration energy storage, where thick electrodes may be required to achieve extremely high areal capacities.

In various embodiments, a fugitive pore former is incorporated during the production of DRI to increase the porosity of the resulting DRI. In one embodiment, the porosity of the DRI pellet is modified by incorporating a sacrificial pore former such as ice (solid H₂O) in the pelletization process, which subsequently melts or sublimes away under thermal treatment. In certain other embodiments the fugitive pore former comprises naphthalene, which subsequently sublimes to leave porosity. In other embodiments the fugitive pore former comprises NH₄CO₃ (ammonium carbonate), and it may be introduced as a solid at various points in the production of DRI and will decompose under heat and leave entirely as gaseous or liquid species (NH₃+CO₂+H₂O). In various other embodiments, the fugitive additive may serve an additional function in the cell (e.g. be an electrolyte component). In certain embodiments the fugitive additive may be an alkaline salt such as KOH or NaOH or LiGH. In certain embodiments the fugitive additive may be a soluble electrolyte additive which is solid in form under ambient, dry conditions, such as lead sulfate, lead acetate, antimony sulfate, antimony acetate, sodium molybdenum oxide, potassium molybdenum oxide, thiourea, sodium stannate, ammonium thiosulfate. In various other embodiments the fugitive additive may be a binder used in the agglomeration of iron ore powder to form a pellet or other shape, such as sodium alginate or carboxymethylcellulose binder.

In certain embodiments, the reducing gas used to form DRI is hydrogen (H₂). In certain embodiments, the hydrogen is generated by electrolysis of water from renewable power generation sources such as wind energy or solar energy. In certain embodiments the electrolyzer is coupled to an energy storage system. In certain embodiments the electrolyzer is a Proton Exchange Membrane (PEM) electrolyzer. In certain embodiments the electrolyzer is an alkaline electrolyzer. In embodiments that use hydrogen as a reducing gas, the cementite (Fe₃C) content of the DRI can be as low as 0 wt.

In certain embodiments, natural gas (methane, CH₄) is used as a reducing agent to produce DRI. In certain embodiments, the methane is steam reformed (via reaction with water, H₂O) to produce a mixture of carbon monoxide (CO) and hydrogen (H₂) through the reaction CH₄+H₂O→CO+3H₂. In certain embodiments, this reforming reaction occurs through an ancillary reformer, separate from the reactor in which the iron reduction occurs. In certain embodiments, the reforming occurs in situ in the reduction reactor. In certain embodiments the reforming occurs both in an ancillary reformer and in the reduction reactor. In certain embodiments, coal is used as a reducing agent to produce DRI. In certain embodiments coke is used as a reducing agent to produce DRI. In embodiments that use a carbon-containing reducing gas, the cementite (Fe₃C) content of the DRI can be higher, up to 80 wt %.

In certain embodiments, a mixture of DRI produced using various reducing gases can be used to achieve a beneficial combination of composition and properties. In one non-limiting embodiment a 50/50 mix by mass of DRI produced from BF grade pellets reduced in natural gas and DRI produced from DR grade pellets reduced in hydrogen is used as the negative electrode of a battery. Other combinations of mass ratios, feedstock type (DR, BF, other artificial ores, etc.) and reducing media (hydrogen, natural gas, coal, etc.) may be combined in other embodiments.

In various embodiments, DRI pellets may be crushed and the crushed pellets may comprise the bed (with or without the addition of a powder).

In various embodiments, additives beneficial to electrochemical cycling, for instance, Hydrogen Evolution Reaction (HER) suppressants may be added to the bed in solid form, for instance, as a powder, or as solid pellets.

In some embodiments, metal electrodes may have a low initial specific surface area (e.g., less than about 5 m²/g and preferably less than about 1 m²/g). Such electrodes tend to have low self-discharge rates in low-rate, long duration energy storage systems. One example of a low specific surface area metal electrode is a bed of DRI pellets. In many typical, modern electrochemical cells, such as lithium ion batteries or nickel-metal-hydride batteries, a high specific surface area is desirable to promote high rate capability (i.e., high power). In long duration systems, the rate capability requirement is significantly reduced, so low specific surface area electrodes can meet target rate-capability requirements while minimizing the rate of self-discharge.

In some embodiments, DRI pellets are processed by mechanical, chemical, electrical, electrochemical, and/or thermal methods before the DRI pellets are used in an electrochemical cell. Such pre-treatments may allow superior chemical and physical properties to be achieved, and, for example, may increase the accessible capacity during the discharge reaction. The physical and chemical properties of as-purchased (also sometimes referred to as “as received”) DRI may not be optimal for use as the negative electrode of an electrochemical cell. Improved chemical and physical properties may include introduction of a higher content of desirable impurities, such as HER suppressants, achieving a lower content of undesirable impurities (such as HER catalysts), achieving a higher specific surface area, achieving a higher total porosity, achieving a different pore size distribution from the starting DRI (such as a multimodal pore size distribution to reduce mass transport resistance), achieving a desired distribution of pellet sizes (such as a multimodal size distribution to allow packing of pellets to a desired density), altering or selecting pellets of a desired aspect ratio (in order to achieve a desired bed packing density). Mechanical processing may include tumbling, milling, grinding, crushing, pulverizing, and powderizing. Chemical processing may include acid etching. Chemical processing may include soaking a bed of pellets in an alkaline solution to create necking between pellets as well as coarsening of the micropores within the pellets. Thermal processing may include processing DRI in at elevated temperature in inert, reducing, oxidizing, and/or carburizing atmosphere. In various embodiments, mechanical, chemical, electrical, electrochemical, and/or thermal methods of pre-processing the materials forming an electrode, such as DRI pellets, etc., may fuse the material forming the electrode into a bed, such as bed of fused together DRI pellets, etc.

In some embodiments, the negative electrode may contain inert conductive matrix including carbon black, graphite powder, acetylene black, activated carbon, carbon steel mesh, stainless steel mesh, carbon steel wool, steel wool, nickel-coated carbon steel mesh, nickel-coated stainless steel mesh, nickel-coated steel wool, carbon steel expanded metal, nickel-coated carbon steel expanded metal, stainless steel expanded metal, nickel-coated stainless steel expanded metal, or combinations thereof.

According to various embodiments, the positive electrode is comprised of manganese-bearing compounds, including manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or combinations thereof. In some embodiments, the positive electrode may contain one or more natural oxide minerals of manganese such as birnessite, pyrolusite, hausmannite, akhtenskite, hollandite, ramsdellite, nsutite, spinel, psilomelane, todorokite, bixbyite, vernadite, or combinations thereof. In some embodiments, the positive electrode may contain manganese-bearing compounds with the structure of oxide mineral of manganese such as birnessite, etc. In some embodiments, the positive electrode may contain electrolytic manganese dioxide (EMD). In some embodiments, the manganese dioxide is in the phase of α-MnO₂, β-MnO₂, γ-MnO₂, δ—MnO₂, ε-MnO₂, λ-MnO₂, or combinations thereof. In some embodiments, the positive electrode may contain manganese-bearing compounds with the structure of oxide mineral of manganese such as, but not limited to, pyrolusite, ramsdellite, nsutite, hollandite, birnessite, or vernadite. In some embodiments, the positive electrode may contain manganese (II) hydroxide (Mn(OH)₂). In some embodiments, the positive electrode may contain hydroxide mineral of manganese such as pyrochroite. In some embodiments, the positive electrode may contain manganese-bearing compounds with the structure of hydroxide mineral of manganese such as pyrochroite. In some embodiments, the positive electrode may contain manganese (III) oxyhydroxide (MnOOH). In some embodiments, the positive electrode may contain oxyhydroxide mineral of manganese such as manganite, feitknechtite, groutite, or manganite. In some embodiments, the positive electrode may contain manganese-bearing compounds with the structure of oxyhydroxide mineral of manganese such as manganite. In various embodiments, the positive electrode includes inert conductive matrix including carbon black, graphite powder, acetylene black, activated carbon, charcoal powder, coal powder, nickel-coated carbon steel mesh or expanded metal, nickel-coated stainless steel mesh or expanded metal, nickel-coated steel wool, or combinations thereof.

In embodiments the specific surface area for the manganese-bearing compounds can be from about 0.05 m²/g to about 50 m²/g, from about 0.5 m²/g to about 5 m²/g, as well as greater and smaller values.

In some embodiments, the positive electrode may contain additive(s) to enhance the capacity and cyclability of the positive electrode. In some embodiments, the additive(s) in the positive electrode include oxides, sulfides, and sulfates such as antimony (III) oxide (Sb₂O₃), barium oxide (BaO), barium sulfate (BaSO₄), barium hydroxide (Ba(OH)₂), bismuth (III) oxide (Bi₂O₃), bismuth (III) sulfide (Bi₂S₃), calcium oxide (CaO), calcium sulfate (CaSO₄), calcium hydroxide (Ca(OH)₂), cerium oxide (CeO₂), lead oxide (PbO), magnesium oxide (MgO), magnesium hydroxide (Mg(OH)₂), strontium oxide (SrO), titanium sulfide (TiS₂), or combinations thereof. In some embodiments, the additive(s) in the positive electrode include metals or metallic cations such as Li⁺, Na⁺, K+, Mg²⁺, Ca²⁺, Ba²⁺, Co²⁺, Cu²⁺, Fe²⁺, Fe³⁺, Bi³, Pb²⁺, Zn²⁺, Ni²⁺, or combinations thereof. In some embodiments, the additive(s) in the positive electrode include carbon nanotubes, carbon nanofibers, graphene, nitrogen-doped carbon nanotubes, nitrogen-doped carbon nanofibers, nitrogen-doped graphene, or combinations thereof.

In some embodiments, the positive electrode may contain binder compound(s). In some embodiments, the binder compound includes polytetrafluoroethylene (PTFE), polyvinylidene difluoride (PVdF), polypropylene (PP), polyethylene (PE), fluorinated ethylene propylene (FEP), polyacrylonitrile, styrene butadiene rubber, carboxymethyl cellulose (CMC), sodium carboxymethyl cellulose (Na-CMC), polyvinyl alcohol (PVA), polypyrrole (PPy), or combinations thereof.

In some embodiments, the manganese oxide based cathode can be assembled at “discharged” state. The “discharged” state is defined as Mn (III) (such as MnOOH, Mn₂O₃), Mn (II+III) (such as Mn₃O₄), and Mn (II) (such as Mn(OH)₂). In some embodiments, the source of the “discharged” manganese oxide or oxyhydroxide species includes natural ores such as manganite, groutite, feitknechtite, bixbyite, pyrochroite, manganosite, hausmannite, nsutite, etc. In other embodiments, the source of the “discharged” manganese oxide species may be from disposed primary alkaline batteries (i.e. Zn/MnO₂) where the “discharged” cathode of the primary alkaline battery may be reused in the assembly of rechargeable manganese oxide based cathode. In some embodiments, additive(s) such as Bi₂O₃ or metallic bismuth, may be blended, along with other electrode components, with the “discharged” manganese oxide species to enable the electrical rechargeability of these “discharged” compounds back to the “charged” species (i.e. Mn(IV)) with the desired phase. In some embodiments, the “discharged” cathode is coupled with the “discharged” anode in a full cell configuration with the first half cycle charging both cathode and anode. In other embodiments, the “discharged” cathode is coupled with the charged anode in a full cell configuration with the first half cycle charging the cathode with hydrogen evolution reaction (HER) as the counter electrode reaction.

In various embodiments, the loading of manganese-bearing compound(s) in the positive electrode is in the range of 50 and 90 weight percent on the basis of the equivalent mass of MnO₂. In various embodiments, the loading of the conductive matrix in the positive electrode is in the range of 5 and 40 weight percent. In various embodiments, the loading of additive(s) in the positive electrode is in the range of 0 and 20 weight percent. In various embodiments, the loading of binder in the positive electrode is in the range of 0 and 20 weight percent.

In some embodiments, the manganese-bearing compound(s) and additive(s) are combined through chemical reactions or physical process(es) such as, but not limited to, stirring, mixing, milling, blending, or combinations thereof. In some embodiments, the additive(s) are incorporated into the structure of the manganese-bearing compound(s) through chemical, electrochemical, or thermal processes.

In some embodiments, the positive electrode containing manganese-bearing compound(s), additive(s), conductive matrix, and binder is produced by a powder compaction process, such as, but not limited to, uniaxial pressing or calender rolling. In some embodiments, the compaction is performed dry or wet. In some embodiments, the positive electrode containing manganese-bearing compound(s), additive(s), conductive matrix, and binder is produced by an extrusion process, such as, but not limited to, screw or piston. In some embodiments, the compaction is performed dry or wet. In some embodiments, the positive electrode containing manganese-bearing compound(s), additive(s), conductive matrix, and binder is produced by directly packing the mixed powder in the cell. In some embodiments, the mixed powder is packed in a dry state, and expanded by adding electrolyte in the dry powder. In some embodiments, the mixed powder is packed in a wet state such as slurry or paste. In some embodiments, a coating or printing process, such as, but not limited to doctor blade, screen printing, gravure coating, slot-die coating, or comma coating, is used to apply the mixed powder to the current collector.

In certain embodiments, redox mediator can be used to facilitate the electron transfer of the redox reaction of MnO₂ to MnOOH. In certain embodiments, redox mediator can be used to facilitate the electron transfer of the redox reaction of MnO₂ to Mn(OH)₂. Requirements of redox mediator include: (1) facile and reversible redox kinetics; (2) similar redox potential to that of the reaction it facilitates (i.e. MnO₂< >MnOOH or MnO₂< >Mn(OH)₂); (3) stable in the presence of electrolyte of interest (e.g. high concentration alkaline). In some embodiments, the redox mediator is insoluble in the electrolyte. As a non-limiting example, the redox mediator for rechargeable manganese dioxide electrode is ferrocene, ferrocene derivatives, or combinations thereof. As another non-limiting example, the redox mediator is 2,5-di-tert-butyl-1,4-benzo-quinone (DBBQ). As another non-limiting example, the redox mediator is tetrathiafulvalene (TTF). In some embodiments, the redox mediator is soluble in the electrolyte. As a non-limiting example, the redox mediator for rechargeable manganese dioxide electrode is TEMPO, TEMPO derivatives, or combinations thereof. In a certain embodiment, the redox mediator is LiI, NaI, KI, CsI, or combinations thereof.

In various embodiments, electrolyte is comprised of aqueous alkali metal hydroxide including lithium hydroxide (LiOH), sodium hydroxide (NaOH), potassium hydroxide (KOH), cesium hydroxide (CsOH), or combinations thereof. In some embodiments, electrolyte may contain alkali metal sulfide or polysulfide including lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6). In some embodiments, electrolyte may contain hydrogen evolution reaction (HER) suppressor. In some embodiments, the HER suppressors can be selected from the non-limiting set of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate, 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, Iron(III) sulfide, calcium nitrate, hydroxylamines, benzotriazole, furfurylamine, quinoline, tin(II) chloride, ascorbic acid, tetraethylammonium Hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40®), tetramethylammonium hydroxide, NaSb tartrate, urea, D-glucose, C₆Na₂O₆, antimony potassium tartrate, hydrazinsulphate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, and combinations thereof.

In various embodiments, a separator that is impermeable to electrons and permeable to at least one alkali metal ion or the hydroxide ion is in close contact between the negative electrode and the positive electrode. In some embodiments, a separator is non-woven fiber layer such as nylon, cellulose, etc. In some embodiments, a separator is a porous polymer layer such as polypropylene separator, polyethylene separator, or polybenzimidazole (PBI) separator. In some embodiments, a separator is a woven layer such as polypropylene mesh, polyethylene mesh, polyester mesh, or cotton gauze. In some embodiments, an anion-exchange membrane that selectively conducts hydroxide ion is in close contact between the negative electrode and the positive electrode. In various embodiments, the separator is a size exclusion separator that selectively conducts hydroxide ions and alkali metal ions, and meanwhile prevents sulfide or polysulfide ions from crossing over from the negative side to the positive side. In various embodiments, the separator is a size exclusion separator that selectively conducts hydroxide ions, and meanwhile prevents sulfide or polysulfide ions from crossing over from the negative side to the positive side. In some embodiments, the size exclusion separator has a pore size larger than the diameter of hydroxide ions and alkali metal ions and meanwhile smaller than the diameter of sulfide ions. In some embodiments, the size exclusion separator has a pore size larger than the diameter of hydrated hydroxide ions and hydrated alkali metal ions and meanwhile smaller than the diameter of hydrated sulfide ions. In some embodiments, the size exclusion separator has a pore size larger than the diameter of hydroxide ions and meanwhile smaller than the diameter of sulfide ions. In some embodiments, the size exclusion separator has a pore size larger than the diameter of hydrated hydroxide ions and meanwhile smaller than the diameter of hydrated sulfide ions.

In various embodiments, battery components are assembled in prismatic configuration or cylindrical configuration. In various embodiments, the current collector includes nickel, copper, aluminum, carbon steel, stainless steel, nickel-coated stainless steel, nickel-coated carbon steel, and nickel-coated steel wool, graphite, or combinations thereof. In various embodiments, the current collector is metal plate, metal rod, metal tube, expanded metal, perforated metal, metal mesh, graphite plate, graphite rod, graphite tube, graphite foil, carbon powder based plate, carbon powder based rod, carbon powder based tube, carbon powder based foil, or combinations thereof. In various embodiments, the current collector is deposited in the form of a coating or a paste, through a technique such as gravure coating or screen printing. In various embodiments, battery housing materials are polypropylene, high-density polyethylene, or polyvinyl chloride. In various embodiments, electrolyte is in static (non-circulating) mode or flowing (circulating) mode.

In some embodiments, the current collector is a layer of conductive and electrolyte impermeable barrier. In some embodiments, such a conductive and electrolyte impermeable barrier contains carbon materials and hydrophobic binder. In some embodiments, carbon materials include carbon black, activated carbon, graphite, or combinations thereof. In some embodiments, the hydrophobic binder includes polytetrafluoroethylene (PTFE), polyvinylidene difluoride (PVdF), polypropylene (PP), polyethylene (PE), fluorinated ethylene propylene (FEP), or combinations thereof. In a prismatic cell, such a current collector is in a flat shape. In some embodiments, the flat current collector can be made by a powder compaction process, an extrusion process, a coating process or a printing process. In some embodiments, the flat current collector and the exterior structural component can be produced simultaneously through an extrusion or co-extrusion process. In a cylindrical cell, such a current collector for the outer layer of the cell is in a hollow cylindrical or a tubular shape. In some embodiments, the hollow cylindrical or tubular current collector can be made by an extrusion or co-extrusion process or by folding or rolling a sheeted material. In some embodiments, the cylindrical current collector and the exterior structural component can be produced simultaneously through a paste extrusion or co-extrusion process.

In some embodiments, a layer of conductive and electrolyte impermeable barrier is placed between the electrode and the current collector. In some embodiments, such a conductive and electrolyte impermeable barrier contains carbon materials and hydrophobic binder. In some embodiments, carbon materials include carbon black, activated carbon, graphite, or combinations thereof. In some embodiments, the hydrophobic binder includes polytetrafluoroethylene (PTFE), polyvinylidene difluoride (PVdF), polypropylene (PP), polyethylene (PE), fluorinated ethylene propylene (FEP), or combinations thereof. In a prismatic cell, the conductive and electrolyte impermeable barrier is in a flat shape. In some embodiments, the flat conductive and electrolyte impermeable barrier can be made by a powder compaction process, an extrusion process, a coating process, or a printing process. In a cylindrical cell, the conductive and electrolyte impermeable barrier is in a hollow cylindrical or a tubular shape. In some embodiments, the hollow cylindrical or tubular conductive and electrolyte impermeable barrier can be made by an extrusion or co-extrusion process or by folding or rolling a sheeted material. In various embodiments, the current collector that touches the conductive and electrolyte impermeable barrier can be alkaline incompatible such as copper, aluminum, or carbon steel.

In some embodiments, a proton conductor is included in the positive electrode to block sulfide from accessing the surface of positive electrode and to facilitate local proton transfer. In some embodiments, the proton conductor is in liquid state and coated on the surface of positive electrode. In certain embodiments, the liquid proton conductor is Nafion® solution. In some embodiments, the proton conductor is in solid state and mixed with other components of the positive electrode. In certain embodiments, the solid proton conductor is Nafion® beads.

In various embodiments, the cell or stack is charged in a current controlled, voltage controlled, or power controlled mode, or combinations thereof. In various embodiments, the cell or stack is charged in constant current, constant voltage, constant power mode, or combinations thereof. In various embodiments, the cell or stack is discharged in constant current, constant voltage, constant power mode, or combinations thereof. In various embodiments, the cell or stack is discharged in a current controlled, voltage controlled, or power controlled mode, or combinations thereof.

In various embodiments, an auxiliary electrode is included in the sealed rechargeable Fe—MnO₂ cell for catalyzing the hydrogen oxidation reaction (HOR) generated on the negative electrode during the charge of the cell. Such an auxiliary electrode is called hydrogen recombination electrode. The consumption of hydrogen as a side reaction product may not only mitigate safety concerns associated with hydrogen but also balance the state of charge of the positive electrode. In various embodiments, the hydrogen recombination electrode includes a catalytic core and a separator surrounding the core. The catalytic core provides the reaction sites for HOR. The separator is ionically conductive and electrically insulating. In some embodiments, the catalytic core is a solid electrode, for example as shown in FIG. 2A. FIG. 2A illustrates a solid electrode that is a hydrogen recombination electrode 200 that includes a separator 202 and catalytic core 203. In some embodiments, the catalytic core is a porous electrode, for example as shown in FIG. 2B. FIG. 2B illustrates a hydrogen recombination electrode 220 that includes the separator 202 and a porous catalytic core 221. In one example, the hydrogen recombination electrode 235 is placed in the negative electrode compartment, such as the negative electrode compartment 231 including anode formed from DRI, for example as shown in FIG. 2C. FIG. 2C illustrates a specific example electrochemical cell 230 similar to electrochemical cell 100 described above where the anode may be formed from DRI and the cathode in the positive electrode compartment 232 may be formed from MnO₂/C. As an example, the hydrogen recombination electrode 235 may be a hydrogen recombination electrode 200 or 220 described above. Hydrogen produced on the anode will be consumed “on-site” by the hydrogen recombination electrode 235. The electrochemical cell 230 may include a vent 235 having a threshold pressure. The threshold pressure of the vent may be higher than threshold pressures of vents in cells where a hydrogen recombination electrode may not be present. In another example, the hydrogen recombination electrode 241 is placed between the anode and cathode, for example as shown in FIG. 2D in which the electrochemical cell 240 includes the hydrogen recombination electrode 241 disposed between the negative electrode compartment 231 and positive electrode compartment 232. In this electrochemical cell 240 configuration, the hydrogen recombination electrode 241 may replace the polypropylene mesh 105 and the battery separator 104, and therefore the hydrogen recombination electrode 241 may have a porous catalytic core, such as that of hydrogen recombination electrode 220 described above. Hydrogen produced on the anode will be transferred through the pores in the anode and consumed by the hydrogen recombination electrode 241. Hydrogen concentration gradient is the primary driving force of the hydrogen mass transfer. In another example electrochemical cell 250 configuration, the hydrogen recombination electrode 251 is placed on the top of the anode at the top of the negative electrode compartment 231, for example as shown in FIG. 2E. In such a configuration, the hydrogen recombination electrode 251 may be integrated with the vent. In another example, the hydrogen recombination electrode is the same as the cathode of the cell 261, for example as shown in electrochemical cell 260 in FIG. 2F. In other words, during charge, the main electrochemical reaction on the cathode 261 is the oxidation of manganese compound(s) and the “auxiliary” electrochemical reaction on the cathode 261 is HOR. Hydrogen concentration gradient is the primary driving force of the hydrogen mass transfer from the anode 231 to the cathode 261 of the cell 260.

In various embodiments, an auxiliary electrode serving as a rebalancing electrode is placed on the positive electrode side. The main purpose of such an auxiliary electrode is to protect the positive electrode from being overcharged when HER takes place on the negative electrode side. In some embodiments, the auxiliary electrode is nickel oxyhydroxide. In some embodiments, the auxiliary electrode is the same manganese based positive electrode with excess capacity.

In various embodiments, the operating temperature is in the range of −20° Celsius to 60° Celsius. In some embodiments, the preferred operating temperature is in the range of 20° Celsius to 40° Celsius.

In one non-limiting example, a rechargeable Fe—MnO2 cell contains a MnO2-based positive electrode, Bi₂S₃ incorporated sintered iron negative electrode, a polypropylene separator, and 15 wt % KOH+15 wt % NaOH electrolyte, in a prismatic configuration. In this embodiment, the positive electrode contains EMD (60-70 wt %), graphite (25-35 wt %), and PTFE (5-10 wt %), with nickel coated steel mesh current collector. The powders of EMD, graphite, and PTFE are mixed in a wet process, in the presence of isopropanol. The electrodes are produced by calendering the mixed powder followed by drying. The electrode(s) and nickel coated steel mesh current collector were combined using a hydraulic press. The thickness of the positive electrode is between 1 and 10 mm. The thickness of the negative electrode is between 1 and 10 mm. The target operating current density of the cell is 1 to 10 mA/cm².

In another non-limiting example, a rechargeable Fe—MnO₂ cell contains a MnO₂-based positive electrode, Bi₂S₃ incorporated DRI negative electrode, a polybenzimidazole (PBI) separator, and 30 wt % KOH+1 wt % LiGH electrolyte, in a cylindrical configuration. In this embodiment, the positive electrode contains EMD (70-80 wt %), carbon black (15-25 wt %), and PTFE (5-10 wt %), with nickel coated steel plate current collector. The powders of EMD, carbon black, and PTFE are mixed in a dry process, and packed into the cylindrical cell in a dry state. In some embodiments, the positive electrode “column” is placed on the center of the cylinder whereas the negative electrode is placed surrounding the positive electrode “center”. In some embodiments, the negative electrode “column” is placed on the center of the cylinder whereas the positive electrode is placed surrounding the negative electrode. The PBI separator sandwiched by two layers of polypropylene mesh is placed between the positive electrode and the negative electrode.

In another non-limiting example, a rechargeable Fe—MnO₂ cell contains a MnO₂-based positive electrode, Bi₂S₃ incorporated DRI negative electrode, a polybenzimidazole (PBI) separator, and 30 wt % KOH+1 wt % LiGH electrolyte, in a cylindrical configuration. In this embodiment, the positive electrode contains EMD (70-80 wt %), carbon black (15-25 wt %), and PTFE (5-10 wt %). The powders of EMD and carbon black are mixed through ball milling before a PTFE dispersion is added and subsequently mixed. In some embodiments, an additional process aid is added. This mixture is then extruded through a circular die, producing a tube structure. The tube is then sectioned to the appropriate length, corresponding to the height of the electrode, with each section being rolled through a gravure coater to deposit a patterned copper paste current collector. In some embodiments, the positive electrode “column” is placed on the center of the cylinder whereas the negative electrode is placed surrounding the positive electrode “center”. In some embodiments, the negative electrode “column” is placed on the center of the cylinder whereas the positive electrode is placed surrounding the negative electrode. The PBI separator sandwiched by two layers of polypropylene mesh is placed between the positive electrode and the negative electrode.

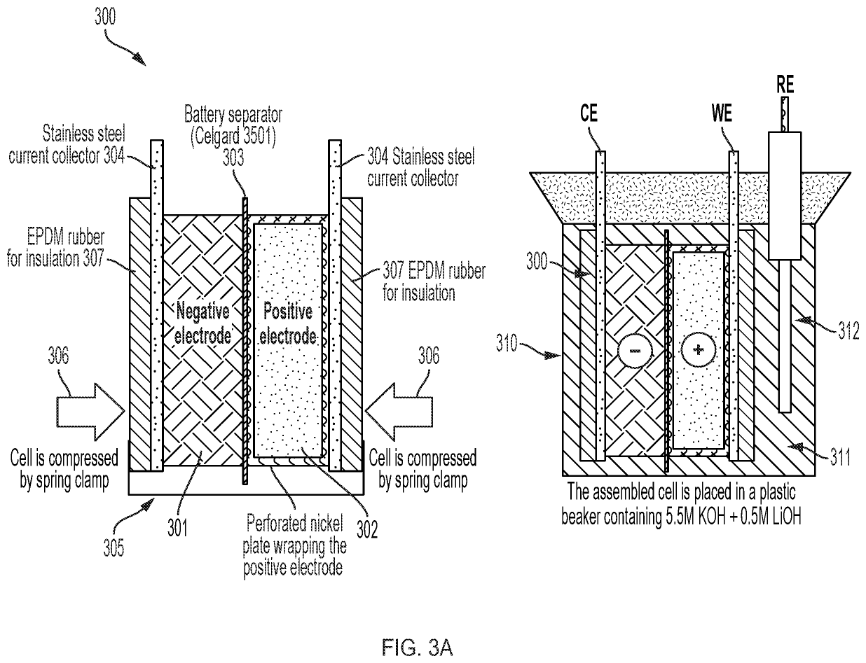

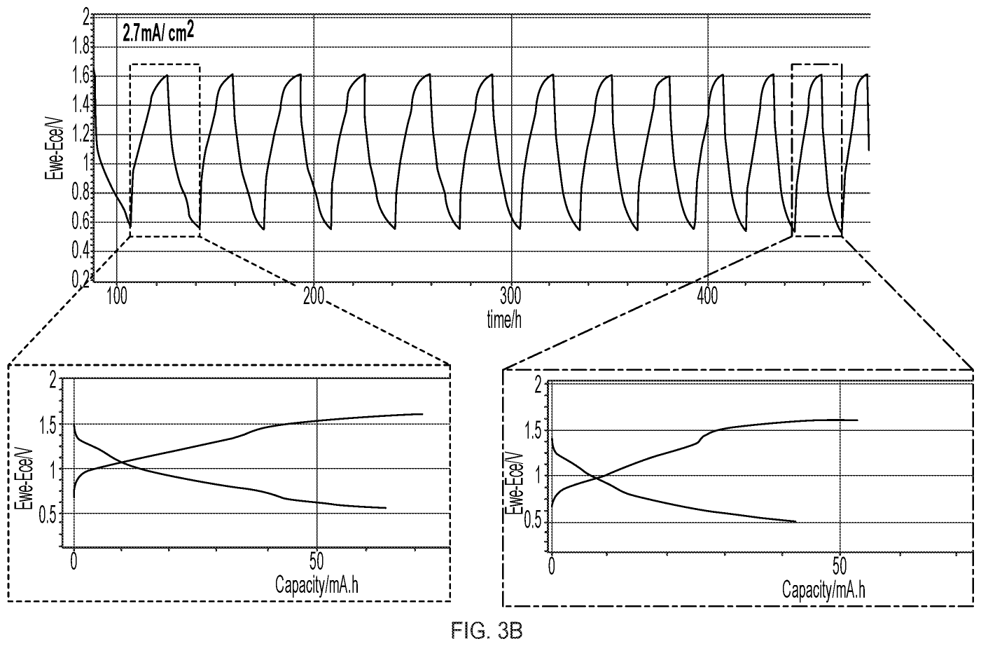

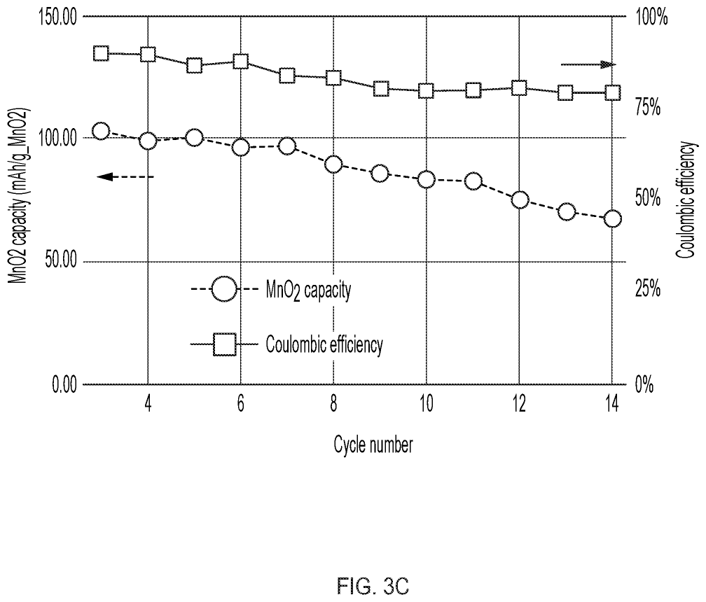

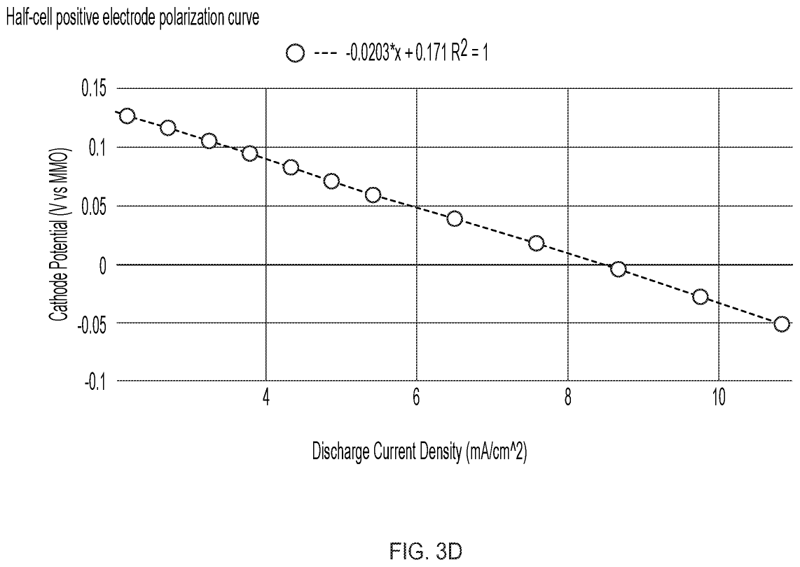

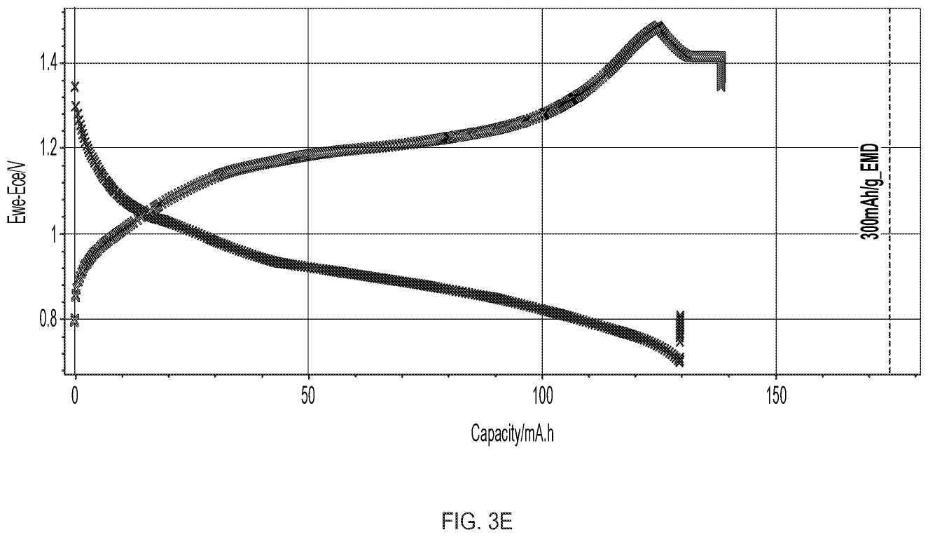

In another non-limiting example, a proof-of-concept cell 300 was built according to FIG. 3A. The active area of the cell 300 was about 1.5 cm². The negative electrode 301 was iron powder with a weight of about 1.3 g. The positive electrode 302 was MnO₂-based powder with a weight of about 0.8 g in which MnO₂ loading of about 78 wt %. The conductive matrix in this MnO₂-based powder was carbon. The positive electrode 302 also included about 0.5 mm thick perforated nickel wrap serving as the holder for the MnO₂-based powder. One piece of polypropylene battery separator 303 (Celgard 3501) was used between the negative electrode 301 and the positive electrode 302. The “negative electrode/separator/positive electrode” assembly (e.g., the combination of the negative electrode 301, separator 303, and positive electrode 302) was sandwiched between two stainless steel plates 304 that served as the current collectors. A spring clamp 305 was used to hold the cell parts together. The contact between the spring clamp 305 and the current collectors 304 was insulated by a layer of ethylene propylene diene monomer (EPDM) rubber 307 such that the cell 300 was compressed by the force 306 from the clamps against the EPDM rubber 307. As shown on the right hand side of FIG. 3A, the complete cell 300 (except for the end of current collectors 304) was submerged in a plastic beaker 310 containing as solution 311 of 5.5M KOH+0.5M LiGH. A mercury/mercury oxide (MMO) reference electrode 312 was placed in the beaker 310 close to the positive electrode 302 side to monitor the positive half-cell potential. The full cell capacity is limited by the positive electrode 302 at an absolute capacity of about 100 mAh assuming the positive electrode reaction is Mn(IV)⇔Mn(III).

FIG. 3B shows the galvanostatic (constant current) cycling at 2.7 mA/cm², which corresponds to 6.4 mA/g_{MnO2}, using the proof-of-concept cell design, i.e., cell 300 as shown in FIG. 3A. There are 12 cycles in FIG. 3B with a total duration >400 hours. Throughout the 12 cycles, the average charge voltage is about 1.35 V and the average discharge voltage is about 0.80 V. As shown in the zoomed-in curves (full cell voltage vs. capacity mAh), there are multiple plateaus associated with the charge and discharge curves, indicating the change of valence of iron and manganese containing species. FIG. 3C summarizes the MnO₂ capacity change (left Y-axis) and the coulombic efficiency (right Y-axis) based on the graph as shown in FIG. 3B. The MnO₂ capacity changes from 103 mAh/g_{MnO2} to 62 mAh/g_{MnO2} with an average decay rate of 3.3 mAh/g/cycle. The coulombic efficiency changes from 90% to 78% from the beginning to the end. FIG. 3D shows the beginning of life (BOL) half-cell positive electrode polarization curve using the proof of concept cell setup, i.e., cell 300 as shown in FIG. 3A. Mercury/mercury oxide (MMO) was used as the reference electrode. The apparent positive electrode area specific resistance (ASR) was determined as about 20 Ω·cm².

In another non-limiting example, a proof-of-concept cell using electrolytic manganese dioxide (EMD) as the positive electrode active material and direct reduced iron (DRI) negative electrode active material was built and tested. The active area of the cell was about 9 cm², which was set by the area of the positive electrode. The negative electrode was 6 DRI marbles with a total mass of 13.5 g held by expanded nickel that also served as the current collector. The positive electrode had a mass of about 0.9 g, whereby the MnO₂ loading was 65 wt %. The conductive matrix and binder in this MnO²-based powder were graphite and PTFE powder, respectively. The positive electrode also included a piece of 20 mesh nickel gauze serving as the current collector. One piece of PBI separator was used to wrap the positive electrode. The wrapped positive electrode was then sandwiched between two pieces of polypropylene mesh. The “negative electrode/separator/positive electrode” assembly (e.g., the combination of the negative electrode, separator, polypropylene mesh, and positive electrode) was compressed between two acrylic end plates, tightened by bolts, nuts, and washers. The complete cell except for the end of current collectors was submerged in a plastic beaker containing a solution of 10 wt % KOH. A mercury/mercury oxide (MMO) reference electrode was placed in the beaker to monitor both positive and negative half-cell potentials. The full cell capacity is limited by the positive electrode at about 170 mAh as the theoretical capacity assuming the positive electrode reaction is Mn(IV)⇔Mn(III).

FIG. 3E shows the 2nd cycle charge-discharge data of the proof-of-concept EMD/DRI cell as described in the above paragraph. The X-axis is the full cell capacity in the unit of mAh and the Y-axis is the full cell voltage in the unit of V. Constant current-constant voltage (CCCV) was used during charge. The cell was initially charged at 8.7 mA (equivalent to C/20 based on EMD capacity) until the positive potential reaches 0.5 V (vs MMO). After that, the cell was charged at constant potential of 0.5V (vs MMO) until charging current decayed to 0.87 mA. Constant current (i.e. galvanostatic) of 8.7 mA was used during discharge until the positive potential decreased to −0.2V (vs MMO). The theoretical cell capacity is about 170 mAh, corresponding to 300 mAh/g_{EMD}. As shown in the figure, the discharge capacity of EMD is 229 mAh/g. The average charge voltage is 1.22 V and the average discharge voltage is 0.91 V. The coulombic efficiency is 93.8%. The voltaic efficiency is 74.6%. The energy efficiency is 70.0% There are multiple plateaus/bumps associated with the charge and discharge curves, indicating the change of valence of iron and manganese containing species.

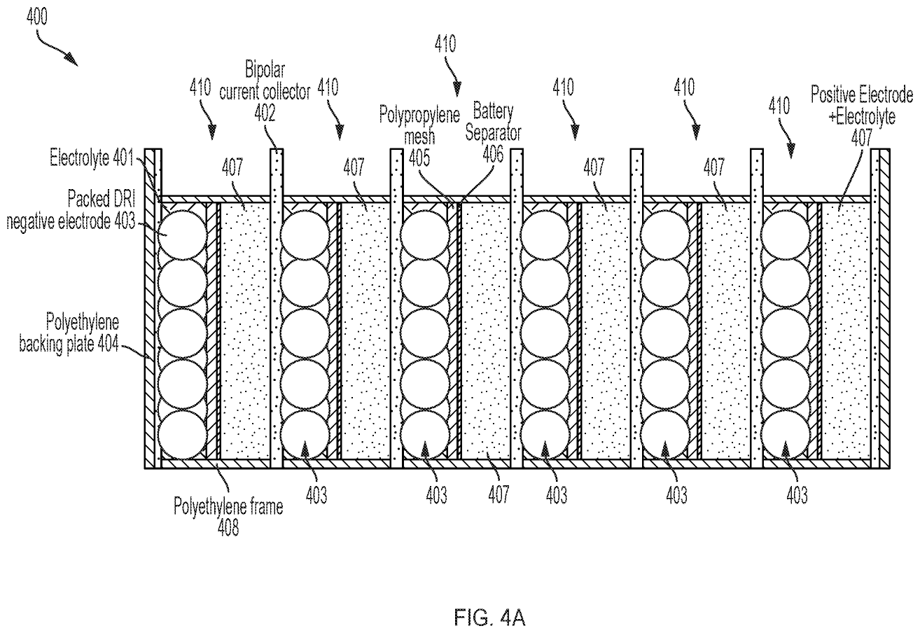

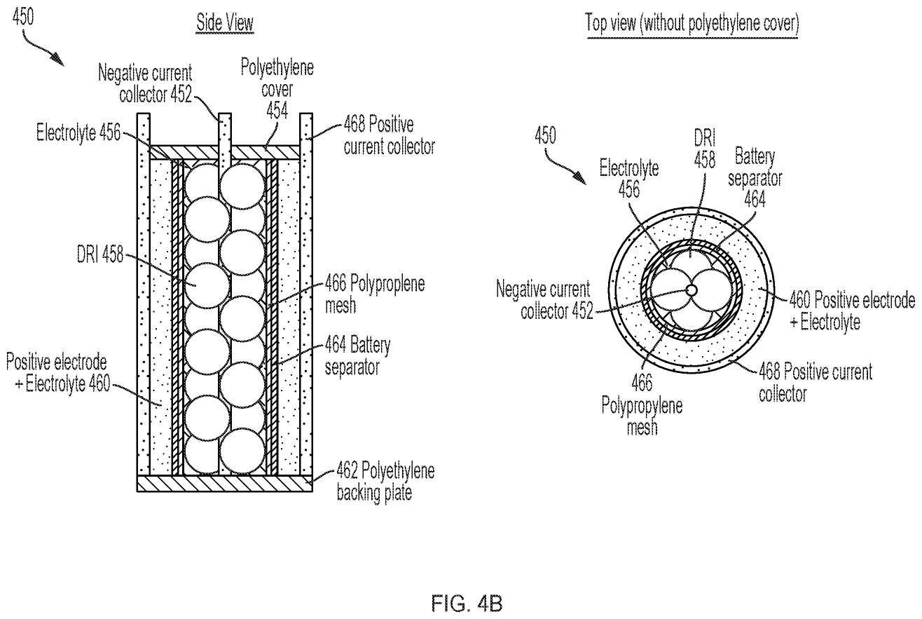

In another non-limiting example, pelletized direct reduced iron (DRI) is used as the negative electrode. In some embodiments, the electrochemical cell using DRI as the negative electrode and the manganese oxide based positive electrode is in prismatic cell configuration or stacked prismatic cell configuration as shown in FIG. 4A. For example, FIG. 4A illustrates a prismatic stack 400 of six electrochemical cells 410 using pelletized DRI as the negative electrode 403 and a manganese compound based positive electrode 407 similar to the stacked configuration discussed above with reference to FIG. 1B. Each cell 410 includes a negative electrode 403 immersed in electrolyte 401 separated from the positive electrode 407 by a polypropylene mesh 405 and battery separator 406. Bipolar current collectors 402 are disposed between each cell 410 and are at the sides of the edge cells 410 in the stack 400. Polyethylene backing plates 404 are disposed outboard of the two end cells 410 and bipolar current collectors 402 in the stack and polyethylene frames 408 support each cell 410. In some embodiments, the electrochemical cell 450 using DRI as the negative electrode 458 and the manganese oxide based positive electrode 460 is in cylindrical cell configuration as shown in FIG. 4B. FIG. 4B illustrates a side view of the cell 450 on the left side of the figure and a top view of the cell 450 on the right side of the figure, the top view shown with the polyethylene cover 454 removed in that view. A negative current collector 452 is at the center of the packed DRI forming the negative electrode 458. The negative electrode 458 is supported in a polypropylene mesh 466 and submerged in electrolyte 456. The battery separator 464 separates the negative electrode 458 from the positive electrode 460 and positive electrolyte. The positive current collector 468 surrounds the positive electrode 460. A polyethylene backing plate 462 forms the bottom of the cell 450 and a polyethylene cover 454 encloses the top of the cell 450. As illustrated in the top view, the negative electrode 458 surrounds the negative electrode 452, the separator 464 surrounds the positive electrode 460, electrolyte 456, and polypropylene mesh 466, the positive electrode 460 and its electrolyte surrounds the separator 464, and the positive current collector 468 surrounds the positive electrode 460.

In another non-limiting example, the manganese-bearing compound in the positive electrode is δ-MnO₂ (birnessite) with layered crystal structure. The interlayer of δ-MnO₂ may contain metal cations. The metal cations are Li⁺, Na⁺, K⁺, Mg²⁺, Ca²⁺, Ba²⁺, Cu²⁺, Fe²⁺, Fe³⁺, Bi³⁺, Pb²⁺, Zn²⁺, or combinations thereof. The interlayer of δ-MnO₂ may contain protons. The interlayer of δ-MnO₂ may contain water molecules. In some embodiments, δ-MnO₂ is chemically produced from water soluble manganese precursors such as NaMnO₄, KMnO₄, MnSO₄, MnCl₂, Mn(NO₃)₂, Mn (II) acetate, or combinations thereof, prior to cell assembly. In certain embodiments, δ-MnO₂ is produced by mixing stoichiometric amounts of NaMnO₄ and MnSO₄ aqueous solutions in the presence of 1 mol/L KCl, followed by heat treatment of the mixed solutions at 90° Celsius for 1 hour. In some embodiments, δ-MnO₂ is electrochemically produced in-situ upon cycling after the cell was assembled using MnO₂ in other phases such as α-MnO₂, natural MnO₂ (β-MnO₂), electrolytic manganese oxide (EMD, γ-MnO₂, ε-MnO₂), or combinations thereof. In some embodiments, δ-MnO₂ is produced in situ during the first charge/discharge cycle. In some embodiments, δ-MnO₂ is produced in situ during the first few charge/discharge cycles.

In another non-limiting example, the manganese-bearing compound in the positive electrode is α-MnO₂ with open-tunnel crystal lattice structure. The tunnels of α-MnO₂ may contain metal cations such as Li⁺, Na⁺, K⁺, Mg²⁺, Ca²⁺, Ba²⁺, Cu²⁺, Fe²⁺, Fe³⁺, Bi³⁺, Pb²⁺, Zn²⁺, or combinations thereof. The tunnels of α-MnO₂ may contain protons. The tunnels of α-MnO₂ may contain water molecules. In some embodiments, α-MnO₂ is chemically produced from water soluble manganese precursors such as NaMnO₄, KMnO₄, MnSO₄, MnCl₂, Mn(NO₃)₂, Mn (II) acetate, or combinations thereof, prior to cell assembly. In certain embodiments, α-MnO₂ is produced by mixing KMnO₄ and MnCl₂ aqueous solutions in equal molar concentrations, such as, but not limited to, 0.2 mol/L, followed by hydrothermal conversion at elevated temperature and pressure, such as 160° Celsius for 6 hours in an autoclave. In some embodiments, the temperature is in the range of 100° Celsius to 200° Celsius. In some embodiments, the pressure is the range of 1 atm to 20 atm.

In another non-limiting example, the manganese-bearing compound and Bi₂O₃ powder are physically mixed through ball milling in the presence of conductive matrix In some embodiments, the manganese-bearing compound is MnO₂ powder including but not limited to α-MnO₂, natural MnO₂ (β-MnO₂), EMD, birnessite, or combinations thereof. In some embodiments, the manganese-bearing compound is naturally existing manganese-bearing ore including but not limited to birnessite, pyrolusite, hausmannite, akhtenskite, hollandite, ramsdellite, nsutite, spinel, psilomelane, todorokite, bixbyite, vernadite, or combinations thereof. In certain embodiments, the naturally existing manganese-bearing ore is unprocessed. In certain embodiments, PTFE as the binder is added in the powder mixture before milling. In some embodiments, a conductive matrix such as graphite, carbon black, activated carbon, nickel powder, or combinations thereof, is added in the powder mixture before milling. The milled powder mixture is combined with a metal or graphite current collector and used as the positive electrode in an assembled cell. In some embodiments, the assembled cell is in full-cell configuration using DRI negative electrode. In some embodiments, the assembled cell is in full-cell configuration using sintered iron negative electrode. In some embodiments, the Bi-doped MnO₂ is produced through constant current cycling. In some embodiments, the cut-off potential during the reducing process is <−0.4V vs. mercury/mercury oxide (MMO) reference electrode. In certain embodiments, the cut-off potential during the reducing process is between −0.5V and −0.7V vs. MMO reference electrode. In some embodiments, the cut-off potential during the oxidizing process is >−0.3V vs. MMO reference electrode. In certain embodiments, the cut-off potential during the reducing process is between 0.1V and 0.3V vs. MMO. In some embodiments, the charge/discharge rate is between C/24 and C/1. In certain embodiments, the charge/discharge cycle number is 1. In some embodiments, the Bi-doped MnO₂ is produced through constant potential cycling. In some embodiments the reducing potential is <−0.5V vs. MMO reference electrode and the oxidizing potential is >0.1V vs. MMO reference electrode. In some embodiments, the Bi-doped MnO₂ is produced through constant power cycling. In some embodiments, the Bi-doped MnO₂ is produced through cyclic voltammetry. In certain embodiments, the upper potential of cyclic voltammetry is between 0.1V and 0.3V vs. MMO reference electrode. In certain embodiments, the lower potential of cyclic voltammetry is between −0.5V and −0.7V vs. MMO reference electrode. In some embodiments, the scan rate <100 mV/s. In certain embodiments, the scan rate is between 0.1 mV/s and 1.0 mV/s. In some embodiments, the cycle number is <100. In certain embodiments, the cycle number is <10.

In another non-limiting example, an electrochemical cell with a nominal discharge duration of 1 hour with the rated current density at 15 mA/cm² and rated cell voltage at 0.79V. was built based on the proposed electrode reactions. MnO₂ powder and Bi₂O₃ powder are physically mixed and milled in the presence of graphite. According to various embodiments, MnO₂ powder is α-MnO₂, natural MnO₂ (β-MnO₂), EMD, birnessite, or combinations thereof. In certain embodiments, PTFE as the binder is added in the powder mixture before milling. In certain embodiments, 30 wt % KOH solution is added in the powder mixture before milling. In certain embodiments, the MnO₂ loading in the positive electrode is 65 wt %. The milled manganese containing powder mixture is used as the positive electrode in an assembled cell. Iron-bearing powder and Bi₂S₃ powder are physically mixed and milled in the presence of graphite. In some embodiments, iron-bearing powder is metallic iron such as DRI fines, smashed DRI, or combinations thereof. In some embodiments, iron-bearing powder is an iron-bearing compound such as Fe(OH)₂, Fe₂O₃, Fe₃O₄, or combinations thereof. In certain embodiments, PTFE as the binder is added in the powder mixture before milling. The milled iron containing powder mixture is used as the negative electrode in an assembled cell. In some embodiments, the mixed positive electrode powders are coated on both sides of the current collector with the powder thickness of 200 micron on each side of the current collectors. In some embodiments, the mixed negative electrode powders are coated on both sides of the current collector with the powder thickness of 200 micron on each side of the current collectors. According to various embodiments, the current collectors are nickel coated carbon steel with less than 10 micron thick nickel coating. In some embodiments, the current collectors are 100 micron thick. In some embodiments, hydrophilic polypropylene battery separator such as Celgard 3501 is placed between the positive electrode and the negative electrode. In some embodiments, the electrode porosity is between 20% and 30%. In some embodiments, the active area of the electrodes is 1000 cm². In some embodiments, the cell-level energy density is higher than 50 Wh/L. In certain embodiments, the cell-level energy density is 55 Wh/L. In certain embodiments, the cell-level energy cost is $100/kWh.

In one non-limiting example, the described manganese-bearing positive electrodes can be coupled with iron-bearing negative electrodes as stationary electrochemical energy storage systems with a target duration of 24 hours. In some embodiments, the target duration of Fe—MnO₂ batteries as energy storage systems is between 12 and 36 hours. In another non-limiting example, the described manganese-bearing positive electrodes can be coupled with iron-bearing negative electrodes as black starter with a target duration of 30 min. In some embodiments, the target duration of Fe—MnO₂ batteries as black starters is between 1 and 60 min. In another non-limiting example, the described manganese-bearing electrodes can be included as an auxiliary electrode in a large scale long duration energy storage system using Fe-air chemistries. In this embodiment, the manganese-bearing electrode(s) serving as a black starter are placed on the positive electrode side of the Fe-air batteries. In this embodiment, the manganese-bearing auxiliary electrode(s) stop discharging when oxygen reduction reaction takes place on the main positive electrode. In this embodiment, the manganese-bearing auxiliary electrode(s) are charged during the regular charging process of the Fe-air batteries before or along the oxygen evolution reaction taking place on the main positive electrode.

In certain embodiments the electrolyte is a near-neutral aqueous solution, in which the pH is between 4 and 10. In certain embodiments the electrolyte is a sulfate or chloride solution such as Li₂SO₄, Na₂SO₄, K₂SO₄, CuSO₄, NaCl, LiCl, KCl, CuCl₂, or combinations thereof, dissolved in water.

Various embodiments may include a battery, comprising: a first electrode, comprising a manganese oxide; an electrolyte; and a second electrode, comprising direct reduced iron. In some embodiments, the electrolyte is a liquid electrolyte. In some embodiments, the electrolyte comprises an alkali metal hydroxide comprising lithium hydroxide (LiOH), sodium hydroxide (NaOH), potassium hydroxide (KOH), cesium hydroxide (CsOH), or mixtures thereof. In some embodiments, the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof. In some embodiments, the second electrode is pelletized and comprises a multimodal distribution. In some embodiments, the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof. In some embodiments, the second electrode further comprises iron oxides, hydroxides, sulfides or mixtures thereof. In some embodiments, the second electrode further comprises one or more secondary phases including silica (SiO₂) or silicates, calcium oxide (CaO), magnesium oxide (MgO) or mixtures thereof. In some embodiments, the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof. In some embodiments, the second electrode further comprises one or more hydrogen evolution reaction suppressants. In some embodiments, the first electrode has a specific surface area less than about 50 m²/g. In some embodiments, the first electrode has a specific surface area less than about 1 m²/g. In some embodiments, the second electrode has a specific surface area less than about 5 m²/g. In some embodiments, the second electrode has a specific surface area less than about 1 m²/g. In some embodiments, the first electrode comprises a binder comprising polytetrafluoroethylene (PTFE), polyvinylidene difluoride (PVdF), polypropylene (PP), polyethylene (PE), fluorinated ethylene propylene (FEP), polyacrylonitrile, styrene butadiene rubber, carboxymethyl cellulose (CMC), sodium carboxymethyl cellulose (Na-CMC), polyvinyl alcohol (PVA), polypyrrole (PPy), or combinations thereof. In some embodiments, the first electrode comprises an additive comprising bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof. In some embodiments, a separator material is used between the first electrode and the second electrode. In some embodiments, a stack of batteries may comprise a plurality of batteries as described above. In some embodiments, the stack of batteries may include current collectors connecting two or more electrochemical repeating units of the same polarity. In some embodiments, the stack of batteries may include a bipolar current collector connecting two or more electrochemical repeating units of differing polarities.

Various embodiments may provide a method of making a battery, comprising: providing a first electrode comprising a manganese oxide; providing a second electrode, comprising direct reduced iron; and providing an electrolyte located between the first electrode and the second electrode. In some embodiments, the electrolyte comprises a liquid electrolyte.

Without being limited to any specific theory or model of the reactivity of the iron electrode, possible schemes for the oxidation of the iron electrode in alkaline electrolyte can proceed according to the following two reaction steps, Reaction 1 and Reaction 2 below. Additional or different reaction products are possible (one of which is described in Reaction 3 below), but the characteristic of volume change through the reaction is general to any oxidation product relative to metallic iron. Reactions 1, reaction 2, and reaction 3 are as follows:

| | | |
|---|---|---|
| Reaction 1: | Fe + 2OH⁻ → Fe(OH)₂ + 2e⁻ | E⁰ = −0.88 V vs. SHE; |
| Reaction 2: | 3Fe(OH)₂ + 2OH⁻ → Fe₃O₄ + 4H₂O + 2e⁻ | E⁰ = −0.76 V vs. SHE; and |
| Reaction 3: | Fe(OH)₂ + OH⁻ → FeOOH + H₂O + e⁻ | E⁰ = −0.61 V vs. SHE. |

Table 4 gives some key physical properties of selected iron-containing materials which may be used as negative electrode active materials (for example in the negative electrodes 102, 231, 301, 403, and 458 discussed above) in alkaline iron-based electrochemical cells, including batteries and metal-air batteries. The Pilling-Bedworth ratio is the ratio of the volume of the elementary cell of a metal oxide to the volume of the elementary cell of the corresponding metal (from which the oxide is created) and is a measure of the net volume change in one step of the reaction. In Table 4, the Pilling-Bedworth ratio is computed for the transformation from iron metal to the specified iron-bearing phase. Theoretical specific capacities are computed based on mass of Fe.

TABLE 4

| Characteristic | Fe | Fe(OH)₂ | Fe₃O₄ | Fe₂O₃ | FeOOH | Fe(OH)₃ | FeCO₃ | FeS | FeS₂ | FeO | FeTiO₃ |
|---|---|---|---|---|---|---|---|---|---|---|---|
| Molar mass | 55.85 | 89.86 | 231.53 | 159.69 | 88.85 | 106.867 | 115.85 | 87.92 | 119.98 | 71.844 | 151.7 |
| (g/mol) | | | | | | | | | | | |
| Density | 7.87 | 3.40 | 5.17 | 5.24 | 4.25 | 3.90 | 3.90 | 4.84 | 5.00 | 5.74 | 4.72 |
| (g/cc) | | | | | | | | | | | |
| Molar | 7.09 | 26.43 | 44.78 | 30.48 | 20.91 | 27.40 | 29.71 | 18.17 | 24.00 | 12.52 | 32.14 |
| volume | | | | | | | | | | | |
| (cc/mol) | | | | | | | | | | | |
| Volume per | 7.09 | 26.43 | 14.93 | 15.24 | 20.91 | 27.40 | 29.71 | 18.17 | 24.00 | 12.52 | 32.14 |
| mol Fe | | | | | | | | | | | |
| (cc/mol) | | | | | | | | | | | |
| Pilling- | — | 3.73 | 2.10 | 2.15 | 2.95 | 3.86 | 4.19 | 2.56 | 3.38 | 1.76 | 4.53 |
| Bedworth | | | | | | | | | | | |
| Ratio | | | | | | | | | | | |
| Theoretical | — | 959.76 | 1279.68 | 1439.64 | 1439.64 | 1439.64 | 959.76 | 959.76 | 959.76 | 959.76 | 959.76 |
| Specific | | | | | | | | | | | |
| Capacity- | | | | | | | | | | | |
| Direct | | | | | | | | | | | |
| (mAh/gFe) | | | | | | | | | | | |

Electrochemical cells using iron-based materials as the negative electrode (e.g., cells 100, 131, 230, 240, 250, 260, 300, 410, and 450 discussed above) may be assembled in either the charged state, in the discharged state, or at an intermediate state of charge. For example, using metallic iron as the active material in the as-assembled cell would start in the charged state. By contrast, starting with hematite (Fe₂O₃) in the as-assembled cell would start in the discharged state. Starting with Fe(OH)₂ in the as-assembled cell would constitute starting in an intermediate state of charge.

The present invention describes materials, systems, and methods, for the use of various iron-bearing materials, starting from the discharged or partially discharged state in an alkaline electrochemical cell such as an Fe—Ni, Fe—MnO₂, or Fe-air battery. In certain embodiments of the present invention, the iron-bearing material comprises certain iron-bearing minerals, also known as iron ores. In certain cases, Mn-rich ores are referred to as “manganiferous ores.” Table 5 describes non-limiting examples of various common mineral forms of iron-bearing materials according to their mineral name, the general corresponding chemical formula, and the typical weight percentage of iron. Iron ores may comprise one or more of such iron-bearing minerals, as well as any other naturally-occurring mineral form comprising iron.

TABLE 5

| Mineral | Chemical Formula | Fe weight % |
|---|---|---|
| Hematite | Fe₂O₃ | 70.0 |
| Magnetite | Fe₃O₄ | 72.4 |
| Martite | xFe₂O₃ · yFe₃O₄ | 70~72 |
| Goethite | Fe₂O₃ · H₂O (2 FeOOH) | 62.9 |
| Limonite | 2Fe₂O₃ · 3H₂O | 59.8 |
| Siderite | FeCO₃ | 48.3 |
| Pyrite | FeS₂ | 46.6 |
| Ilmenite | FeTiO₃ | 36.8 |
| Wustite | FeO | 77.7 |
| Spinel Manganese Ferrite | FeMn₂O₄ | 24.3 |

Iron ores may comprise an iron-bearing material such as (but not limited to) the mineral forms described in Table 5, along with impurity phases, such as SiO₂, Al₂O₃, TiO₂, CaO, MgO, and other impurity phases. Collectively, these impurity phases are called “gangue” phases in the art. Iron ores are mined and, as needed, concentrated or beneficiated to produce a high Fe content (generally >60 wt % Fe) for subsequent processing including but not limited to reduction via a blast furnace, direct reduction process (such as a shaft furnace reduction, rotary hearth, linear hearth, rotary kiln, or fluidized bed reduction), etc. The main stages of processing or classification before reduction: include: (1) Mined ore. Ores are commonly classified according to their iron-content, and sometimes are classified as Low-grade, Medium-grade, or High-grade; (2) Direct shipping ores; (3) Beneficiated ores (“concentrate”, or “pellet feed”); and (4) Pelletizing (an agglomeration process). Common outputs may be referred to herein as Direct Reduction grade (“DR grade”) and Blast Furnace Grade (“BR grade). Herein, the term “ore” may be used to refer to the material which is mined. The term “concentrate” may be used refer to the processed ore, which has had gangue phases preferentially removed to increase the Fe weight fraction. These concentrates are generally (though not always) a powdery or slurry form. Typical compositions for various iron ores and concentrates are described in Table 6.

TABLE 6

| | Magnetite | | Magnetite | | Hematite | | Hematite | |
|---|---|---|---|---|---|---|---|---|
| | Concentrate | | Ore | | Concentrate | | Ore | |
| | Min | Max | Min | Max | Min | Max | Min | Max |
| Fe | 61.8 | 68.5 | 33 | 45 | 67.2 | 68.4 | 60.6 | 69 |
| (total) | | | | | | | | |
| FeO | 20.8 | 29.87 | 0 | 0 | 0 | 0 | 0 | 0 |
| Fe₂O₃ | 59.77 | 66.21 | 0 | 0 | 0 | 0 | 0 | 0 |
| SiO₂ | 4.1 | 12.5 | 0 | 0 | 1 | 2.5 | 0.41 | 5.1 |
| Al₂O₃ | 0.04 | 0.32 | 0 | 0 | 0.3 | 0.65 | 0.35 | 6 |
| CaO | 0.04 | 0.54 | 0 | 0 | 0 | 0 | 0 | 0 |
| MgO | 0.1 | 0.86 | 0 | 0 | 0 | 0 | 0 | 0 |
| S | 0.006 | 221 | 0 | 0 | 0 | 0 | 0.001 | 0.006 |
| P | 0.009 | 24 | 0.4 | 0.4 | 0 | 0 | 0.02 | 0.05 |
| K₂O | 0.03 | 0.032 | 0 | 0 | 0 | 0 | 0 | 0 |
| Na₂O | 0.06 | 0.06 | 0 | 0 | 0 | 0 | 0 | 0 |
| TiO₂ | 0.002 | 0.3 | 11 | 11 | 0 | 0 | 0 | 0 |
| Mn | 0 | 0 | 0 | 0 | 0 | 0 | 0 | 0 |
| V | 0 | 0 | 0 | 0 | 0 | 0 | 0 | 0 |
| Cu | 0 | 0 | 0 | 0 | 0 | 0 | 0 | 0 |
| Pb | 0 | 0 | 0 | 0 | 0 | 0 | 0 | 0 |
| Zn | 0 | 0 | 0 | 0 | 0 | 0 | 0 | 0 |
| Cr | 0 | 0 | 0 | 0 | 0 | 0 | 0 | 0 |
| V₂O₃ | 0 | 0 | 0.3 | 0.3 | 0 | 0 | 0 | 0 |

Ore sources are sometimes named according to their composition (e.g. “hematite,” or “magnetite”) and in other cases, they are named according to a specific geological formation. For example, one common source of iron ore in the United States is called “taconite,” which is a relatively low-grade iron ore comprising the mineral forms of magnetite, hematite, chert, siderite, greenalite, minnesotaite, and stilpnomelane. Taconite generally is mined with an iron content of 20-35 wt % Fe. Due to the low Fe content, taconite is typically beneficiated (the iron content is increased by removal of gangue phases). Taconite is beneficiated by crushing and grinding of the ore into a fine powder, followed by separation by flotation or magnetic separation to form the “concentrate” which comprises a higher weight percentage of iron than the raw taconite ore. This powder is then mixed with a binder, such as bentonite clay, and agglomerated to form pellets. Depending on the residual gangue content contained in the pellets, these may be classified as Blast Furnace grade (BF grade) or Direct Reduction grade (DR grade). The typical composition of DR Grade pellets are described in Table 7.

TABLE 7
DR Grade

| | Typical | Range |
|---|---|---|
| Fe wt % | 67 | 63-67 |
| FeO wt % | 0.5 | 0-2 |
| CaO wt % | 0.5 | 0-2 |
| MgO wt % | 0.25 | 0-2 |
| SiO₂ wt % | 2 | 0-4 |
| Al₂O₃ wt % | 0.26 | 0-4 |
| S wt % | 0.002 | <0.01 |
| P wt % | 0.028 | <0.05 |

The typical composition of BF Grade pellets are described in Table 8.

TABLE 8
BF Grade

| | Typical | Range |
|---|---|---|
| Fe wt % | 67 | 63-67 |
| FeO wt % | 0.5 | 0-2 |
| CaO wt % | 0.5 | 0-2 |
| MgO wt % | 0.25 | 0-2 |
| SiO₂ wt % | 5 | 2-7 |
| Al₂O₃ wt % | 0.26 | 0-4 |
| S wt % | 0.002 | <0.01 |
| P wt % | 0.028 | <0.05 |

Higher quality iron ores may have higher Fe content as mined, and do not require beneficiation. These are referred to “direct shipping ores.”

One aspect of the present invention is the use of iron ore materials in electrochemical cells, such as cells 100, 131, 230, 240, 250, 260, 300, 410, 450, etc. Another aspect of the present invention is the use of concentrate as active material in an electrochemical cell, such as cells 100, 131, 230, 240, 250, 260, 300, 410, 450, etc. Another aspect of the present invention is the use of BF grade pellets in an electrochemical cell, such as cells 100, 131, 230, 240, 250, 260, 300, 410, 450, etc. Another aspect of the present invention is the use of DR grade pellets in an electrochemical cell, such as cells 100, 131, 230, 240, 250, 260, 300, 410, 450, etc. Another aspect of the present invention is the use of combinations and variations of iron ores, concentrates, BF grade pellets, and DR grade pellets in an electrochemical cell, such as cells 100, 131, 230, 240, 250, 260, 300, 410, 450, etc. According aspects of the present invention, iron ores are beneficially used as redox-active electrodes in electrochemical cells, including in storage batteries of primary (also referred to as “disposable”) or secondary (also referred to as “rechargeable”) type.

In another aspect of the invention, iron ore materials, may be processed in such a way as to preferentially promote the presence of iron-containing phases which optimize for performance in an electrochemical device. Performance metrics which may be so improved include but are not limited to specific capacity (measured in mAh/g), kinetic overpotentials, coulombic efficiency, cycle life, calendar life. As one example, the iron ore pellets (both BF grade and DR grade) previously described are commonly processed in a way that promotes the presence of hematite, as such pellets are produced primarily for use in steelmaking. Iron ore materials are beneficiated as previously described to produce a concentrate which contains both magnetite and hematite. After mixing with binder and agglomeration to form a pellet, these pellets are subjected to a heat treating step called “induration,” which serves to: 1) sinter the pellets to improve mechanical strength; and 2) to convert the magnetite to hematite. The time, temperature, and atmosphere are selected to promote this phase transformation according to the processes optimized for the use of these pellets in steelmaking (for example, in a blast furnace or in a direct reduction process). However, hematite is much less conductive than magnetite and hematite seems to be more difficult to reduce electrochemically than magnetite. In one embodiment of the present invention, these thermal processing steps are eliminated, enabling the presence of a greater fraction of magnetite; such un-indurated pellets may be called “green pellets,” or “green bodies” in the art. In another embodiment, the processing conditions are selected to sinter the pellets, but selected in a way that maximizes the phase fraction of magnetite. In certain embodiments, the induration step involves exposure to oxygen such that the magnetite oxidizes to hematite. The partial pressure of the oxidation step may be controlled to remain in a magnetite field instead of entering the hematite field. In certain embodiments, the time and temperature are selected to promote sintering, but to minimize coarsening of the iron ore grains, such that the primary particle size remains fine. In certain embodiments, the primary particle size of the magnetite grains is less than 500 microns (micron=10⁻⁶ m), or less than 100 microns, or less than 50 microns.

In certain embodiments, the iron ore is subsequently fabricated into electrodes by thermochemical reduction. In some embodiments, the reduction may proceed almost to complete reduction of the iron oxides to metallic iron. Nearly complete reduction of the iron oxide to metallic iron is the goal of many industrial thermochemical reduction processes for iron.

In other embodiments, the iron ore is incompletely reduced to metallic iron. There are several reasons why such incompletely-reduced products may be particularly useful for iron batteries. First, several of the oxide phases created during the reduction of iron are semiconducting, and thus may usefully serve as electronic conductors in an iron electrode material. For example, magnetite is fairly conductive close to room temperature. Wustite, while less conductive than magnetite, is still highly conductive relative to most oxides. In some embodiments, one may take advantage of the semiconducting nature of wustite and magnetite to form a battery electrode which is possibly a composite with metallic iron. Partially reduced products may also be more electrochemically active. The inventors have observed that wustite may in some circumstances be more electrochemically active than even metallic iron. Wustite may be less expensive to thermochemically reduce due to its higher oxidation state than metallic iron. Wustite may therefore be both less expensive and higher performance than metallic iron as a component of a battery electrode. In one aspect, a positive electrode for an alkaline iron battery may be produced from indurated pellets composed of hematite traditionally fed to direct reduction or blast furnace processes. The pellets may be reduced in a vertical shaft furnace via appropriate mixtures of hydrocarbons and other reducing gases known in the art of the direct reduction of iron. The reduction process may terminate by way when a metallization of at most 95% is achieved (metallization is a term used in the art of direct reduction of iron to describe the fraction of iron atoms which are fully metallic in their oxidation state). In some instances, a lower metallization may be preferred, with metallizations as low as 0% yielding large quantities of magnetite and wustite as alternative input materials for a battery. The resulting partially reduced pellets, lump, fragment or other particulate may be packed into a bed of particles in order to serve as an iron electrode material. The electrode material may consist entirely of iron oxides, and comprise primarily a mixture of magnetite and wustite.

The iron ore materials comprising the electrodes, devices, and systems of the invention may have a wide range of purities, and indeed may have relatively high impurity concentrations compared to iron-bearing materials that are synthesized from purified sources of iron. Table 9 lists several of the more commonly found impurities in iron ores, and their typical ranges of concentration in weight percentage. In some aspects of the invention, said iron ore materials may have at least a minimum amount of such naturally-occurring impurities, singly or in combination.

TABLE 9

| Component | Low | Mid | High |
|---|---|---|---|
| SiO₂ wt % | 0.05 | 4 | 7 |
| Al₂O₃ wt % | 0.02 | 0.04 | 6 |
| CaO wt % | 0.02 | 0.5 | 5 |
| MgO wt % | 0.05 | 0.25 | 3 |
| TiO₂ wt % | 0.0001 | 0.3 | 12 |

Non-limiting advantages to the use of iron ores in such applications include low cost and widespread availability of the ores. The use of such ores does not preclude the selection of the ores for particular physical and chemical characteristics, nor does it preclude further processing of the ores (as in the example of concentrates, BF grade pellets, and DR grade pellets).

In certain embodiments, the presence of certain impurity phases is preferentially increased, to derive additional performance benefits in an electrochemical cell using an alkaline electrolyte. For example, alkaline electrolytes are subject to reaction with carbon dioxide (CO₂) to form carbonate anions (CO₃²⁻) which is well-known in the art as a degradation mechanism of such electrolytes. CaO, when contacted with water, will react to form Ca(OH)₂ according to CaO+H₂O->Ca(OH)₂. Ca(OH)₂ is known to react with CO₃²⁻ to trap carbonate as CaCO₃ and release hydroxide ions OH⁻. Thus, the presence of CaO in the iron material provides for a carbonate sink, which scrubs carbonate from the alkaline electrolyte. Analogous reactions are possible using MgO and BaO as well. In certain embodiments, the mass fraction of CaO is selected to be as high as possible to provide maximum carbonate trapping capability.

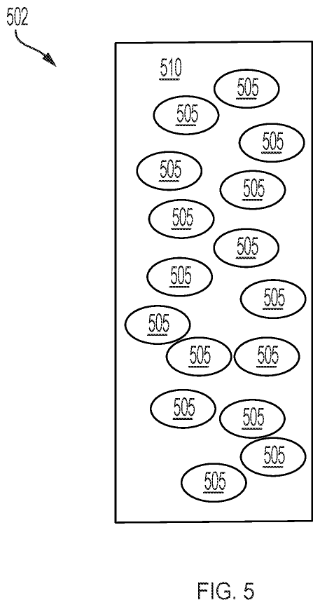

In various embodiments, the electrodes and devices of the invention, in addition to comprising iron ores, may comprise other materials. Electrodes of the invention may comprise a composite which may include said iron ore or ores mixed with DRI pellets and/or smaller metal particles such as metal fines or shavings. For example, as illustrated in FIG. 5, the negative electrode 502 may include spherical pellets 505 comprised of taconite and a smaller metal particle composition 510 comprised of conductive material. The negative electrode 502 may be an example of negative electrodes discussed above, such as negative electrodes 102, 231, 301, 403, and 458. By combining low cost taconite pellets used as a bulk iron feedstock for the pellets 505 and a conductive additive 510, the cost of forming a conductive electrode upon assembly of a battery may be lowered. As other examples, the composite metal electrode architecture may include a mixture of different sized iron ore particles, such as larger iron ore pellets (e.g., taconite, DRI, sponge iron, atomized iron, etc.) and a smaller metal particle composition, such as metal fines or shavings (e.g., fines or shavings of DRI, taconite, sponge iron, atomized iron, etc.).

The iron ores used for the purposes herein may be selected, or further processed or treated, to improve certain physical characteristics. These characteristics include, but are not limited to, improved electrical conductivity, improved surface or interfacial reaction kinetics, and accommodation of the volume change induced by electrochemical transformation during cycling, as characterized at least in part by the Pilling-Bedworth ratio illustrated in Table 4.

In some embodiments, the electrical conductivity of the metal electrode is increased by adding conductive fibers, wires, mesh, or sheets to the pellets such that the conductive material is dispersed between individual pellets. In one embodiment, the conductive fiber comprises copper or iron. In another embodiment, the fiber is a chopped fiber. In another embodiment, the fiber is iron, and its diameter is selected to be larger than the thickness of iron that is reversibly oxidized and reduced as the battery is discharged and charged. Accordingly, the interior of the fiber remains as metallic iron as the electrode, including said fiber participates in the electrochemical reaction of the cell, maintaining a metallic conductive path within the electrode. In another embodiment, said fibers are sintered to the iron ore in fabricating the electrode.

In other embodiments, a conductive additive is added to the mineral form comprising iron. Without being bound by any particular scientific interpretation, said conductive additive may facilitate electrochemical reactions of the iron by providing electronically conductive pathways for electrons to be conveyed to and from the redox-active iron sites. Said conductive additive may be almost any electronically conductive material including but not limited to met-als, metal carbides, metal nitrides, metal oxides, and allot-ropes of carbon including carbon black, carbon black of high structure, graphitic carbon, carbon fibers, carbon microfibers, vapor-grown carbon fibers 65 (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments. An electronically conductive poly-mer, including but not limited to polyaniline or polyacetylene based conductive polymers or poly(3,4-ethylenediox-ythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocene-substi-tuted polyethylene, carbazole-substituted polyethylene, polyoxyphenazine, polyacenes, or poly(heteroacenes).

In some embodiments, the conductive additive comprises an ore or metal salt. In some embodiments, said ore or metal salt is reduced thermochemically or electrochemically to a more highly electronically conductive form. In some embodiments, said more highly electronically conductive form comprises a metal salt, such as a metal oxide, or a metal. In some embodiments, the ore or metal salt yielding the conductive additive is selected to have a less negative free energy of formation (i.e., is more noble) than the iron ore or mineral or salt comprising the electrode, and may be preferentially reduced over the iron ore or mineral or salt. As a non-limiting example, the metal comprising the conductive additive may be produced from a starting ore or mineral form of the metal by thermochemical reduction to the metallic form. In some embodiments, the conductive additive comprises Ni, Co, Cu, Zn, Sn, brass, bronze, or Ag.

In one particular embodiment, the conductive additive comprises copper, and is made by adding a copper ore to the iron ore and subsequently heating the mixture at a temperature and a reducing gaseous environment whereby the copper ore is reduced to metallic copper. Optionally, the reducing environment may comprise hydrogen gas. In some embodiments the copper wets the surfaces of the iron ore and infiltrates or partially infiltrates the iron ore. Optionally, the electrode may be heat treated below the melting point of the copper to allow the solid copper to subsequently dewet the iron ore.

In another such embodiment, copper metal and the iron ore, or a copper ore and the iron ore, are heat treated and co-sintered to produce a composite electrode with high electronic conductivity provided by the metallic copper constituent.

In some embodiments, the conductive additive and the iron ore material are arranged in physical proximity and size scale to provide for improved transport of electrons and ions to the redox-active microscopic regions of the electrode. In some embodiments, the conductive additive may form a continuous, percolating network through the electrode. In other embodiments, the iron ore is in the form of particles, and the conductive additive substantially coats the surface of the particles. In some embodiments, the conductive additive preferably comprises less than 20% by volume of the combined volume of the iron ore and the conductive additive, preferably less than 10% by volume, and still preferably less than 5% by volume.

Even when electronic conductivity is improved through addition of a conductive additive, other factors such as the particle size of the iron ore may affect the rate of the electrochemical reactions, and correspondingly, the charge and/or discharge rate and efficiency of the electrode. While fine particles may have a higher surface area for electrochemical reaction and a smaller cross-sectional dimension for electron or ion transport, and thereby improve the rate of electrochemical reactions, they may also be more subject to the influence of passivating (that is, electrically insulating) surface layers that may form in service, and may be more costly to produce from mined materials. For the purposes of the present discussion, the primary particle size is considered to be the size of a solid particle generally free of internal porosity, whereas the secondary particle size is that of a collection of bound primary particles. Accordingly, the pellets of iron ore materials referred to previously constitute secondary particles. In some embodiments, the iron ore primary particles or the iron ore secondary particles comprising the electrodes, devices, and systems of the invention have a mean particle size corresponding to about a −325 mesh size (less than about 44 micrometers). In other embodiments, the iron ore particles have a mean primary particle size less than about 10 micrometers. In some embodiments, the iron ore particles have a primary particle size greater than about 10 micrometers, preferably greater than about 15 micrometers, and still more preferably greater than about 20 micrometers.

In general, the secondary particles comprising the iron ore electrodes of the invention, which include pelletized forms of the iron ores, may have substantial porosity, for at least two reasons. The porosity enables infiltration of the electrode secondary particle or pellet by the electrolyte of the electrochemical cell. The porosity also accommodates the change in volume of the iron ore material as it is cycled between a discharged (oxidized) state and a charged (reduced) state. As illustrated in Table 4, the Pilling-Bedworth ratio of iron-bearing minerals can be a factor of 2 to 5. Accordingly, the porosity of the electrode comprising the conductive additive and iron ore material, not including changes in volume due to subsequent electrochemical operation of the battery is, by volume, preferably between 10% and 80%, more preferably between 20% and 70%, and still more preferably between 30% and 50%. In some embodiments, at least 70% of said porosity is filled with a liquid electrolyte, preferably more than 80%, and still more preferably, more than 90%.

In some embodiments, the conductive additive forms a porous structure with cavities within which particles of the iron ore reside, thereby allowing free volume surrounding the iron ore particles to permit expansion and contraction, while the iron ore particle remains electrically connected to a continuous structure of the conductive additive. In some such structures, the cavity in the porous conductive structure is equiaxed. In other embodiments, the cavities are anisometric, and may be extended in one dimension in the form of tubes, or in two dimensions to form plate-like cavities of various aspect ratios.

In some embodiments, the electrode of the invention is a composite comprising the iron ore and an added material that provides elastic compliance to the electrode, thereby permitting repeated expansion and contraction of the redox-active material during discharge and charge. In some embodiments the added material is a polymer or polymeric binder. In some instances, the conductive additive is also said compliant material. Examples of polymeric binders: sodium carboxymethyl cellulose (Na-CMC), lithium carboxymethyl cellulose (Li-CMC), potassium carboxymethyl cellulose (K-CMC), polyacrylic acid (PAA), polyacrylamide, polyether ether ketone (SPEEK), sulfonated polyether ether ketone (SPEEK). In some embodiments, the polymeric binder is also electronically conductive; examples of such polymers include trans-polyacetylene, polythiopene, polypyrrole, poly(p-phyenylene), polyaniline, poly(p-phenylene vinyelene), poly(3,4-ethylenedioxythiophene) polystyrene sulfonate (PEDOT:PSS).

Various embodiments may include a battery, comprising: a first electrode; an electrolyte; and a second electrode, wherein one or both of the first electrode and the second electrode comprises iron. In some embodiments, the iron is in the form of iron ore. In some embodiments, the iron is in the form of concentrate. In some embodiments, the iron is in the form of at least one form selected from the group consisting of pellets, BF grade pellets, DR grade pellets, hematite, magnetite, wustite, martite, goethite, limonite, siderite, pyrite, ilmenite, or spinel manganese ferrite. In some embodiments, the iron further comprises at least 0.1% SiO₂ by mass. In some embodiments, the iron further comprises at least 0.25% SiO₂ by mass. In some embodiments, the iron further comprises at least 0.5% SiO₂ by mass. In some embodiments, the iron further comprises at least 0.1% CaO by mass. In some embodiments, the iron further comprises at least 0.25% CaO by mass. In some embodiments, the iron further comprises at least 0.5% CaO by mass.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal conductive elements in parallel. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electronic current and ionic current flowing in an opposite direction as that of a discharging battery in service.

In general, but particularly for long-duration storage applications, electrodes and electrode materials that are low-cost and simple to manufacture are desired. Manufacturing and/or fabrication processes may be evaluated and selected based on multiple criteria including capital cost, material throughput, operating costs, number of unit operations, number of material transfers, number of material handling steps, required energy input, amounts of generated waste products and/or by-products, etc.

Various embodiments are discussed in relation to the use of metal agglomerates as a material in a battery (or cell) (e.g., in a cell 100, 131, 230, 240, 260, 300, 410, 450), as a component of a battery (or cell), such as an electrode (e.g., negative electrode 102, 231, 301, 403, 458, 502), and combinations and variations of these. In various embodiments, the iron material may be an iron powder such as a gas-atomized or water-atomized powder, or a sponge iron powder. In various embodiments, the iron agglomerates may be in the form of pellets, which may be spherical or substantially spherical. In various embodiments the agglomerates may be porous, containing open and/or closed internal porosity. In various embodiments the agglomerates may comprise materials that have been further processed by hot or cold briquetting. Embodiments of agglomerates materials for use in various embodiments described herein, including as electrode materials, may have, one, more than one, or all of the material properties as described in Table 10 below. As used in the Specification, including Table 10, the following terms, have the following meaning, unless expressly stated otherwise: “Specific surface area” means, the total surface area of a material per unit of mass, which includes the surface area of the pores in a porous structure; “Total Fe (wt %)” means the mass of total iron as percent of total mass of agglomerates; “Metallic Fe (wt %)” means the mass of iron in the Fe⁰ state as percent of total mass of agglomerates.

TABLE 10

| Material Property | Embodiment Range |
|---|---|
| Specific surface area* | 0.01-25 m²/g |
| Skeletal density** | 4.6-7.8 g/cc |
| Apparent density*** | 1.5-6.5 g/cc |
| Total Fe (wt %)^{#} | 65-100% |
| Metallic Fe (wt %)^{##} | 46-100% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Skeletal density preferably determined by helium (He) pycnometry, and more preferably as is set forth in ISO 12154 (the entire disclosure of which is incorporated herein by reference); recognizing that other tests may be employed to provide results that can be correlated with He pycnometry results. Skeletal density may also be referred to as “true density” or “actual density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = 1 - \frac{apparent density}{actual density}$ ^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.

In embodiments the specific surface area for the agglomerates can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

The packing of agglomerates creates macro-pores, e.g., openings, spaces, channels, or voids, in between individual agglomerates. The macro-pores facilitate ion transport through electrodes that in some embodiments have a smallest dimension that is still very thick compared to some other types of battery electrodes, being multi-centimeter in dimension. The micro-pores within the agglomerates allow the high surface area active material of the agglomerates to be in contact with electrolyte to enable high utilization of the active material. This electrode structure lends itself specifically to improving the rate capability of extremely thick electrodes for stationary long duration energy storage, where thick electrodes may be required to achieve extremely high areal capacities.

In various embodiments, a bed of conductive micro-porous agglomerates comprise an electrode in an energy storage system. In some embodiments, said agglomerates comprise agglomerates of direct reduced iron (DRI). The packing of agglomerates creates macro-pores in between individual agglomerates. The macro-pores facilitate ion transport through electrodes that in some embodiments have a smallest dimension that is still very thick as compared to some other types of battery electrodes, being of multiple centimeters in dimension. The macropores may form a pore space of low tortuosity compared to the micro-pores within the agglomerates. The micro-pores within the agglomerates allow the high surface area active material of the agglomerate to be in contact with electrolyte to enable high utilization of the active material. This electrode structure lends itself specifically to improving the rate capability of extremely thick electrodes for stationary long duration energy storage, where thick electrodes may be required to achieve extremely high areal capacities.

The agglomerates for these embodiments, and in particular for use in embodiments of electrodes for long duration energy storage systems, can be any volumetric shape, e.g., spheres, discs, pucks, beads, tablets, pills, rings, lenses, disks, panels, cones, frustoconical shapes, square blocks, rectangular blocks, trusses, angles, channels, hollow sealed chambers, hollow spheres, blocks, sheets, films, particulates, beams, rods, angles, slabs, cylinders, columns, fibers, staple fibers, tubes, cups, pipes, and combinations and various of these and other more complex shapes. The agglomerates in an electrode can be the same or different shapes. The agglomerates in an electrode that is one of several electrodes in a long duration energy storage system, can be the same as, or different from, the agglomerates in the other electrodes in that storage system.

The size of the agglomerates, unless expressly used otherwise, refers to the largest cross-sectional distance of the agglomerate, e.g., the diameter of the sphere. The agglomerates can be the same or different sizes. It is recognized that the shape and size of both the agglomerates, as well as, typically to a lesser degree, the shape and size of the container or housing holding the agglomerates, determines the nature and size of the macro-pores in the electrode. The agglomerates can have sizes from about 0.1 mm to about 10 cm, about 5 mm to about 100 mm, 10 mm to about 50 mm, about 20 mm, about 25 mm, about 30 mm, greater than 0.1 mm, greater than 1 mm, greater than 5 mm, greater than 10 mm and greater than 25 mm, and combinations and variations of these.

In embodiments, the agglomerates as configured in an electrode can provide an electrode having a bulk density of from about 3 g/cm³ to about 6.5 g/cm³, about 0.1 g/cm³ to about 5.5 g/cm³, about 2.3 g/cm³ to about 3.5 g/cm³, 3.2 g/cm³ to about 4.9 g/cm³, greater than about 0.5 g/cm³, greater than about 1 g/cm³, greater than about 2 g/cm³, greater than about 3 g/cm³, and combinations and various of these as well as greater and lesser values.

In various embodiments, additives beneficial to electrochemical cycling, for instance, hydrogen evolution reaction (HER) suppressants may be added to the bed in solid form, for instance, as a powder, or as solid pellets.

In some embodiments, metal electrodes may have a low initial specific surface area (e.g., less than about 5 m²/g and preferably less than about 1 m²/g). Such electrodes tend to have low self-discharge rates in low-rate, long duration energy storage systems. One example of a low specific surface area metal electrode is a bed of agglomerates. In many typical, modern electrochemical cells, such as lithium ion batteries or nickel-metal-hydride batteries, a high specific surface area is desirable to promote high rate capability (i.e., high power). In long duration systems, the rate capability requirement is significantly reduced, so low specific surface area electrodes can meet target rate-capability requirements while minimizing the rate of self-discharge.

In another embodiment, desirable impurities or additives are incorporated into the agglomerates. When these impurities are solids, they may be incorporated by ball-milling (for example, with a planetary ball mill or similar equipment) the powder additive with metal powder, the agglomerates serving as their own milling media. In this way the powder additive is mechanically introduced into the pores or surface of the agglomerate. Agglomerates may also be coated in beneficial additives, for example, by rolling or dipping in a slurry containing the additives. These desirable impurities may include alkali sulfides. Alkali sulfide salts have been demonstrated to vastly improve active material utilization in Fe anodes. Just as soluble alkali sulfides may be added to the electrolyte, insoluble alkali sulfides may be added to the agglomerates, for example, by the above method.

In various embodiments, the specific surface area of the agglomerates is increased by a factor of 3 or more, preferably a factor of 5 or more, as measured by a technique, such as the Brunauer-Emmett-Teller gas adsorption method. In some embodiments, this surface area increase is accomplished by using the agglomerates as an electrode in an electrochemical cell, and electrochemically reducing it with an applied current.

The ratio of electrolyte to iron material, for example agglomerates in a cell may be from about 0.5 mL_{electrolyte}: 1 gᵢᵣₒₙ₋ₘₐₜₑᵣᵢₐₗ to about 5 mL_{electrolyte}: 1 gᵢᵣₒₙ₋ₘₐₜₑᵣᵢₐₗ, from about 0.6 mL_{electrolyte}: 1 gᵢᵣₒₙ₋ₘₐₜₑᵣᵢₐₗ to about 3 mL_{electrolyte}: 1 gᵢᵣₒₙ₋ₘₐₜₑᵣᵢₐₗ, about 0.6 mL_{electrolyte}: 1 gᵢᵣₒₙ₋ₘₐₜₑᵣᵢₐₗ, about 0.7 mL_{electrolyte}: 1 gᵢᵣₒₙ₋ₘₐₜₑᵣᵢₐₗ, about 0.8 mL_{electrolyte}: 1 gᵢᵣₒₙ₋ₘₐₜₑᵣᵢₐₗ, about 1 mL_{electrolyte}: 1 gᵢᵣₒₙ₋ₘₐₜₑᵣᵢₐₗ, and combinations and variations of these as well as larger and smaller ratios.

A packed bed of agglomerates may be a desirable configuration of an iron-based electrode as it provides for an electronically conductive percolation path through the packed bed while leaving porosity available to be occupied by an electrolyte that facilitates ion transport. In certain embodiments, the ratio of electrolyte volume to agglomerate mass may be in the range of 0.5 mL/g to 20 mL/g, such as 0.5 mL/g to 5 mL/g, or such as 0.6 mL/g or 1.0 mL/g. The agglomerates are generally in contact with surrounding agglomerates through a small contact area compared to the surface area of the agglomerate, and in some instances the contact can be considered a “point contact.” Contacts of small cross-sectional area may be constrictions for the flow of electrical current that may result in a relatively low electrical conductivity for the agglomerate bed as a whole, which may in turn lead to high electrode overpotentials and low voltaic efficiency of the battery.

In some embodiments, additives comprising a molybdate ion are used in an alkaline battery comprising an iron anode. Without being bound by any particular scientific interpretation, such additives may aid in suppressing the hydrogen evolution reaction (HER) at the iron electrode and improving the cycling efficiency of the battery. The concentration of the additive is selected to be able to suppress HER while still enabling the desired iron charge/discharge process. As an example, a molybdate ion may be added via a molybdate compound such as KMoO₄. In one specific example, the electrolyte contains an additive concentration of 10 mM (mM means millimolar, 10⁻³ mol/L concentration) molybdate anion. In other embodiments, the electrolyte contains additive concentrations ranging from 1-100 mM of the molybdate anion.

In some embodiments, a surfactant is used to control wetting and bubbling during operation of a metal air battery. During charging, at least two gas evolution reactions may occur that result in bubble formation. One is hydrogen evolution at the metal anode, which is a parasitic reaction that may contribute to poor coulombic efficiency during cycling of the battery. Another is the oxygen evolution reaction, which is necessary for the functioning of the metal-air battery. A surfactant additive can mitigate undesirable effects associated with both reactions. In the case of HER, a hydrophobic surfactant additive may suppress the hydrogen evolution reaction at the metal anode by physically blocking water (a HER reactant) from the metal anode during charging. In the case of ORR, a surfactant additive may reduce electrolyte surface tension and viscosity at the oxygen evolution electrode to generate smaller, uniformly sized, controllable bubbles during charging. In one non-limiting example, 1-Octanethiol is added to the alkaline electrolyte at a concentration of 10 mM to mitigate both of these challenges.

In some embodiments, corrosion inhibitors used in the field of ferrous metallurgy to inhibit aqueous corrosion are used as components in a battery with an iron negative electrode to improve performance. In some embodiments, iron agglomerates are used as the negative electrode, and favorable performance characteristics may be achieved by using one or more corrosion inhibitors in a suitable range of concentrations. In these embodiments, the principles of corrosion science are used to prevent undesirable side reactions (e.g. hydrogen evolution) in the charge condition, mitigate the rate of spontaneous self-discharge during an electrochemical hold, and maximize the utilization of iron active material upon discharge. Generally, there are two classes of corrosion inhibitors: interface inhibitors which react with the metal surface at the metal-environment interface to prevent corrosion, and environmental scavengers that remove corrosive elements from the environment surrounding the metal surface to inhibit corrosion. Under the broad umbrella of corrosion inhibitors, appropriate concentrations of inhibitors may be added to the electrochemical cell to achieve favorable performance characteristics with respect to the efficiency and capacity of an electrochemical cell. For the iron electrode of a metal air battery, one applicable general class of inhibitors are liquid and interphase interface inhibitors. This class encompasses three major types of interface inhibitors: anodic, cathodic, and mixed inhibitors. Anodic inhibitors create a passivation layer that inhibits an anodic metal dissolution reaction. Cathodic inhibitors may decrease the rate of a reduction reaction (HER in the case of an iron electrode), or precipitate at cathodic active sites to block the same reduction reaction. Mixed inhibitors may inhibit corrosion via one or both pathways, and include but are not limited to molecules that adsorb on the metal surface physically or chemically to form a film that may block active sites for a reduction reaction. The inhibitors can be added to a base electrolyte at any concentration.

In various embodiments, an inhibitor that forms a passivation layer on the metal surface is paired with an additive that de-passivates the iron surface. In the correct concentrations, an optimal balance of corrosion inhibition and active material utilization may be achieved. In one specific embodiment, when using direct reduced iron as the negative electrode, 10 mM molybdate anion is used as the passivator, while 10 mM sulfide anion is used as the de-passivator in an alkaline electrolyte comprised of 5.5M potassium or sodium hydroxide. Specific examples of electrolyte compositions include: 5.5 M KOH+0.5 M LiOH+10 mM Na₂S+10 mM 1-octanethiol; 5.95 M NaOH+50 mM LiOH+50 mM Na₂S+10 mM 1-octanethiol; 5.95 M NaOH+50 mM LiOH+50 mM Na₂S+10 mM 1-octanethiol+10 mM K₂MoO₄; and 5.95 M NaOH+50 mM LiOH+50 mM Na₂S+10 mM K₂MoO₄. However, the present disclosure is not limited to any particular concentration of the above additives in the electrolyte. For example, one or more of the above additives may be included in the electrolyte at concentrations ranging from about 2 mM to about 200 mM, such as from about 5 mM to about 50 mM, or about 5 mM to about 25 mM.

For a physically adsorbed (chemisorbed or physisorbed) inhibitor, interaction with the metal surface is often strongly dependent on temperature.

In one embodiment, an inhibitor is used where desorption of the inhibitor from the iron surface may be favorable at lower temperatures with respect to a normal operational temperature. During charge, the inhibitor forms a film that suppresses the evolution of hydrogen at the electrode. On discharge the temperature of the cell can be increased or decreased such that the inhibitor desorbs from the metal surface and exposes active material to allow for improved electrode utilization. On the subsequent charge, the temperature of the cell may be returned to a normal operational temperature to reform the film and suppress HER. This process may be repeated to achieve high charging efficiencies and high discharge utilization of the iron electrode. In one non-limiting example, octanethiol may be used as an inhibitor that can physisorb or chemisorb on a metal anode (e.g. Fe, Ni). Upon heat treatment of an electrochemical cell up to 60° C., physisorbed octanethiol is desorbed, revealing more active sites that can be oxidized during discharge. Free octanethiol in the electrolyte then physisorbs to the anode again upon cooling. At higher temperatures (>60° C.), octanethiol may chemisorb to the electrode, forming continuous, uniform films across the surface. These chemisorbed species may be desorbed more effectively at low temperatures (<100° C.).

In order to enable performance at higher temperature, organic film-forming inhibitors with oxygen, sulfur, silicon, or nitrogen functional groups can be used to form continuous chemisorbed films on the iron particulate electrode to replicate the depassivating behavior of the sulfide while resisting decomposition or oxidation.

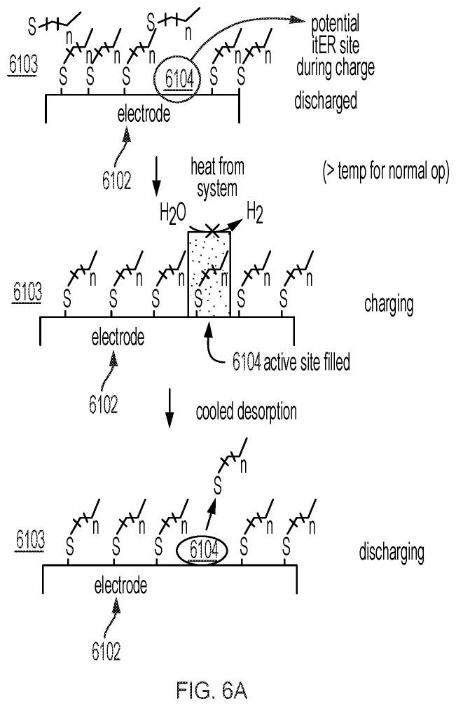

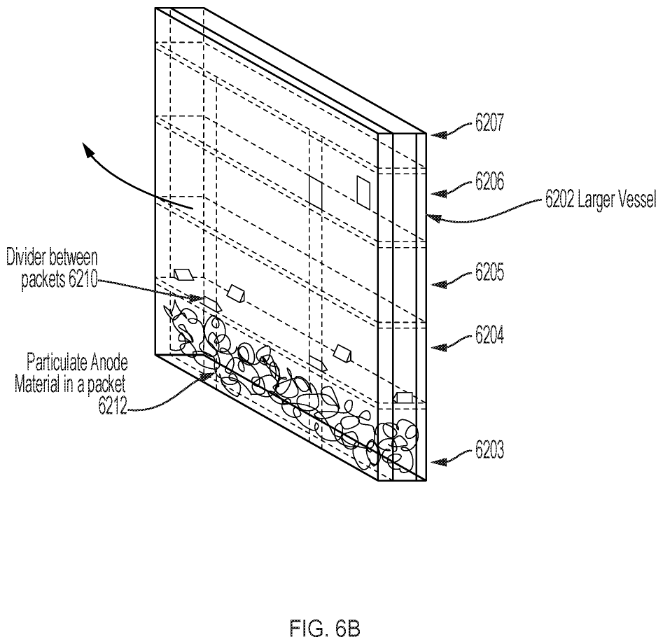

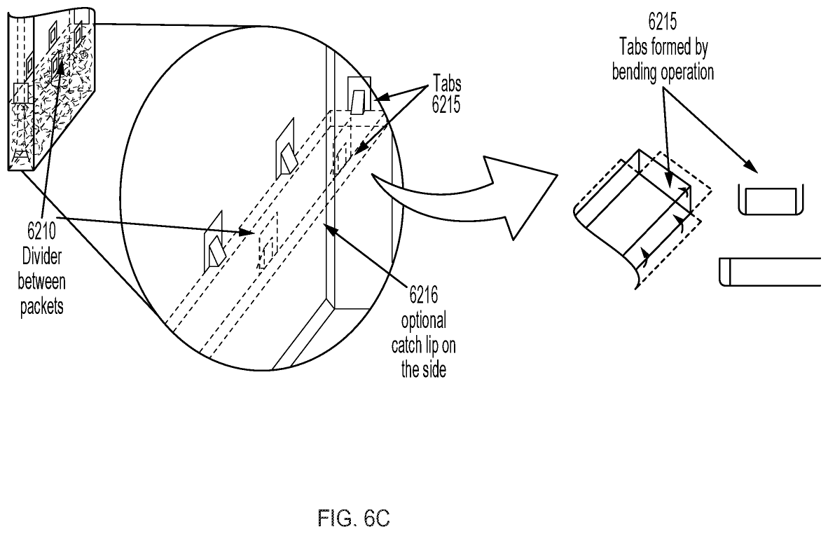

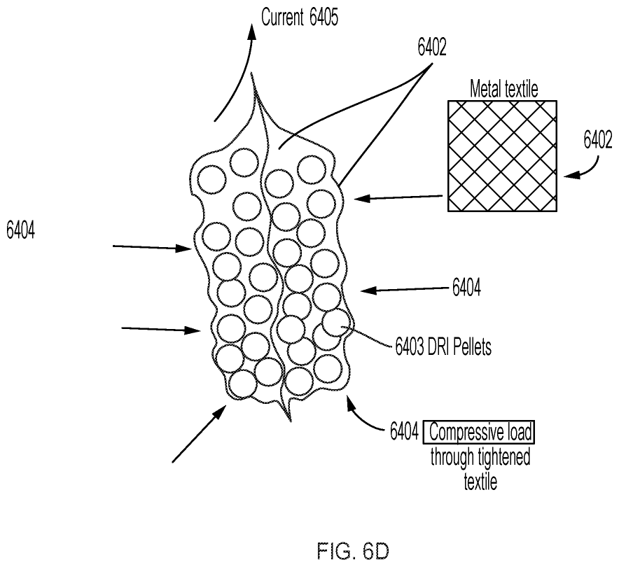

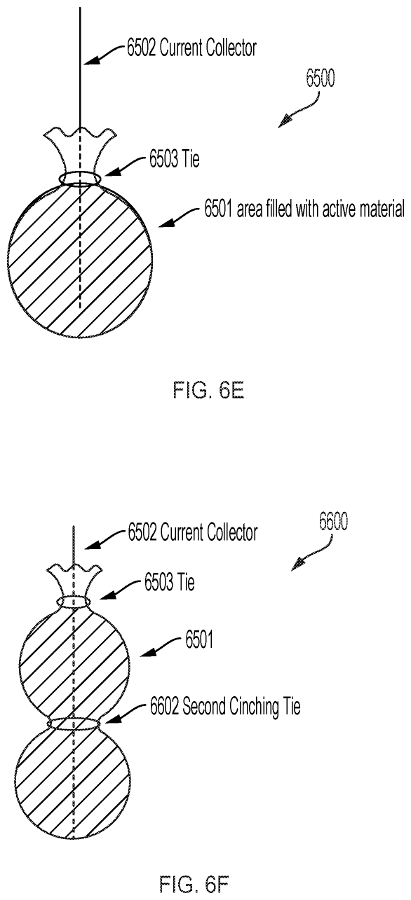

In one embodiment, 1 to 10 mM octanethiol is added to the electrolyte. During charge, the system is allowed to heat to temperatures outside of normal operating conditions (e.g., >50° C.), facilitating the formation of more complete and uniform chemisorbed octanethiol films across the active sites of the iron particulate electrode and preventing hydrogen evolution at the surface. On discharge, the system is cooled and portions of the chemisorbed film desorb from the surface, revealing additional active sites for discharge. The remaining octanethiol acts to depassivate the electrode, facilitating more complete discharge. FIG. 6A illustrates an example method of facilitating such complete discharge. For example, FIG. 6A illustrates the electrode 6102 (e.g., electrode 102, 231, 301, 403, 458, 502) in a discharge state at the top of the figures. A potential hydrogen evolution reaction (HER) site 6104 was created during discharge where a octanethiol film desorbed from the electrode 6102 surface. In the next step of the method as illustrated in the middle of FIG. 6A, 1 to 10 mM octanethiol is added to the electrolyte 6103. During charge, the system is allowed to heat to temperatures outside of normal operating conditions (e.g., >50° C.), facilitating the formation of more complete and uniform chemisorbed octanethiol films across the active sites of the iron particulate electrode 6102 and preventing hydrogen evolution at the surface of the electrode 6102 as the octanethiol film filed in the potential HER site 6104. On discharge, the system is cooled and portions of the chemisorbed film desorb from the surface, revealing additional active sites for discharge, such as the HER site 6104. The remaining octanethiol acts to depassivate the electrode 6102, facilitating more complete discharge.

During an electrochemical rest period, it is desirable to minimize the corrosion of the metal electrode. One type of corrosive media to an iron metal electrode in an aqueous electrolyte is dissolved oxygen. During an electrochemical hold, dissolved oxygen can contact the iron electrode and corrode the active material, discharging the iron electrode.

In one embodiment, an oxygen scavenger (e.g. pyrogallol, ascorbic acid, 8-hydroxyquinoline, sodium peroxide, hydrogen peroxide) may be added to the electrolyte during an electrochemical hold to reduce the concentration of dissolved oxygen in the electrolyte and prevent discharge of the iron electrode.

In one embodiment, an anodic inhibitor (e.g. K₂MoO₄) is added to the electrolyte at concentrations between 1 and 10 mM before an electrochemical hold, creating a passive film that blocks the metal surface from corrosive media in the electrolyte to prevent self discharge. After the electrochemical hold, when the electrode must be discharged, an aggressive ion (e.g. SO₄²⁻, CrO₄⁻, NO₃⁻) is added to the electrolyte to expose the active material and achieve a high utilization of active material, thus mitigating self discharge.

In certain embodiments, other electrolyte additives are incorporated in the electrolyte. Electrolyte additives may be selected from the non-limiting set of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate, 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, manganese dioxide, manganese (III) oxide, manganese (II) oxide, manganese oxyhydroxide, manganese (II) hydroxide, manganese (III) hydroxide, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, Iron(III) sulfide, calcium nitrate, hydroxylamines, benzotriazole, furfurylamine, quinoline, tin(II) chloride, ascorbic acid, 8-hydroxyquinoline, pyrogallol, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40®), tetramethylammonium hydroxide, NaSb tartrate, urea, D-glucose, C6Na2O6, antimony potassium tartrate, hydrazine sulfate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, potassium sulfide, and combinations thereof.

Additional additives include minerals containing SiO₂, which may have beneficial effects on electrochemical performance due to uptake of carbonate from the electrolyte or electrode. Additives which contain such functional groups may be usefully incorporated into iron electrode materials. While the specific mineralogy of ores and other factors may determine the exact SiO₂-containing material added, examples of such SiO₂-containing additives are silica, cristobalite, sodium silicates, calcium silicates, magnesium silicates, and other alkali metal silicates.

In certain embodiments, electrode agglomerates are prepared by agglomerating metal powders, such as iron containing powders, into approximately spherical agglomerates. In various embodiments the agglomeration is conducted at or about room temperature or at or about ambient outdoor temperature or at elevated temperature. In various embodiments, the agglomeration is conducted in a rotary calciner, in which the powder is simultaneously agglomerated and sintered. In certain embodiments, iron powders such as atomized iron powder, sponge iron powder, iron filings, mill scale, carbonyl iron powder, electrolytic iron powder, and combinations or variations thereof are used as feedstocks. In various embodiments, the heat treatment process is conducted at temperatures such as about 700° C. to about 1200° C. such as about 800° C. to about 1000° C. In various embodiments the gas environment is inert (comprising N₂ or Ar) or reducing (comprising H₂, CO₂, CO, etc) or combinations thereof. In various embodiments the heat treatment process fully or partially sinters together the powder to create agglomerates. In various embodiments the agglomerates have size ranging from 1 um (um=10⁻⁶ m) to 1 cm (cm=10⁻² m) such as 10 um, 100 um, or 1 mm (mm=10−3).

In certain embodiments, the feedstock materials are materials known in the art as pig iron, granulated pig iron, nodule reduced iron, scrap iron, and/or scrap steel.

In various embodiments, a fine iron powder with a substantial population of powder particles being below 44 microns (often written as −325 mesh due to the passage of such particles through a 325 mesh sieve) may be utilized as a portion of the feedstock materials or entirely comprise the feedstock materials.

In certain embodiments, electrodes are fabricated by electrochemical deposition of iron from an aqueous solution. In certain embodiments the deposition solution is acidic, with a pH less than about 4, such as pH about 3, or pH about 2. In certain embodiments, the solution is near neutral, with a pH between about 4 and about 10, such as pH about 5 or pH about 7 or pH about 9. In certain embodiments the electrolyte comprises a salt such as NaCl or LiCl or KCl. In certain embodiments the liquid electrolyte is agitated by stirring, shaking, mixing, or turbulent flow to promote an uneven deposition rate and a porous structure. In certain embodiments the liquid electrolyte is sparged or aspirated, to introduce gas bubbles into the liquid during the deposition process.

In certain embodiments, iron powders are prepared by an electrometallurgical process for making porous iron. Working from a melt, iron-comprising metal is sprayed, bubbled through, or molded onto a substrate or into a mold to produce a low-cost, high surface area iron product. In certain embodiments, these powders are subsequently agglomerated using a rotary calciner or other methods, and may be subsequently assembled into an electrode. In certain embodiments the powders are directly assembled into an electrode, with no intermediate agglomeration process. In certain embodiments, a mixture or combination of agglomerated and non-agglomerated powders are used in an electrode. In certain embodiments, agglomerated and/or non-agglomerated powders produced by the electrometallurgical method are combined with other metals to fabricate an electrode.

Electrochemically produced metals offer a unique opportunity for production of high surface area materials, especially if the metal is in a liquid state, in which case the resulting liquid product is cooled via a variety of methods to achieve the desired properties. For example, iron produced via high temperature electrometallurgical is cooled directly in a high surface area mold, spray deposited (atomized) into particles or dispersed in a cooling media.

In certain embodiments, metal electrodes are directly prepared by electrometallurgical processes such as molten oxide electrolysis. In certain embodiments, porous electrodes are made by intentionally aspirating or sparging gas into a molten oxide electrolysis cell. In certain embodiments, the gas is an inert gas such as N₂ or Ar.

In certain embodiments, molten metal from an electrometallurgical process is sprayed, bubbled through, or molded onto a substrate or into a mold to produce a low-cost, high surface area metal electrode. In certain embodiments the metal is substantially iron.

In one non-limiting example, iron ore comprising Fe₂O₃, Fe₃O₄, and mixtures thereof, is dissolved in an electrolyte comprising SiO₂, Al₂O₃, MgO, and CaO in weight ratios of 60 wt %, 20 wt %, 10 wt %, and 10 wt %, respectively. The mixture is brought to an elevated temperature of about 1600° C. Metallic iron is electrochemically reduced from the molten oxide mixture and pooled at the cathode. The molten metal is transferred by pipes and valves to a shot tower, and is rapidly cooled in vacuum to produce a fine iron powder with average diameter of 50 um (um=10⁻⁶ m). The iron powder is subsequently passed into a rotary calciner operating under a nitrogen (N₂, 100%) atmosphere at 900° C. to form aggregates with average diameter of 2 mm, which are subsequently assembled by packing into a metal electrode.

In certain embodiments, the electrodes may be fabricated from the thermochemical reduction of iron oxides. In some embodiments, the reduction may proceed almost to complete reduction of the iron oxides to metallic iron. Nearly complete reduction of the iron oxide to metallic iron is the goal of many industrial thermochemical reduction processes for iron. However, there are many potential reasons why incomplete reductions of iron oxides to metallic iron would make such incompletely-reduced products particularly useful for the creation of iron batteries. First, several of the oxide phases created during the reduction of iron are semiconducting, and thus may usefully serve as electronic conductors in an iron electrode material. For example, magnetite is fairly conductive close to room temperature. Wustite, while less conductive than magnetite, is still highly conductive relative to most oxides. In some embodiments, one may take advantage of the semiconducting nature of wustite and magnetite to form a battery electrode which is possibly a composite with metallic iron. Partially reduced products may also be more electrochemically active. The inventors have observed that wustite may in some circumstances be more electrochemically active than even metallic iron. Wustite may be less expensive to thermochemically reduce due to its higher oxidation state than metallic iron Wustite may therefore be less expensive and higher performance than iron as a component of a battery electrode. In one aspect, a positive electrode for an alkaline iron battery may be produced from indurated pellets composed of carbonhematite traditionally fed to direct reduction or blast furnace processes. The pellets may be reduced in a vertical shaft furnace via appropriate mixtures of hydrocarbons and other reducing gases known in the art of the direct reduction of iron. The reduction process may terminate by way when a metallization of at most 95% is achieved (metallization is a term used in the art of direct reduction of iron to describe the fraction of iron atoms which are fully metallic in their oxidation state). In some instances, a lower metallization may be preferred, with metallizations as low as 0% yielding large quantities of magnetite and wustite as alternative input materials for a battery. The resulting partially reduced pellets, lump, fragment or other particulate may be packed into a bed of particles in order to serve as an iron electrode material. The electrode material may consist entirely of iron oxides, and comprise primarily a mixture of magnetite and wustite.

In some instances, porous iron electrode materials may suffer from high electrical resistance when assembled into a bed. As such, the performance of iron electrode materials inside a battery may be enhanced by methods for decreasing the resistance to charge transfer between and among the particulate materials, and enhanced methods for current collection from the electrode active materials. This section describes methods for enhancing the charge transfer within the packed bed through to the current collectors.

The inventors have discovered through experiment that the performance of porous iron electrodes may be enhanced by applying a compressive force to the anode bed during the course of battery cycling. For example, the contact resistance between porous particulate materials may be decreased by over one order of magnitude by application of a uniaxial compressive stress of 0.01 MPa or more. Too high of compressive stresses may lead to local failure of the electrode material via cracking of the material (and therefore potential local decreases in electrical conduction), densification due to deformation of the porous iron electrode material without cracking (which may in turn lead to a reduction in the pore space available for the formation of discharge product or a decrease in the mass transport through the pore space), or other mechanical failure modes. The application of compressive stresses that do not lead to material failure but are above the stresses needed for reduction of contact resistance may lead to increases in the performance of the porous iron electrode material during electrochemical cycling. Within this regime, further increases in compressive stresses and different configurations of compressive stresses may be used to increase the conductivity of the bed, with stresses on the order of 0.1-10 MPa yielding enhanced performance in some systems. As the applied stresses (and therefore forces) increase, the requirements for the mechanical enclosure which may successfully apply such stresses become more stringent, and generally the costs of the enclosure increases. Thus, in one aspect, a mechanical structure which permits simultaneous current collection and compression of a porous iron electrode material with stresses between 0.1 and 10 MPa is an especially useful means of containing the iron electrode materials within an electrochemical cell.

In various embodiments, it may be useful for a current collector to serve multiple functions in the cell, including serving as a structural member. In one example, the current collector may provide structural support to the electrode by running through a middle of the packed bed of particulate material. In some embodiments, the packed bed may have current collectors on both sides in addition to a central current collector. In some embodiments, the current collector in the middle of the packed bed may be fabricated from a sheet without perforations, whereas the current collectors on the external faces may be perforated or otherwise containing holes to facilitate transport of ions to the electrode active materials. In various embodiments, air electrodes or other positive electrode materials may be placed adjacent to the iron electrode material on both sides such that ions do not need to flow through the electrode material across a given depth in the electrode, this may be due to e.g. a plane of symmetry for the transport. As such, a lack of perforations in the current collector included in the middle of the bed may usefully reduce costs for the center current collecting sheet while having little to no impact on the transport within the system. The iron electrode materials may be mounted to or compressed against a combined structural support and current collector included in the middle of the packed bed. Additional functions performed by a current collecting component in an iron electrode may include: anode locating/mounting, enhanced current collection, adjacent cell separation, and voltage stacking.

The degree to which the resistivity of a porous electrode must be reduced to reach a given level of electrochemical performance is a function of the current collection method, as well as the material properties. If current is being collected from more sides, or with shorter total path lengths to the current collector, a battery may be able to operate efficiently with a higher resistivity path, as the ultimate voltage drop is lower. As such, the compression strategies and the current collection strategies for porous iron electrodes may be usefully co-optimized to yield systems with the lowest total cost for a given level of performance. Below, a set of techniques and designs for current collection from and compression of porous electrode beds which may be used in combination or separately in order to yield high performance porous battery electrodes with low price.

The current collecting materials may be any of those used in the art to collect current in alkaline batteries at the potentials that anodes in alkaline iron-based batteries may be exposed to. The composition of the electrolyte, the specific potentials used during battery cycling, and other process variables (e.g. temperature) will determine the degree to which various current collecting materials are stable. These materials may include nickel, nickel-plated stainless steel, copper, copper plated stainless steel, iron of sufficient thickness, carbon fiber and other carbon-based materials, and iron coated with cobalt ferrite.

In one aspect, a reactor containing a porous iron electrode (e.g., electrode 102, 231, 301, 403, 458, 502, 6102) may be divided up into horizontal layers contained in a larger vessel. FIGS. 6B and 6C illustrate example aspects of such an embodiment in which a larger vessel 6202 is divided into horizontal layers 6203-6207. The larger vessel 6202 itself may operate as a negative electrode (e.g., electrode 102, 231, 301, 403, 458, 502, 6102). With reference to FIGS. 6B and 6C, these horizontal layers (e.g., 6203-6207) may be referred to as packets. In each of these horizontal layers (e.g., 6203-6207), the anode, such as particulate anode material 6212, may be compressed via any of the methods applicable for compressing and containing particulate materials. In doing so, a current-collecting divider 6210 between the packet may be inserted into the larger vessel 6202 holding the packets (e.g., 6203-6207). Tabs 66215 on the divider 6210 or other compliant, conductive mechanisms may be used to hold the compressive forcer (e.g., divider 6210) for the packet (e.g., 6203-6207) in place while also serving as a means of current collection. This is shown in FIGS. 6B and 6C. The divider 6210 may also include an optional catch lip 6216 on the side.

In an aspect, the current collector may be a metallic or other conductive textile. Examples include meshes woven of nickel, copper, or graphite fibers. The current collector may surround or be layered into the electrode materials. The current collecting textile may surround a Direct Reduced Iron (DRI) pellet bed as an electrode shown below. The textile may be tightened, cinched, or otherwise brought into close mechanical contact with the electrode material in order to promote sufficient electrical contact with electrode material. An illustrative example is shown in FIG. 6D for the case of a metal textile 402 with an electrode (e.g., electrode 102, 231, 301, 403, 458, 502, 6102, 6202) composed of direct reduced iron pellets 6403. The metal textile 6402 may be a mesh or screen encasing the DRI pellets 6403 and providing a compressive force or load 6404 on the DRI pellets 6403 to press the DRI pellets 6403 together within the metal textile 6402 mesh and to establish close contact between the metal textile 6402 and the DRI pellets 6403. The current 6405 may be collected by the metal textile 6402.

In another aspect, a conductive mesh pouch or bag may be used as a means of simultaneously compressing and current collecting from an electrode material. More specifically, a mesh pouch or bag may be filled with particulate iron electrode material, the bag may be cinched or otherwise reduced in volume via a belt, string, wire or other cinching mechanism in order to apply compression to the anode material. A conductive mesh tube or similar may be filled with particulate iron electrode material, and the electrode material may be compressed via application of axial tension to the conductive mesh tube. In such a case, the weave of the mesh may be optimized such that the mesh tube undergoes substantial compression upon application of axial tension. One may understand this in analogy to the Chinese finger trap, wherein axial extension of a woven tube causes the diameter of the tube to narrow. The amount of compression applied to the particulate iron material may be adjusted by the thickness of the strands in the weave, the density of the strands in the weave, and the amount of axial force/extension applied to the weave. In some instances, the porous iron electrode material may be composed of direct reduced iron pellets. In some instances, the porous iron electrode material may be composed of crushed direct reduced iron pellets. A binder may usefully be included in the particulate iron material in some cases to aid in adhesion of the pellet.

In some aspects, a porous mesh container and the particulate active materials may be disposed in a similar geometric manner to a teabag and tea leaves, for example as illustrated in FIGS. 6E and 6F. FIG. 6E illustrates a single cinch configuration 6500 in which the porous mesh bag 6501 is tied at a single cinch point 6503 by the current collector 6502. The configuration 6500 may be a negative electrode (e.g., electrode 102, 231, 301, 403, 458, 502, 6102). FIG. 6 illustrates a double cinch configuration 6600 in which the porous mesh bag 6501 is tied at a first cinch point 6503 by the current collector 6502 and a second cinching point 6602. The double cinch configuration 6600 may be a negative electrode (e.g., electrode 102, 231, 301, 403, 458, 502, 6102). This tea bag container (e.g., 6501) may be conducting and serve as a current collector. In some aspects, the tea bag container (e.g., 6501) may have a current collector placed inside of the tea bag container's envelope. The tea bag container (e.g., 6501) may have ties to aid in compression, including ties that are not at the top of the tea bag container (e.g., 6501), such as a second cinch tie 6602 or other placed cinch ties. The tea bag container (e.g., 6501) may also have ties at the top of the container to maintain active material within the container. In another aspect, the tea bag container (e.g., 6501) may be non-conductive and the current collective may be performed solely through a current collector placed inside of the tea bag container's envelope.

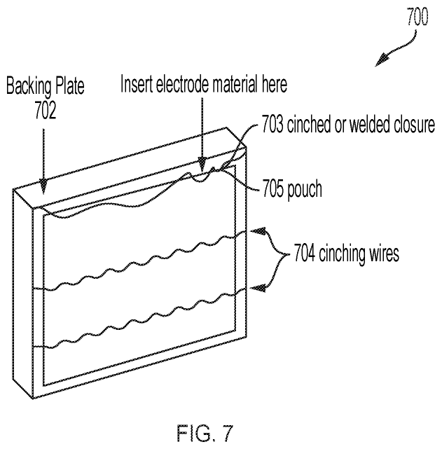

In another aspect, a loose, flexible, conducting sheet may loosely attached at the edges to a backing plate, which may or may not be rigid, forming a pouch. Cinches, such as wires, inserted through the flexible sheet and the back, are opened to allow filling the pouch with a pellet or powder anode material. The cinches are pulled shut to compress the anode, and may be used for current collection. The cinching wires may be conductive and serve as added current collectors distributed throughout the pouch. The pouch may also be attached in a rigid manner (by e.g. welds), or by connections which are rigid with respect to some forms of motion and flexible with respect to others (e.g. a hinged connection). In some instances, the current collection may take place from one side such that either the backing plate or the pouch are not current collecting, whereas in other instances it may be advantageous to collect current from both sides of the pouch construction. An example of such a cinched construction 700 with a backing plate 702 is shown by way of non-limiting example in FIG. 7 which may illustrate a configuration for a negative electrode (e.g., electrode 102, 231, 301, 403, 458, 502, 6102). In some embodiments, the backing plate 702 may be used to rigidly support pouches 705 on both sides as illustrated in FIG. 7 with cinching wires 704 running across the backing plate 702 and pouches 705. Electrode material may be poured into the pouches 705 through an opening that may be then cinched or welded closed to form a closure 703.

In another embodiment, a particulate electrode material may be compressed within perforated sheets. The sheets may be conductive such that they serve as both a means of compressing the electrode material and a means of collecting current from the electrode material. The perforations in the sheet may be selected such that they are smaller than a characteristic size of the particulate material, and thus that the particulate material may not easily escape from the cage formed by the perforated sheet.

In various embodiments, the electrode material may be a particulate material. The desire for facile transport of ions between the positive and negative electrodes may necessitate that the materials surrounding the electrode materials are porous or otherwise perforated. In some instances, a particulate material with a particle size finer than the porosity or perforations may be desired due to e.g. the difficulties of making very fine perforations. In instances where particles finer than the porosity or perforations are desired, the electrode material may be agglomerated via a binder such that a secondary particle forms which is composed of many primary particles. The primary particle sizes thus may be finer than the perforations, but the secondary particle size may be coarser than the perforations. Such coarser particles will be less susceptible to egress through the porosity or perforations of the current collectors and other compressing materials, and may be more effectively compressed as a result. In one aspect, a polymer stable in alkaline conditions may be used to bind an agglomerate together such as poly(ethylene) or poly(tetrafluoroethylene). In another aspect, a polymer may be introduced onto the surface of the primary particles and subsequently pyrolyzed to form a conducting binder on the surface of the primary particles, thereby binding them together. In yet another aspect, a polymeric binder that is only partially stable in the conditions appropriate to the electrode may be introduced between the primary particles. The binder may permit the electrode to be cycled a sufficient amount via e.g. several electrochemical charge and discharge cycles such that a bond forms electrochemically between the various primary particles prior to the disintegration or degradation of the polymer. In another aspect, the shape of the porosity or perforations in the structure compressing the electrode materials may be engineered to retain the electrode materials within the structure, but to maximize the ionic transport through the perforations or porosity. By way of non-limiting example, long slits may be introduced into a perforated sheet such that the particles may not exit through the slits, but the amount of area open to mass transport is increased relative to the amount present if the perforations were equiaxed. In one aspect, the particulate electrode material may be composed of direct reduced iron, and the perforated sheet may be composed of stainless steel. In another aspect, the particulate electrode material may be composed of crushed direct reduced iron to a particle size several times smaller than the native pellet size, and the perforations in a current collector maybe be sized such that the crushed fragments do not escape from the compressing cage.

In one aspect, a bed of particulates is vibrated, shaken, stirred, or moved so particulates settle closer together than when initially filled. This method may also be used periodically during the life of the system to help encourage new contact angles or arrangements between particulates as they change shape or size. In the case of a container which provides pockets for particulates, its orientation may be changed, such as spinning in the case of a wheel-shaped containment.

In another aspect, additives may be included or added to the bed of the electrode material to enhance conduction through the electrode between current collectors. The additives may be usefully concentrated at key points in the electrode structure. In one aspect, a particulate anode material is stuck to a current collector, which may take any shape, including rounded, or a hollow sphere, and may have particulate on both sides, using a conductive glue. The conductive glue may comprise a binder stable in the intended environment, such as alkaline electrolyte, and a conductive particle, such as metal, such as iron, filings or powder, including steel mill dust. The binder may, for example, comprise poly(ethylene) or poly(tetrafluoroethylene). The conductive glue may additionally contain additives useful to battery performance, such as sulfide salt additives, or additives intended to bond with carbonate ions in solution, such as calcium hydroxide. Creating a conductive bond between the electrode particulate materials and the current collector may usefully enhance battery performance at low added cost when the interface resistance between the particulate material and the current collector is one of the larger resistances in the electrochemical system. The composition of the conductive glue may be between 10-80 vol. % of the conductive additive, with the remainder comprising a binder, any additives, and a possible cosolvent or tackifier.

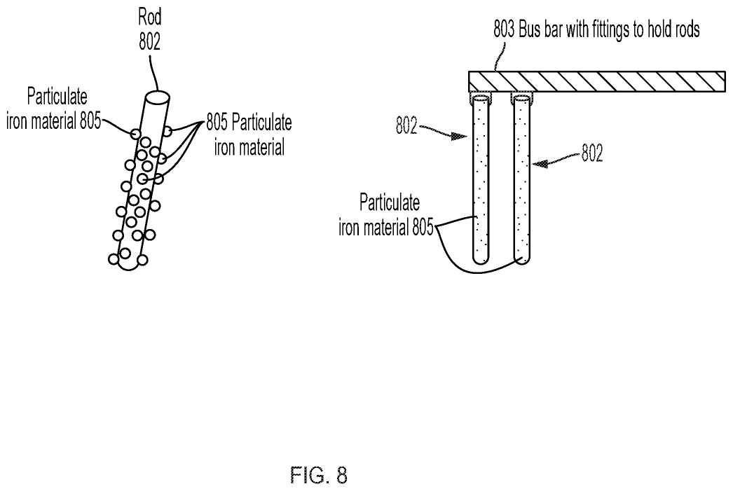

In another aspect, current collection may occur by creating a bond between each of the particulate materials and a conductive rod. If the particulate materials are attached by a conductive bond to a current collector, the compressive stresses need not be applied. The particulate materials may be attached to a rod along its length. The mass of anode material may extend past the end of the rod. The anode mass may be attached via sintering, welding, or other metal bonding techniques, by attachment with wire, or by deposition onto the rod from solution or slurry, which may take place via magnetism or evaporation of the solvent. The rod may be used for current collection from the anode. Anodes of this rod format may be snap-fit into a flexible ring-with-a-slit-like fastening mechanism for easy assembly of a compound anode. This fastening rail may also serve as a bus bar. This is schematically shown in FIG. 8 in which rods 802 with attached iron particulate material 805 are fitted to a bus bar 803. The rod 802 may have any cross section, including circular or linear, and need not be straight, but may rather assume a coil or some other shape to enhance packing and limit the bus bar 803 volume needed. The rod 802, or plurality of rods 802 together may be a negative electrode (e.g., electrode 102, 231, 301, 403, 458, 502, 6102).

In another aspect, simultaneous current collection and compression may take place via a pouch, open at the top, which may be fabricated, for instance, from crimped or welded sheet metal. The pouch may be filled with a particulate iron electrode material and the top may be rolled down to provide compression of the particulate materials. The compression may make use of a horizontal rod inside the rolled portion to perform the rolling. The pouch may be made of conductive materials suitable to be current collectors in alkaline battery environments, and specifically at iron positive electrodes. Current may be collected from the end(s) of the rod. The pouch may be porous or perforated to permit ionic transport through the pouch, as in a metallic mesh made of nickel.

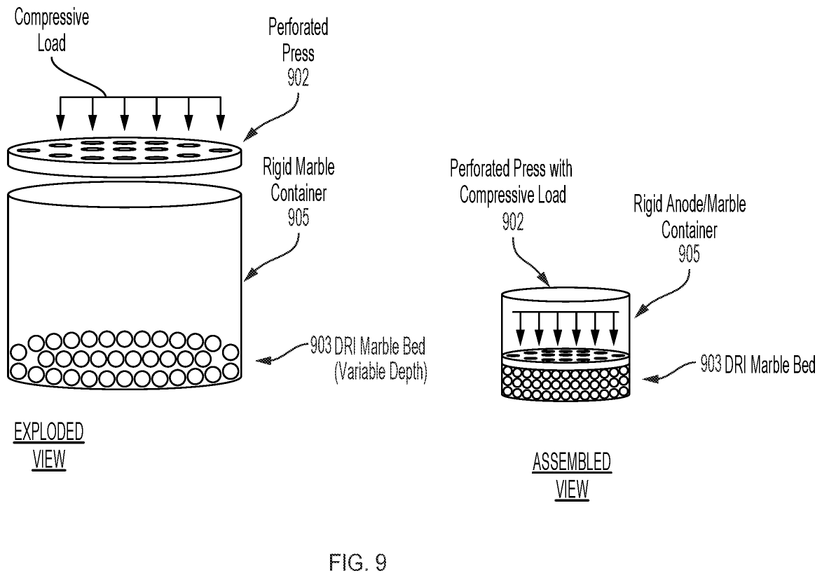

In another aspect, a rigid container may be formed. The rigid container may have at least one conductive wall, and may be constructed of materials suitable for use in an alkaline electrolyte, and further may be suitable to serve in the current collector of an iron positive electrode. The rigid container may be filled with particulate electrode material, and compressed via a piston or plunger mechanism. In one exemplary embodiment, a welded can with a bottom and wrap-around outside is filled with anode pellets (or powder) and compressed from the top using a plunger mechanism. The faces of the rigid container may be constructed of rigid, but ion permeable material such as perforated sheet metal or expanded sheet. In one aspect, an expanded sheet metal comprised the sidewalls of the rigid container. The platen or face used by the plunger may contain tabs or other compliant mechanisms which may mechanically engage with features in the sidewalls of the rigid container such that the plunger may only be needed to provide a compressive force for assembly. The mechanically engaging features thus enable the piston to be used for initial compression but subsequently removed. Compressive load in this and other embodiments may be applied via any of the means common in the art for applying compressive loads, including but not limited to bolts, hydraulics, weight, threaded rods, zip ties, and rivets. FIG. 9 shows an exemplary embodiment wherein a perforated press 902 is used to compress the iron electrode material 903 within a rigid anode container 905. In this case, the iron electrode material 903 may be direct reduced iron pellets, referred to as a DRI marble bed. FIG. 9 shows an exploded view on the left and an assembled view on the right. The assembled anode container 905 with the iron electrode material 903 compressed therein may be a negative electrode (e.g., electrode 102, 231, 301, 403, 458, 502, 6102).

In another aspect, iron particulate materials may be sandwiched between two sheets of conductive, compliant material, such as a metal textile, and riveted to be fastened around the edges to provide compression. In some instances, the conductive compliant material may be riveted, cinched, or otherwise reduced in volume intermittently throughout the area of the electrode to provide more uniform compression.

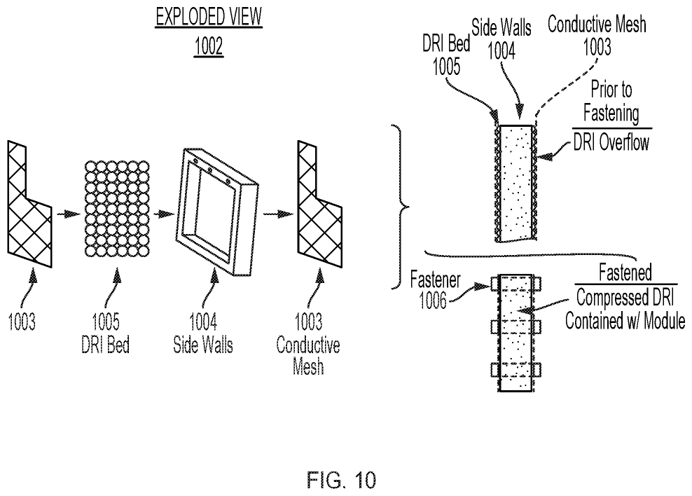

In another aspect, a compliant sheet or mesh may be used in combination with a rigid side wall to provide simultaneous compression, current collection, and containment. More specifically, in one exemplary embodiment, such as illustrated in FIG. 10, a module 1002 consisting of a rigid side walls 1004 may be slightly overfilled with iron electrode material 1005 with metal mesh top and bottom plates 1003, all enclosed with fasteners 1006 (e.g., bolts, threaded rods, zip ties, rivets etc). The module 1002 may be a negative electrode (e.g., electrode 102, 231, 301, 403, 458, 502, 6102). The mesh 1003 applies a compressive load to the iron electrode material 1005 when the fasteners 1006 are tightened as the side walls 1004 may be slightly overfilled with marbles (e.g., DRI marbles as the iron electrode material 1005). The mesh 1003 may serves as a current collector. The mesh 1003 may allow for good electrolyte circulation or diffusion to the iron electrode material 1005. The fasteners 1006, in combination with the other elements, may keep the iron electrode material 1005 contained and may apply a clamping load. In some embodiment, the fasteners 1006 may also serve as a current collector. The mesh 1003 may be wire mesh, perforated plate, resistive to corrosion i.e. nickel, stainless steel etc. The side walls 1004 may be any rigid material suitably stable in the electrochemical environment of the iron electrodes 1005, i.e. plastic, some metals, etc. The resulting assembly of iron electrode material 1005 and the current collecting apparatus may be a modular component or may be permanently connected to an electrochemical energy storage system entirely.

In another aspect, a compliant material, gasket-like material is used to contain the iron particulate electrode material on several faces. The compliant material permits variable displacement of the force-applying elements of the design according to the local compliance and/or packing of the bed. In one example, a compliant gasket borders a cylindrical cell and conducive, current collecting, perforated plates form the ends of the cylindrical cell. The plates are forced together at various points along the circumference of the cell via, e.g. bolts penetrating through the silicon gasket. The gasket may be made of a compliant, alkaline resistant material, such as an Ethylene propylene diene monomer (EPDM) rubber or related material. In some instances, the gasket may need to be highly compliant, in which case a foam of a polymeric material, such as an EPDM foam, may be useful.

In another aspect, a current collector may contain divots or other locating or contacting features on its surface. These features may serve to enhance the contact area between the current collector and the particulate iron material and/or to locate a particulate material such that it packs efficiently as a result of the templating provided by the surface of the current collector. In one example, a current collector may contain a series of divots sized and placed such that a spherical set of particles, such as those from a direct reduction process, may pack in a close-packed manner adjacent to the surface. Other templates, such as a body-centered cubic template are possible. For particulate materials with an axis of symmetry, such as rods, the templating may have an axis of symmetry like a divot that is a cylindrical trough. The divots may be introduced through machining, sheet metal dimpling or other deformation processing, or may include suitably-sized perforations or through-holes in the current collector. The current collector may be shaped so as to compress the particulate materials most optimally against each other, for example, in the case of rod-shaped particulate material, the current collector may comprise a sheet rolled into a cylinder around the cylindrical aggregates and compressed to constrain the cylinder diameter.

In order to reduce electrical resistance due to current collection, current collectors may be engineered to allow current collection to occur more homogeneously throughout the packed bed electrode by introducing current collecting components throughout the thickness of the electrode, or which penetrate a reasonable way through the thickness of the electrode.

In certain embodiments, a current collector may feature spikes, rods, tabs, or other high aspect ratio features that may project out into the electrode bed from a current collecting sheet or other boundary of the packed bed electrode. These high aspect ratio features may be configured in size and shape such that they contact many electrode material particles in the bed which would not be contacted by a simple, flat sheet current collectors. In certain embodiments, a sheet metal current collector with tabs that project into the space filled with particulate material is used as a current collector. In another aspect, an expanded sheet metal sheet is used as a current collector, and some struts within the sheet are cut and bent inward to serve as tabs projecting into the space filled with active material.

In certain embodiments, a conductive brush or series of wires are attached to a current collector. The wires flexibly project into the space filled by an iron electrode material. The wires are put in contact with the material due to their spring constants, and the contact may be improved by use of a compressive pressure.

In many embodiments, fasteners or other compression-providing elements are desired to retain current collectors in compressed position relative to one another. In what follows, the term fastener shall be understood to mean any element of a mechanical assembly that provides a fastening or compressive function through the use of an additional part that mechanically engages with other portions of the assembly. The performance of an iron positive electrode comprised of individual pellets increases when a sustained compressive load is applied to it before operating the cell. However, using metal fasteners such as stainless steel bolts to sustain the load is disadvantageous because of both added part count and assembly time, and because the bolts likely need to be electrically isolated from current collectors to mitigate the hydrogen evolution reaction (an undesired parasitic side reaction that lowers coulombic efficiency) occurring on the bolts, which adds more complexity to the design and likely adds to part count. Thus, while fasteners are desirable from a mechanical perspective, metallic fasteners are disadvantageous. Several methods of replacing metallic fasteners with other methods are considered below.

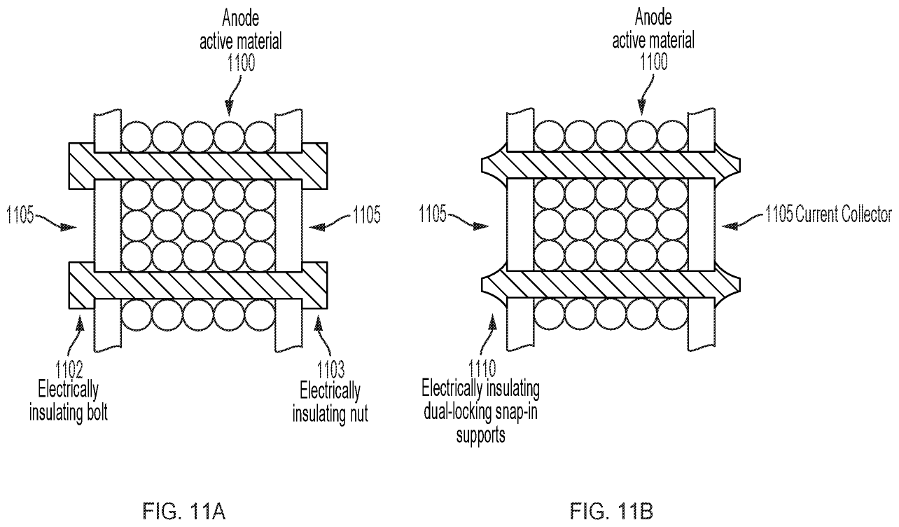

In some embodiments, non-metallic fasteners may be used in place of metallic fasteners. In one example embodiment, two sandwiching current collector plates may surround the iron electrode bed. The current collector plates could be made to apply a compressive force on the anode bed via fasteners made from an electrically insulating, non-metallic material that is resistant to degradation in the alkaline environment of the electrolyte. The electrically insulating and non-metallic nature of the fasteners would result in a lack of electron transport to the electrolyte-exposed surfaces of the fasteners, which would prevent the undesired hydrogen evolution reaction from occurring on the exposed surfaces of the fasteners. Reducing the HER rate means that more electrons participate in the desired anode reduction reaction, that is, a higher coulombic efficiency. In certain embodiments, the fasteners are bolts and nuts. In certain embodiments, the fasteners are made of one or more of acrylic, polytetrafluoroethylene, polyethylene, low density polyethylene, high density polyethylene, ultra high molecular weight polyethylene, polypropylene, or polyether ether ketone. In another exemplary embodiment, two sandwiching current collector plates that surround the anode bed could be made to apply a compressive force on the anode bed via fasteners that save assembly time by the use of a “snap-in” mechanism rather than a screw mechanism that requires rotation of a fastener. In certain embodiments, the fasteners are dual-locking snap-in supports of the appropriate length. Any combination of the above fastening techniques may be used to provide compression while avoiding the use of metallic fasteners. Some fastening techniques are illustrated in FIGS. 1A and 11B. FIGS. 11A and 11B illustrate aspects that may be used to fasten a negative electrode (e.g., electrode 102, 231, 301, 403, 458, 502, 6102) in various embodiments. The illustration in FIG. 11A shows an electrically insulating nut 1103 sandwiching two current collecting sheets 1105 against an iron electrode material 1100 and labeled as an ‘anode active material’ in FIG. 11A. The nut 1103 tightens on the bolt 1102 to draw the sheets 1105 together, thereby compressing the anode active material 1100. A second example of snap-in compressive feature, such as snap in support 1110 is shown in FIG. 11B replacing, and operating in a similar manner to, the bolt 1102 and nut 1103 of FIG. 11A.

In some embodiments, it may be useful to use a compliant mechanism capable of applying a large, distributed load to a current collector or compressive platen. In one example, the last face dimension of a rectangular prism box for containing the anode is a leaf-spring mechanism that springs back after anode loading to compress and contain the pellet anode. The current collector itself may be a compliant mechanism such that applying load on relatively few points (as occurs with a leaf spring), may result in a distributed load across the system.

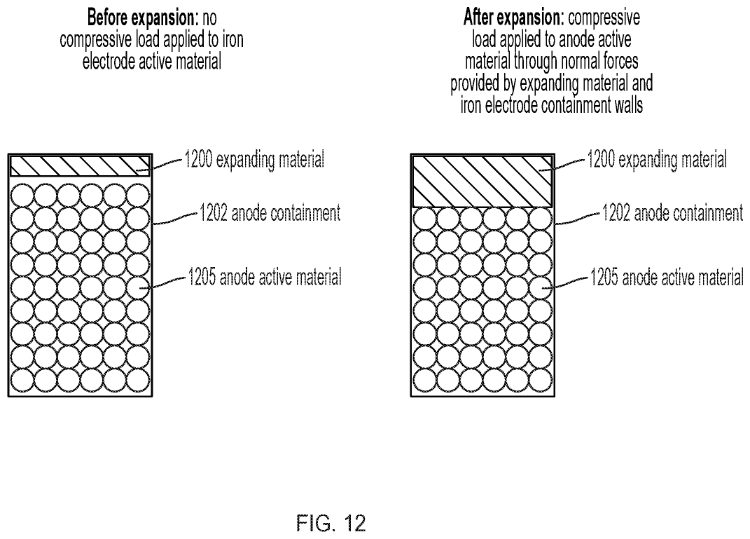

Application of a compressive stress may be applied by alternative means from compression applied via mechanical fastening of the structure. In certain cases, iron electrode material may be contained by a rigid body (for example, a prismatic cell with current collectors or other mechanical supports on all faces), but the need for applying a compressive load during assembly may be eliminated by the use of an expanding material lining one face of the anode containment body. The expanding material may expand after assembly of the cell, thus providing a compressive load on the anode bed after filling the cell with electrolyte. In certain embodiments, the expanding material may be placed in between the iron electrode material and one of the small faces of the iron electrode material containment body. In certain embodiments, the expanding material is an expanding hydrogel that swells when in contact with the aqueous electrolyte, thus providing a compressive load on the anode active material upon filling with electrolyte. In certain embodiments, the expanding material is an inflatable plastic balloon with a port for pumping in air, thus providing a compressive load on the anode active material once pumped with air. The plastic balloon may be composed of poly(ethylene), poly(propylene) or similar polymers that are flexible and resistant to degradation in alkaline solution. FIG. 12 illustrates an example of an embodiment of an expanding material 1200 contained within a rigid iron electrode containment assembly 1202. The unexpanded state is illustrated in the left hand of FIG. 12 and the expanded state of the expanding material 1200 compressing the anode active material 1202 within the anode containment assembly 1202 is illustrated on the right-hand side of FIG. 12. The rigid iron electrode containment assembly 1202 may be a negative electrode (e.g., electrode 102, 231, 301, 403, 458, 502, 6102).

In another embodiment, the container for the iron electrode material is not rigid, but still conserves its volume or has a maximal volume to within a reasonable approximation over stress ranges below ˜10 MPa, as with some metal textiles—this may be termed a flexible cage. In such a case, an expandable material may be placed within the flexible cage, and compression provided by the expansion of expandable material within the flexible cage. The expandable materials from above may be used, as well. The flexible cage may be conducting and serve as both a current collector and as a means of providing compression to the iron electrode material with which it is filled.

In another embodiment, the iron electrode material may exhibit a substantial magnetic moment in the presence of a magnetic field. The iron electrode material may be ferromagnetic, as is the case for iron. Thus, a magnetic field set up by one or more permanent magnets or electromagnets may be used to induce a magnetic force on the iron electrode material toward a rigid wall, thereby providing a compressive load to the anode active material.

In another embodiment, pumps existing within the system, for instance, those intended to move electrolyte, are used to provide suction on the particulate bed. The suction provided by the pump pulls the particulate bed together, and the particulates into contact with one another. Particulates are prevented from being sucked into the pump by means of a screen or mesh with openings smaller than the smallest expected particulate.

In another aspect, phosphates (including iron phosphate), phosphoric acid, or similar phosphor-containing additives may be usefully incorporated into a particulate iron electrode material in order to promote mechanical contact and bonding between particulate materials. The phosphate groups may form phosphate bridges between the metal oxide groups, thereby cementing the particulate materials of the electrode bed together, and forming an electrode that is better mechanically and electrically connected. The oxides of irons may serve as useful conductors because several of them (especially magnetite and wustite) are semiconducting. In the case where the bonded oxides are electrochemically reduced to metallic species, such metallic species may electrochemically sinter or otherwise bond. Thus, the bonding of such oxides, even transiently may lead to enhanced electrochemical performance over many cycles. The electrode materials may be pre-treated with a phosphorus-containing solution before entering the electrolyte, or a phosphorus-containing compound may be introduced into the electrolyte for the purpose of forming such phosphate bonds. Phosphate bonds may occur across a variety of metal-oxide systems including in cadmium, magnesium, aluminum, and zinc. Phosphate additives may be particularly beneficial in iron electrodes as they may reduce the tendency for hydrogen evolution at the iron surface during charging as well.

In some embodiments, one may desire to create a conductive path between the particles of the iron electrode material via metallurgically bonding the particles of the iron electrode material prior to insertion into the electrolyte. Such a metallurgical bond may lead to sufficient conduction through the iron electrode material that compression is not needed to achieve satisfactory electrochemical performance. Below, a variety of methods for eliminating the need for compression of the iron electrode material are described.

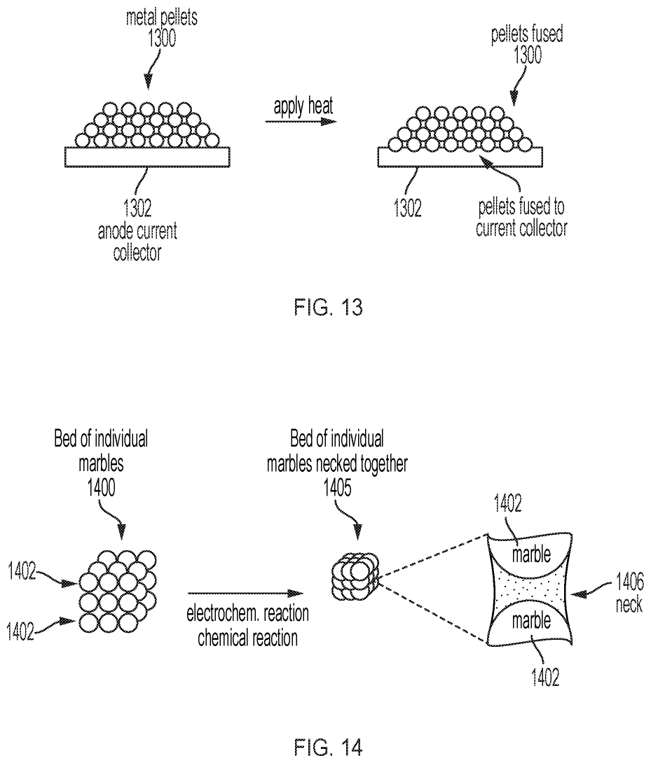

In one embodiment, the iron electrode materials are thermally assembled via a high temperature process including sintering or brazing. A thermal step for bonding the iron electrode material to a current collector may decrease the contact resistance between particulate materials by fusing similar metals to one another for a more robust electrical connection. While sintering has been considered for the manufacturing of iron electrode materials, the sintering of some particulate iron materials has not been considered to date due to their unique particulate structure. In one example, direct reduced iron is an attractive feedstock for an iron electrode material, but due to its coarse particle size, it is not an obvious candidate for thermal bonding via a sintering process. Direct reduced iron may be used in a sintering process directly, or it may be used in combination with another bonding material at the surface of the direct reduced iron such that a suitable metallurgical bond is formed. The bonding material may be painted, sprayed or otherwise introduced onto the direct reduced iron or other particulate iron material in order to permit it to bond to other direct reduced iron particles during a thermal treatment process. The bonding material may be usefully concentrated at the contact points between the direct reduced iron or other particulate material as a means of gaining the most electrical contact with the smallest added cost. An example of a bonding material is a material with a low sintering temperature which may cause a metallurgical bond during a sintering process, such as a suspension of carbonyl iron that is painted or sprayed onto the direct reduced iron or other particulate material. In a second example, a bonding material may melt, or cause a fusion weld or braze upon exposure to heat. In a second example, a nickel brazing compound may be coated onto an iron electrode material, and the material may then be heated to the appropriate temperature for a metallurgical bond to form. The thermal bonding method is illustrated in FIG. 13. FIG. 13 illustrates that a plurality of metal pellets 1300 are provided on an anode current collector 1302. Heat is applied to the pellets 1300 and anode current collector 1302 resulting in the pellets 1300 being fused to the current collector as illustrated in FIG. 13. In this manner the pellets 1300 may be formed into a negative electrode (e.g., electrode 102, 231, 301, 403, 458, 502, 6102).

A possible manufacturing technique for a thermally bonded particulate bed system may feature a rolled sheet of steel which may act as the furnace belt. This belt would unroll from a coil and straighten to become a horizontally translating surface inside of a continuous hydrogen furnace. At the inlet of the furnace, iron electrode material (such as direct reduced iron) would accumulate on the belt via a hopper. This iron electrode material and belt sheet would travel through the furnace rising to a maximum temperature bonding the iron electrode material and the belt. This iron electrode material and current collector sheet could then be cut into small sections to be used as an anode in reactors.

In various embodiments, the particulate materials for iron electrodes achieve excellent contact with each other via creation of ‘flats’ due to the stress concentration at a contact point. In some instances, the electrode material may not need to be held at high force throughout life, but rather the particulate materials may be pressed against one another during fabrication, the flat spots created, and then held with a smaller force throughout life. To accomplish this, an electrode cage may be supported during the high-load stress application to form the flats on the particulate materials and lower the inter-particle contact resistance. The force may then be partially released, the cage may be removed from the supporting structure, and then the electrode cage may be put into the reactor under this lower compressive force, but with the contact resistance that was lowered due to the application of the higher compressive force. If, at any point during life, the cage gets jumbled or the cell gets too resistive, the cage may be removed, put into the supporting structure, recompressed, and the force could be released again, the cage could be put back into the cell.

In various embodiments, the solubility of iron intermediates in alkaline media may be utilized to form necks between particulate material in an iron electrode material comprising a packed bed. The iron electrode may be held at appropriate pH, temperature, and optionally voltage ranges such that the HFeO₂⁻ soluble intermediate may form in high enough concentrations that the bonds between particles within the packed bed grow due to solution-precipitation reactions mediated by the soluble species, as shown in the diagram below, wherein the particles are referred to as marbles. The bond between the particles may be referred to as a neck. The formation of such necks may be a preprocessing step or may happen in-situ in an electrochemical cell for energy storage. The coarsening may form necks between pellets to enhance inter-pellet conductivity, reducing overpotential at the anode. In one aspect of neck formation, the process involves soaking the pellet bed in alkaline solution for >3 days, such that the soluble species coarsens the bed at the micron to millimeter scale and enhances inter-pellet contact. In another embodiment, electrochemical cycling is employed to enhance deposition of the soluble intermediate species. In a third embodiment, the pellets are coated in iron powder, such as atomized or sponge iron powder, to promote the formation of “necks” and reduce contact resistance between DRI pellets. As cycling continues, the powder particles can “sinter” to the host DRI pellet. Mechanistically this can occur due to the mass transfer of the soluble intermediate Fe species (HFeO₂) favoring deposition of discharge product at the interfaces of small and large particles, for example as illustrated in FIG. 14. Specifically, FIG. 14 illustrates that a bed 1400 of individual DRI pieces 1402 (e.g., DRI marbles) may be provided. An electrochemical and/or chemical reaction may result in the bed 1400 being formed into a necked together bed 1405 of DRI pieces 1402 (e.g., marbles) joined together by necks 1406 therebetween. In this manner, the bed 1405 may be a solid mass of joined DRI pieces as opposed to the original starting bed 1400 of separate pieces. In various embodiments, the necked together bed 1405 may be used in a negative electrode (e.g., electrode 102, 231, 301, 403, 458, 502, 6102).

In various embodiments, the particulate materials may be bonded by techniques common for the welding of metallic materials. In one aspect, the particulate materials may be resistance welded by passage of a high current through the packed bed. The current may be applied by a compacting roller assembly such that the particles are brought into contact prior to or concurrently with a resistance welding process. In various embodiments, the particles may be mechanically deformed at high temperature such that a metallurgical bond forms at the contact points between the particles. In one example, a hot briquetting machine for the hot briquetting or direct reduced iron may be run at low compacting pressures such that the particulate material deforms at the contact points to form metallurgical bonds. For particulate materials with internal porosity (such as direct reduced iron) compacting may take advantage of the stress concentration at the contact points between particles such that metallurgical bonds form between particles, but the internal porosity of the particulate material may be largely unchanged away from the contact points. In various embodiments, the creation of the metallurgical bonds may take place in inert atmosphere to prevent oxidation of the iron electrode material. In various embodiments, the bed of particulate material may be ultrasonically consolidated or consolidated by other vibratory means. The ultrasonic or vibratory compaction may be accompanied by an axial pressure. In various embodiments, the particulate materials may be fusion welded together via any of the fusion welding techniques common in the art, including but not limited to tungsten inert gas welding, metal inert gas welding, and gas metal arc welding. In another aspect, the material may be explosively welded.

In various embodiments, a conducting metallic solder may be placed at the contact points between the particulate materials such that a metallic bond may be formed between the materials. In one example, tin or a may be dip coated onto a particulate material bed. In another example, copper may be dip coated onto the particulate material. In an additional embodiment, the conducting liquid is coated onto the particulate by means of passing both through a tube or nozzle and depositing the coated particulate. Precise control of the nozzle allows precision placement of individual particulates, which may aid in achieving optimized electrode geometries. Particulates deposited in this manner may be stacked to produce three-dimensional structures.

In various embodiments, the particulate material may be etched via any one of a variety of acids and subsequently mechanically deformed prior to insertion into an electrochemical cell. The etching action may remove any surface oxides impeding bonding, and may permit electrical contact between the anode materials. Acids such as hydrochloric acid, nitric acid, or any other asides used to strip iron oxides off of metallic iron surfaces may be used. In some instances, the compression may be done while the particulate material is in the acid.

In various embodiments, a particulate material for an iron electrode may comprise a direct reduced iron material. The direct reduced iron material may be fabricated without the cement coating used to decrease sticking during the reduction processing. These cements may inhibit charge transfer across the interfaces between pellets. In such a manner, the direct reduced iron materials may exhibit enhanced charge transfer properties for electrochemical cycling. In one example, a fluidized bed reduction process is used in order to enable the use of direct reduction iron materials which do not require cement coatings.

In various embodiments, particulate material to comprise an iron electrode material may be compressed around a current collector mesh. The current collecting mesh may then be heated (e.g. by electrical resistance) such that the chicken wire welds to the particulate material surrounding it. The pellets are then interconnected by the mesh, and may be welded to each other. The mesh may be comparatively thick and open, like a chicken-wire fence material.

During operation of the battery with a pellet bed electrode, intra-pellet mass and electronic transfer may be difficult due to the size of pellets, resulting in polarization that can reduce the energy efficiency of the battery via (1) Voltage drops on charge and discharge resulting in lower voltaic efficiency and (2) Coulombic inefficiency due to insufficient competition with the hydrogen evolution reaction during charge. As a result of insufficient charging, the specific capacity of resultant iron electrodes is also reduced. For example, in certain cases the polarization is dominated by mass transport of hydroxide ions through pellet pores from the outside of a pellet to iron reaction sites at the center of the pellet. In other cases, the polarization is dominated by electronic transport through the intra-pellet network of iron material from an electrical point of contact on the outside of a pellet to the center of the pellet. Either of these sources of polarization may result in local electrochemical potential within the pellet that favors the hydrogen evolution reaction during charge more than the desired reduction reaction of iron oxide species, which reduces coulombic efficiency.

In one aspect, the size of the particulates may be chosen to promote better packing. For one non-limiting example, a bed may be comprised of 50% particles over 5 mm in diameter, 25% particles between 5 mm and 1 mm in diameter, and 25% particles under 1 mm diameter, in order for the smaller particles to fill space between the larger particles. Particles of smaller sizes than the native DRI size may be made from DRI by the methods detailed below. These particles may be added to their containment in a specific order in order to ensure optimal packing, for one non-limiting example, a layer of larger particles may first be added, followed by an addition of smaller particles to fill spaces, followed by another layer of larger particles and another addition of smaller particles.

Size reduction of iron pellets before battery assembly is disclosed as a method of addressing one or more of the energy efficiency and specific capacity losses due to the size of the pellets. Reducing the size of pellets reduces the characteristic length of intra-pellet mass and electrical transport, which reduces polarization and may enhance one or more of energy efficiency and specific capacity.

Reducing the size of pellets by means of a communitive process, such as a jaw crusher (“crushing”) before assembling into a pellet bed has been shown to result in higher voltaic efficiency. However, the crushing of the pellets should result in both less particle-to-particle contacts on a per-particle basis (irregular particles achieve fewer contacts than spherical particles), and more interface resistances per particle in a bed of a given thickness. Further, ‘rattlers,’ wherein a particle is not in electrical contact with its neighbors due to the geometric packing of the bed are more likely for polydisperse, irregular shapes than for relatively monodisperse spheres. As a result, it is inferred that the gains in voltaic efficiency due to enhanced intra-pellet mass and electrical transport partially mask increases in electronic resistance-based voltage drops and a lack of electrically accessed material (and therefore lower capacity) due to an increased rattler fraction.

In certain embodiments, the size of pellets is reduced to half or less of its original size through crushing, which results in a reduction of the overpotential of the iron electrode by more than 10 mV.

Crushing of the pellets could lead to substantial performance gains if a secondary conductive additive were to be added to the pellet bed to enhance one more of inter-pellet electrical conductivity or pellet-to-current-collector electrical conductivity. The additive would increase conductivity by increasing the conductive surface area of in contact with pellets, mitigating the added interface resistance in a pellet bed of crushed pellets. An additive is desired which does not inhibit mass transfer and results in substantially higher electrical conductivity of the bed. The optimal additive percolates at low volume fractions and is highly conductive.

In certain embodiments, the additive is one or more of carbon black or graphite that is added to the crushed pellet bed in greater than 1% volume fraction, such that the carbon black or graphite bridges crushed pellets together. In certain other embodiments, activated carbon or biochar or low to modest conductivity is used as a low-cost alternative to graphite.

In certain embodiments, the additives are pieces of conductive mesh such as stainless steel wire mesh.

In certain embodiments, the additives are conductive rods such as stainless steel rods of a diameter less than the average pellet size.

Before nominal operation of the battery, additives that improve iron electrode performance may be chemically incorporated into the iron electrode via various processes that rely on intra-pellet mass transport of chemical species in an electrolyte to active iron sites within the porous structure of the pellet. Homogeneous permeation of the additives into the pellets is often necessary to achieve the maximum desired performance-enhancing effect of the additive. However, it is often difficult to get homogeneous permeation of certain liquid-soluble and solid-state additives into pellets that are typically output from direct reduction processes, especially for those additives with low solubility that react with the direct reduced iron.

Size reduction of iron pellets before battery assembly is disclosed as a method of achieving more homogenous permeation of liquid-soluble and solid-state additives into the pellets during the additive incorporation process. Reducing the size of pellets reduces the characteristic length of intra-pellet mass transport, which reduces gradients in concentration of the additive, thus enabling a more homogeneous permeation and incorporation of the additive into the electrode.

In certain embodiments, the additive incorporation process is one or more of soaking in an electrolyte, electrochemical plating, and electrochemical cycling.

In certain embodiments, the additive is an initially liquid-soluble hydrogen evolution inhibitor that incorporates into the solid-state electrode via an electrochemical or spontaneous chemical reaction.

In certain embodiments, the additive is an initially solid-state hydrogen evolution inhibitor that further incorporates into the solid-state electrode via an electrochemical or chemical dissolution-reprecipitation reaction.

In certain embodiments, additives include one or more of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate, 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, Iron(III) sulfide, calcium nitrate, hydroxylamines, benzotriazole, furfurylamine, quinoline, tin(II) chloride, ascorbic acid, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40®), tetramethylammonium hydroxide, NaSb tartrate, urea, D-glucose, C6Na2O6, antimony potassium tartrate, hydrazine sulfate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, potassium sulfide, and combinations thereof.

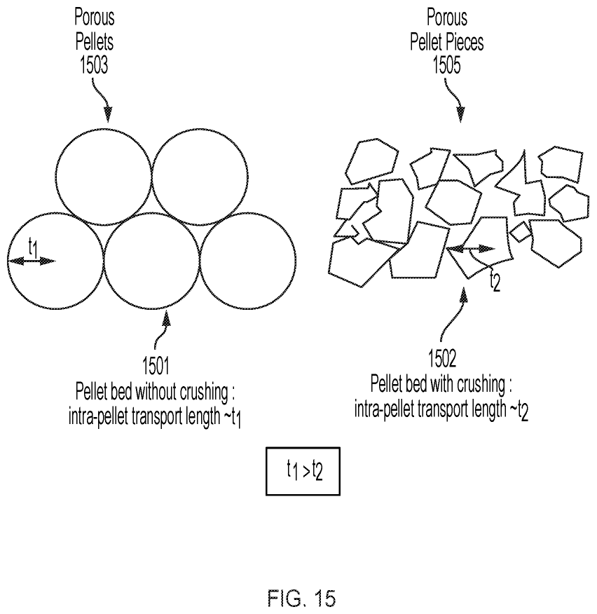

FIG. 15 illustrates example pellet beds 1501 and 1502 according to various embodiments. The pellet beds 1501 and 1502 may be used in an embodiment negative electrode (e.g., electrode 102, 231, 301, 403, 458, 502, 6102). During operation of the battery with a pellet bed electrode, mass and electronic transfer through the pellet bed may be difficult due to the total thickness of the pellet bed, resulting in polarization that can reduce the energy efficiency of the battery via (1) voltage drops on charge and discharge resulting in lower voltaic efficiency and (2) coulombic inefficiency due to insufficient competition with the hydrogen evolution reaction during charge. As a result of insufficient charging, the specific capacity of resultant iron electrodes is also reduced. For example, in certain cases the polarization is partially due to mass transport of hydroxide ions from outside of the pellet bed to the center of the pellet bed. In other cases, the polarization is partially due to electronic transport through the network of iron pellets. Either of these sources of polarization may result in local electrochemical potential within the pellet that favors the hydrogen evolution reaction during charge more than the desired reduction reaction of iron oxide species, which reduces coulombic efficiency.

Increasing the volumetric packing density of pellets is one way to address one or more of the energy efficiency and specific capacity losses due to the total thickness of the pellet bed. By increasing the volumetric packing density, the thickness of the pellet bed for a given electrode capacity decreases, thereby reducing through-bed polarization and enhancing one or more of energy efficiency or specific capacity. For example, FIG. 15 illustrates a pellet bed 1501 with porous pellets 1503 that are formed as spheres or marbles and pellet bed 1502 with porous pellet pieces 1505 that may be formed by crushing spheres, marbles, or other shapes into pieces. The intra-pellet transport length t1 of the pellet bed 1501 may be greater than the intra-pellet piece length t2 of the pellet bed 1502.

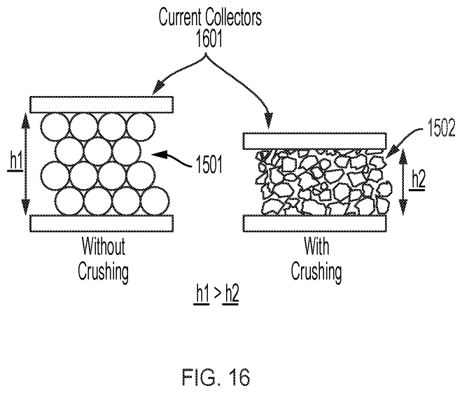

Processing the pellets by means of a jaw crusher (“crushing”) before assembling into a pellet bed is disclosed as a method to increase volumetric packing density and reduce polarization. In this manner, the crushing may result in a pellet bed 1502 rather than the pellet bed 1501. Before crushing, the pellets may be roughly spherical and may have a narrow size range. The crushing operation may break the pellets into multiple pieces with non-spherical shapes and a broader size distribution that result in a higher volumetric packing density. The resulting higher volumetric packing density reduces the thickness of the pellet bed for a fixed projected area and mass of electrode material, thus reducing through-bed polarization and enhancing one or more of energy efficiency or specific capacity (for example when comparing pellet bed 1502 to pellet bed 1501 such that pellet bed 1502 has reduced through-bed polarization and enhanced one or more of energy efficiency or specific capacity in comparison to pellet bed 1502 when the material composition of the porous pellets 1503 and porous pellet pieces 1505 may be the same). FIG. 16 illustrates the pellet beds 1501 and 1502 with current collectors 1601 attached. The height of the pellet bed 1501 without crushing, h1, may be greater than the height, h2, of the pellet bed with crushing 1502 even though the same amount of pellet material may be present in pellet bed 1501 and 1502. As such, crushing may compact the size of the electrode (e.g., electrode 102, 231, 301, 403, 458, 502, 6102).

In certain embodiments, the pellets after a crushing operation break into pieces with jagged edges and with a polydisperse size distribution such that smaller pieces fall within the interstices between larger pellets, thus increasing packing density.

Certain performance attributes of a pellet bed electrode may worsen due to time-dependent or charge-throughput dependent mechanisms during battery operation. Performance attributes that worsen may include but are not limited to specific capacity (mAh/g), electrode overpotential (mV), self-discharge rate (mAh/mo.), and coulombic efficiency (%). Several methods of regaining iron electrode performance by treatments to the battery after beginning of life are disclosed here.

In certain cases, the specific capacity of the electrode may decrease with battery cycling because of a cycle-dependent change in microstructure of the electrode that hinders mass or electronic transport, thereby reducing the accessible capacity at a given polarization. More specifically, pores within the pellets may become increasingly constricted with cycling as they are filled with remnant electrochemical discharge products that have a larger molar volume (per mol iron) than metallic iron. The progressive pore filling results in a hindered mass transport to the iron within those pores, which may render the iron within pores less and less accessible for the electrochemical reaction to occur, which reduces specific capacity. In other cases, the electrical resistance to certain iron sites may increase because of a constriction of the conductive pathways provided by the metallic network within a pellet. In other cases, there may be a core of unreacted metallic iron within each pellet that is completely covered by a passivating layer.

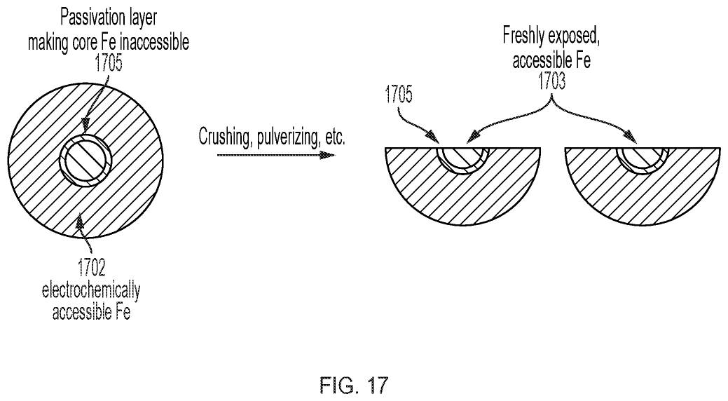

The loss of accessible capacity due to battery use may be regained by ex-situ treatments that are performed on the pellets after the electrode capacity has decayed to a minimum threshold. Various embodiments include processing the used pellets with mechanical, chemical, electrochemical, and/or thermal processes before re-introducing the pellets into the electrochemical cell (i.e., processing the pellets ex-situ) to return the electrode to a state with better chemical and physical properties. Better chemical and physical properties may include higher content of desirable impurities (e.g., hydrogen evolution reaction (HER) suppressants), lower content of undesirable impurities (e.g., HER catalysts), higher specific surface area, higher total porosity, different pore size distribution (e.g. multimodal to reduce mass transport resistance), different pellet size distribution (e.g. multimodal to enhance bed packing), different aspect ratio (e.g. to enhance bed packing), etc. Mechanical processes that may be applied to the pellets ex-situ may include crushing, pulverizing, and/or powderizing that include but are not limited to size reduction. A mechanical size reduction re-exposes passivated metallic iron at the core of pellets, which makes the previously inaccessible iron accessible, thus increasing capacity. Note that mechanical processes that expose initially passivated iron at the core of pellets may not be desirable to be done before battery use, because more exposed metallic iron provides more sites at which the hydrogen evolution reaction might occur, either via the Faradaic parasitic reaction during charging, or via the spontaneous self-discharge reaction. However, mechanical processes done ex-situ may be desirable as a method to regain and/or improve capacity electrical resistance that have decayed due to battery usage, at which point a larger fraction of iron is passivated and inaccessible as illustrated for example in FIG. 17. Specifically, FIG. 17 shows a pellet 1702 after battery usage that is processed ex-situ, such as by crushing, pulverizing, etc., to expose the iron core 1703 in the pellet 1702. FIG. 17 shows the passivation layer 1705 which may make the core 1703 inaccessible until after processing.

Thermal processes that may be applied to the pellets ex-situ may include processing the pellets in at elevated temperature in reducing (e.g., hydrogen), oxidizing, and/or carburizing (e.g., carbon monoxide and/or carbon dioxide) atmosphere. In certain embodiments, the reducing condition is a gas mixture is 10% nitrogen, 30% carbon monoxide, 15% carbon dioxide, and 45% hydrogen at 800° C. for 90 minutes. Electrochemical processes that may be applied to the pellets ex-situ may include reverse electroplating, electrochemical dissolution, etc. Chemical processes that may be applied to the pellets ex-situ may include acid etching, etc. In various embodiments, to increase accessible capacity of the pellets during the discharge reaction, the pellets may be pretreated by soaking in an acid bath (e.g., concentrated HCl) that will etch the iron and enlarge pores in the pellets, increasing the total porosity of the pellets in comparison to used pellets. In various embodiments, to increase the accessible capacity of the pellets during the discharge reaction, the pellets may be pretreated by soaking in a neutral or slightly basic bath that removes excess discharge product from the electrode. For example, one of the expected discharge products, iron (II) hydroxide, is typically unstable at pH<8. By soaking in a bath at pH<8, the iron (II) hydroxide is preferentially removed while the metallic iron is preserved in the electrode. In the pH range pH>7 and pH<8, the bath may be a diluted form of the electrolyte used during electrochemical operation of the battery. After pretreatment, the etched and now more porous pellets may be re-assembled into the negative electrode. The chemical process time may be optimized to increase the usable capacity of the pellets, without losing too much active material to the acid etching solution. Any of the aforementioned processes may be optimized to preferentially make small pores in the pellets larger. In certain embodiments, an electrochemical process utilizes one or more large current pulses that result in a non-uniform current distribution within the pellet such that current is concentrated at sharp and small physical features within the pellet, which preferentially drives the electrochemical dissolution at small physical features and thus makes initially small pores larger. Any of the above processes may also be done before battery operation to make the chemical and physical properties of the pellets better relative to their unmodified, unused state.

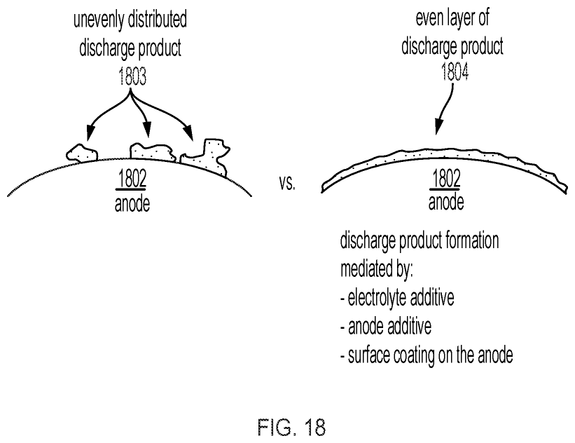

The shape and size of discharge product within the pores of the iron pellets can affect performance in a variety of ways. For example, a thin, uniform layer of discharge product may avoid clogging pores, which may improve capacity retention. On the other hand, a thin uniform layer of discharge product that is not porous may passivate underlying metallic iron such that mass transport of hydroxide ions through the discharge product layer during discharge becomes hindered, thus reducing accessible capacity of the electrode. In another example, an uneven, high-surface-area, porous discharge product may facilitate mass transport through the discharge layer while increasing the active surface area for the next discharge, both of which may increase total accessible capacity. FIG. 18 compares discharge product distributions. The left side of FIG. 18 shows discharge product 1803 unevenly distributed on a surface of an anode 1802. The right side of FIG. 18 shows discharge product 1804 in an even layer on the surface of the anode 1802. The discharge product formation may be mediated by the electrolyte additives, anode additives, and/or surface coatings of the anode 1802. Various methods of controlling discharge product morphology in iron electrodes are disclosed.

Additives and counterions in the electrolyte and/or in the electrode may be used to control the discharge product morphology. Additives and counterions may change the porosity of the discharge layer and accessibility electrochemically active sites by way of the following mechanism: Fe forms a two-layer discharge product with a relatively static inner layer of Fe₃O₄ and a very porous outer layer, which is affected strongly by electrolyte composition. Bivalent cations tend to inhibit uniform discharge and help produce a more porous outer layer. Monovalent cations inhibit uniform discharge and produce a more porous outer layer when they are not well-matched in size with the Fe cations in the outer layer of discharge product. For example, lithium and cesium cations tend to produce a more porous outer layer than sodium and potassium cations because lithium and cesium are less matched in size with the iron cation. Additives and counterions to control discharge product morphology include but are not limited to sulfide (S₂₋), hydrosulfide (HS₋), lithium cation (Li₊), sodium cation (Na₊), calcium cation (Ca₂₊), selenide (Se₂₋), cesium cation (Cs₊), and barium cation (Ba₂₊). In certain embodiments, sodium sulfide, lithium hydroxide, sodium hydroxide, calcium hydroxide, sodium selenide, and/or barium hydroxide are added into the electrolyte at various concentrations to provide the soluble additives and counterions that act to control discharge product morphology.

In certain embodiments, the additives to control discharge product morphology are initially contained within the solid-state electrode. The solid-state additives may be in the form of solid-state metal oxides and/or metal sulfides introduced as solids to an iron electrode. Metal sulfides and oxides of interest include: FeS, FeS₂, MnS, Bi₂S₃, Bi₂O₃, Sb₂S₃, FeAsS, PbS, SnS, HgS, AsS, Pb₄FeSb₆Si₄, Pb₃Sn₄FeSb₂Si₄, SeS₂, among others.

In certain embodiments, additives to control discharge product morphology include one or more of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate, 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, Iron(III) sulfide, calcium nitrate, hydroxylamines, benzotriazole, furfurylamine, quinoline, tin(II) chloride, ascorbic acid, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40®), tetramethylammonium hydroxide, NaSb tartrate, urea, D-glucose, C6Na2O6, antimony potassium tartrate, hydrazine sulfate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, potassium sulfide, and combinations thereof

A pretreatment involving electrochemical cycling may also serve to control the morphology of discharge products for an iron electrode. For example, the inventors have observed that the compactness of the discharge product changes with temperature and current density. A pretreatment involving electrochemical cycling at a temperature and current density that is not necessarily the nominal operating condition of the battery may be used to form a discharge product morphology that is conducive to high accessible capacity, and is sustained when the operating conditions are set to nominal values after the pretreatment. In various embodiments, the pretreatment consists of deep electrochemical charge and discharge cycling at 10° C. at a gravimetric current density of 25 mA/gFe for 100 cycles.

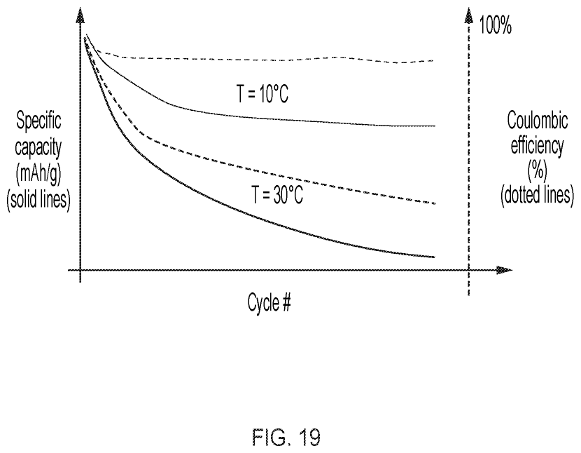

The inventors have found that decreasing the operating temperature of the iron electrode to below 30° C. improves various performance attributes, such as specific capacity, the retention of specific capacity over many electrochemical cycles, and Coulombic efficiency of the electrode. Various mechanisms may be at play simultaneously to result in these effects. For example, specific capacity may be improved at lower temperatures due to an increase in electrical conductivity of the electrode material, including but not limited to iron and iron oxide discharge products. The increase in electrical conductivity of the electrode material would enhance electrical transport to electrochemical reaction sites, which would result in an increase in specific capacity at a given polarization limit of the electrode. In another example, reducing temperature may slow the kinetics of undesirable electrolyte degradation or poisoning reactions that take place during the lifetime of the battery, such as carbonate formation due to carbon dioxide from the atmosphere. For example, carbonate formation consumes OH− ions, decreasing the conductivity of the electrolyte, which decreases the pH of the solution and leads to a decrease in specific capacity. Decreasing the temperature slows these undesirable reactions and result in better specific capacity retention at the iron electrode over the lifetime of the battery. In another example, the decrease in temperature may slow the kinetics of the undesirable hydrogen evolution reaction more so than the desired iron reduction reaction during charging of the battery, thus resulting in a higher coulombic efficiency during charging. In various embodiments, the iron electrode is maintained at 20° C.±5° C. to improve electrode performance. In other embodiments, the iron electrode is maintained at 10° C.±5° C. to improve electrode performance. FIG. 19 is a temperature plot of specific capacity and Coulombic efficiency versus cycle number.

Better electrochemical kinetics of the charging (reduction) and discharging (oxidation) reactions at the iron-based electrode would improve both voltaic efficiency and coulombic efficiency of the cell. A redox mediator can be used to improve the electrochemical kinetics of the iron-based electrode. A redox mediator is a chemical compound that acts as an electron “shuttle” to mediate a reduction or oxidation reaction. Though typically used in the field of biocatalysis, redox mediators can also be used to facilitate the desired oxidation and reduction reactions at the iron-based electrode. Requirements of the redox mediator include (1) fast and reversible redox kinetics; (2) similar redox potential to that of the reaction it facilitates (including but not limited to Fe< >Fe(OH)₂ and/or Fe(OH)₂< >Fe₃O₄); (3) stable in the presence of the electrolyte of interest. The redox mediator can be either soluble or insoluble in the electrolyte of interest. In some embodiments, the redox mediator contains one or more unsaturated base groups, saturated base groups, or combinations thereof. In some embodiments, the base groups contain electron-withdrawing functional groups, electron-donating functional groups, or combinations thereof. In certain embodiments, the unsaturated base groups include but are not limited to cyclopenta-1,3-diene, benzene, 1H-pyrrole, pyridine, pyrazine, furan, 4H-pyran, 1,4-dioxine, thiophene, 4H-thiopyran, 1,4-dithiine, 1-methyl-1H-pyrrole, or combinations thereof. In certain embodiments, the saturated base groups include but are not limited to cyclopentane, cyclohexane, 1,4-dioxane, tetrahydrofuran, tetrahydro-2H-pyran, 1,4-dithiane, tetrahydrothiophene, tetrahydro-2H-thiopyran, 1,4-dimethylpiperazine, 1,3,5-troxane, 1,3,5-trithiane, or combinations thereof. In certain embodiments, the electron-withdrawing functional groups include but are not limited to nitro, trichloro, cyano, carboxyl, fluoro, hydroxyl, or combinations thereof. In certain embodiments, the electron-donating functional groups include but are not limited to primary amine, secondary amine, tertiary amine, amide, methoxy, methyl, alkyl, alkenyl, alkynyl, phenyl, or combinations thereof. In one embodiment, the redox mediator for the iron-based negative electrode are viologen-based compounds. In certain embodiments, the viologen-based compounds include but are not limited to methyl viologen, propyl viologen, hexyl viologen, octyl viologen or combinations thereof.

In an electrochemical cell with an iron electrode, sulfur addition to the cell unlocks utilization of the iron electrode. However, sulfur is a known catalyst poison, so in electrochemical cell embodiment with a catalyst positive electrode, it may be optimal for the sulfur concentration around the iron electrode is high, while sulfur concentration at the catalyst electrode is low.

In one embodiment, sulfur may be concentrated at the iron electrode by submerging the iron electrode in a highly concentrated sulfur solution before it enters the electrochemical cell. Furthermore, if the iron electrode undergoes a single formation cycle of charge, then discharge, sulfur will be electrochemically added to the structure of the iron electrode. Then upon addition to the desired electrochemical cell it will remain concentrated near the anode.

In certain embodiments, the iron electrode is soaked in an electrolyte with a high sulfide concentration (i.e., >50 mM) prior to cycling in an electrolyte with a lower sulfide concentration (ie 50 mM).

In certain embodiments, the porous iron electrode is soaked in an electrolyte bath with any alkali or transition metal sulfide (Na₂S, K₂S, Bi₂S₃, SbS₃, etc.) to increase the presence of sulfide.

In certain embodiments, sulfide is incorporated through a high sulfide concentration electrolyte soak prior to cycling, after which the positive electrodes are inserted into the full cell wherein the initial sulfide concentration can be in the range of 10-250 mM (1.4-33.8 mgS/gFe) or higher.

In one non-limiting example, the porous iron electrode described above comprises a bed of DRI pellets.

Uniform or controlled incorporation of sulfide or other beneficial additives into a porous iron electrode is difficult. One method to uniformly incorporate additives into a porous material is vacuum infiltration, where a substrate is exposed to vacuum (<1 atm) to evacuate the pores and then exposed to a liquid or molten additive to infill any vacancies in the material.

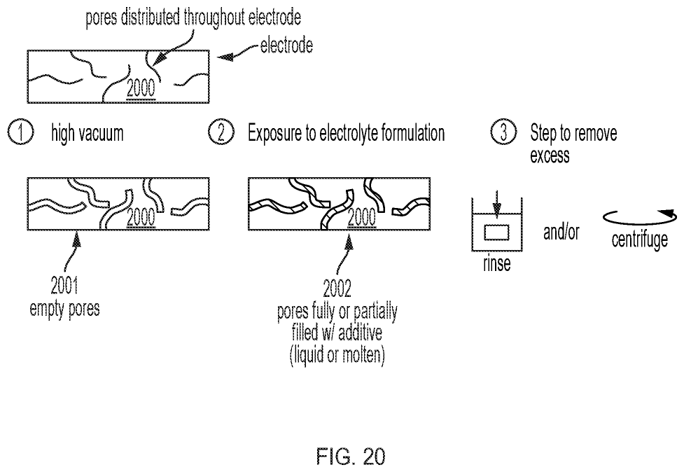

In various embodiments, a substrate is exposed to vacuum sufficient to evacuate pores. FIG. 20 illustrates one example method of evacuating pores. The substrate 2000 is in a first step exposed to a high vacuum to empty the pores 2001.

In one embodiment, the evacuated substrate is then exposed in a second step to an aqueous electrolyte formulation containing additives as specified previously at temperatures between 0 and 250° C. resulting in pores fully or partially filled with additive 2002. After specified time, such as less than 48 hours, the substrate 2000 may be rinsed or centrifuged to remove excess electrolyte in a third step.

In one embodiment, the evacuated substrate is then exposed to a liquid or molten form of additive, where additives are those specified previously in section ## that someone skilled in the art could identify as being compatible with melt processes (e.g. octanethiol, FeS), at temperatures between 25 to 250° C. or 250 and 2000° C. After a specified time less than 48 hours, substrate may be rinsed or centrifuged to remove excess liquid or molten material.

In one embodiment, the evacuated substrate is then exposed to a gaseous additive (e.g. H₂S, H₂Se, CS₂ above 50° C., PH₃). After a specified time, such as less than 48 hours, substrate may be purged with an inert gas or under vacuum to remove excess of the gaseous additive.

In a non-limiting example, a solution containing sodium sulfide is vacuum infiltrated into the pores of a porous iron electrode 2000 prior to cycling to improve the penetration. Better penetration of sulfide into the anode may improve overall performance capacity.

In a non-limiting example, sodium thiosulfate is heated until melted (>45° C.) and vacuum infiltrated into the pores of a porous iron electrode prior to cycling.

Additional methods to localize the sulfide to the iron particulate material electrode include sequestering the sulfide additive in a holder of variable permeability within or adjacent to the electrode. In this way, controlled amounts of sulfide could be added to the iron particulate electrode through passive or active electrochemical or chemical dissolution.

In one embodiment, the additive may be contained in a fully or semipermeable holder, where the holder is made of a plastic stable in an alkaline solution (e.g., polypropylene, polyethylene).

In one embodiment, the additive may be contained in the holder behind an ion-selective membrane, which permits flow of electrolyte into the holder and the slow diffusion of additive into solution.

In one embodiment, the additive may be contained in an electrically conductive material (e.g., conducting polymer mesh, metallic wire mesh).

In one embodiment, the holder may be made of a layer of porous oxide (e.g. silica).

In one embodiment, the additive holder may be in physical, electrical, or physical and electrical contact with the iron particulate material electrode.

In one embodiment, the additive holder may be in contact with the electrolyte and only in contact with the iron particulate material electrode through ionic transport in the electrolyte.

In one embodiment, the additive holder may be submerged in a separate container of electrolyte to provide a constant source of sulfide. The electrolyte in contact with the iron particulate material electrode is then replaced with the electrolyte in contact with the additive holder.

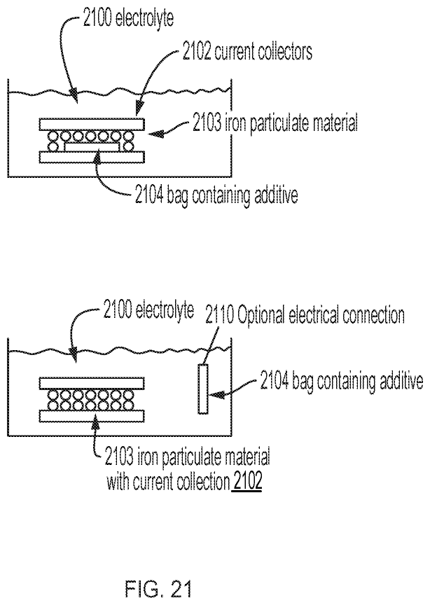

In one embodiment, the additive holder may be in electrical contact with a potentiostat or system, which maintains the holder at potentials that prevent the dissolution of the additive in the holder. FIG. 21 illustrates example additive holder configurations. In the configuration shown in the top portion of FIG. 21, the bag containing additive 2104 may be in contact with the iron particulate material 2103 disposed in the electrolyte 2100 between the current collectors 2102 along with the iron particulate material 2103. In the configuration shown in the bottom portion of FIG. 21, the bag containing additive 2104 may be suspended in the electrolyte 2100 separated from the iron particulate material 2103 and current collector 2102, such as by an optional electrical connection 2110.

Sulfide ions in the electrolyte solution have been proven to increase accessible capacity and cyclability of iron electrodes in alkaline secondary batteries. Sulfide ions, however, have been shown to reduce in concentration in the electrolyte due to ageing with cycle number and time, which may reduce the positive impacts of the dissolved sulfide on anode performance. One method to enable improved performance throughout lifetime is to incorporate sulfur containing species directly into the iron electrode material.

In one embodiment, elemental sulfur is introduced directly into porous iron anodes by melt diffusing the sulfur into the porous metal. The sulfur will then be introduced to the anode as a solid and be in intimate contact with the active metal anode material, promoting positive interactions that improve accessible capacity and cycle life.

In another embodiment, metal sulfides are introduced as solids to an iron anode. Metal sulfides of interest include: FeS, FeS₂, MnS, Bi₂S₃, Sb₂S₃, FeAsS, PbS, SnS, HgS, AsS, Pb₄FeSb₆Si₄, Pb₃Sn₄FeSb₂Si₄, SeS₂, among others. The cation in the metal sulfide may contribute to the battery's capacity (i.e., Fe), be inert to the charge/discharge reaction (i.e., Mn), or retard the hydrogen evolution reaction (i.e., Pb, Sb, Hg, As, Bi).

In one non-limiting example, the metal sulfides are incorporated into a bed of direct reduced iron (DRI) pellets.

Methods for incorporation of sulfur containing species into iron electrodes include, but are not limited to: (1) Incorporation of bulk solid particles, powders, or agglomerates into voids between material in the electrode bed; (2) Incorporation via melt diffusion into the electrode pores for metal sulfides with melting points below the melting point of iron metal (i.e., Bi₂S₃); (3) Incorporation of metal sulfide powders by mixing into oxidized ore pellets (i.e., taconite pellets) during the pelletization process (In such an embodiment, the metal sulfide would remain in the pellet through the reduction process, producing a pellet with metallic iron, metal sulfide, and impurities.); (4) Incorporation of metal sulfides into pellets containing only the metal sulfide and a binder. In one non-binding example, these pellets could be directly incorporated into a pellet bed of DRI in a specific ratio with DRI pellets; and (5) Incorporation of metal sulfide powder using a mixing, milling, or rolling apparatus, such as a ball mill.

In another embodiment, the above-mentioned incorporation methods are used with sulfur containing additives including, but not limited to, metal sulfides.

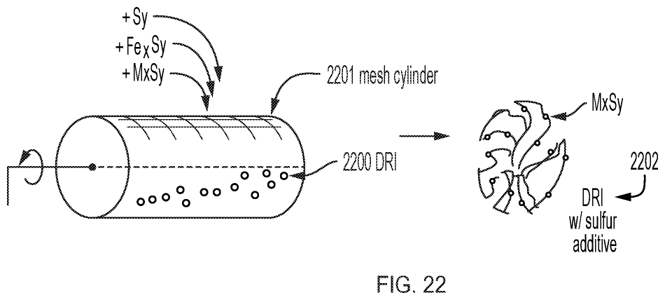

In another embodiment, sulfur containing additives including, but not limited to, metal sulfides, are incorporated into the iron anode material via the Trommel screening process step of DRI production, such as illustrated in FIG. 22 in which DRI pellets 2200 in a mesh cylinder are infused with sulfur additives during production to result in DRI with sulfur additive pellets 2202.

Uniform or controlled incorporation of additives into a preformed metal electrode is difficult and limits effectiveness of additives.

Various embodiments include selective precipitation with reactive counterions. In various embodiments, a metal is incorporated into the particulate iron material electrode in the neutral or oxidized state and subsequently reacted with a counterion of choice. The concentration of the metal additive is determined by the solubility of the source compound or final desired concentration of the reactive counterion in the electrode. In certain embodiments, this electrode is exposed to an electrolyte containing a source of a reactive counterion (e.g. Na₂S, K₂S, Na₂Se, Na₂Te) to form a compound (e.g. CdS, Bi₂S₃, Bi₂Se₃) in situ where the localization and concentration may be determined by the presence, concentration, and solubility of the additive metal, reactive counterion, or resulting compound. In certain embodiments, accessibility of these additives may be further adjusted by use of fugitive pore-formers. In certain embodiments this electrode is cycled electrochemically before or after exposure to an electrolyte containing the reactive counterion in a specified concentration to control the uptake of the reactive counterion.

In a non-binding example, 0.5 to 10 wt % Bi₂O₃ is incorporated into the electrode before being cycled electrochemically to potentials sufficiently reducing to form Bi(s). Exposure to an electrolyte containing 250 mM Na₂S may form Bi₂S₃ distributed throughout the electrode in the reactions shown below:

Bi₂O₃+3H₂O→2Bi(s)+6OH−

2Bi(s)+3S₂₋→Bi₂S₃.

In various embodiments, an additive of interest that is a source of sulfur, selenium, tellurium, nitrogen, or phosphorus (e.g. Na₂S, Na₂Se, Na₃PO₄) is incorporated into the electrode at a concentration determined by the solubility of the source compound or final desired concentration of the final compound in the electrode.

In certain embodiments, this electrode is exposed to an electrolyte containing a source of a reactive metal (e.g. Fe, Bi, Hg, As, Cd, Cu, Ni, In, Tl, Zn, Mn, Ag) or metal-containing ion (e.g., Bi(NO₃)₃, NaAsO₄, Cd(NO₃)₂, CuSO₄*xH₂O) to form a compound (e.g. CdS, Bi₂S₃, Bi₂Se₃) in situ where the localization and concentration may be determined by the presence, concentration, and solubility of the additive metal, reactive counterion, or resulting compound. The solubility of the non-metallic additive may allow for the creation of local concentration gradients in the electrolyte, leading to regions where precipitation is more favored. In certain embodiments, accessibility of these additives may be further adjusted by use of fugitive pore-formers. In certain embodiments this electrode is cycled electrochemically before or after exposure to an electrolyte containing the metal or metal-containing ion in a specified concentration to control the uptake of the metal or metal-containing ion.

In a non-binding example, Na₂S may be incorporated into the metal electrode. Exposure to an electrolyte containing Bi(NO₃)₃ may form Bi₂S₃ distributed throughout the electrode in the reaction shown below:

2Bi(NO₃)₃ (aq)+3Na₂S→6NaNO₃+Bi₂S₃ (s)

In various embodiments, an additive of interest that is a source of sulfur, selenium, tellurium, nitrogen, or phosphorus but may be not itself be ionic (e.g. S or Se metal) is incorporated into the electrode at a concentration determined by the solubility of the source compound or final desired concentration of the final compound in the electrode.

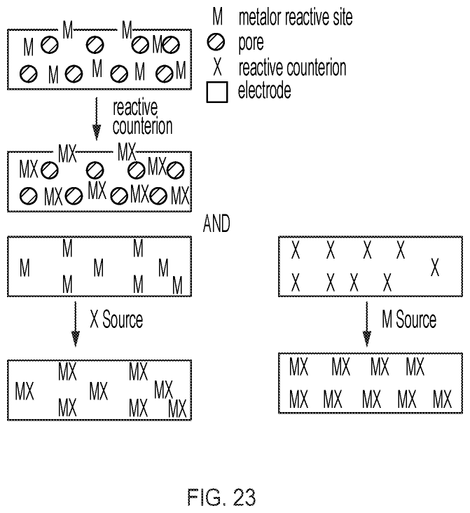

In various embodiments, this electrode containing a non-reactive additive may be exposed to an electrolyte, which in one embodiment contains NaOH or KOH, and, in one embodiment, is electrochemically cycled to generate anionic species on the anode or in the electrolyte (e.g. S₂₋, S₂₂₋, polysulfides). The species may react to form Bi₂S₃ on the surface or sequestered in the anode as illustrated in FIG. 23. The exposure of the anode to this electrolyte may increase the overall porosity as the counterion reacts, which may be beneficial to overall accessible capacity.

Water and air sensitive additives can rapidly degrade in aqueous alkaline electrolyte. For example, compounds containing sulfide (S²⁻) and bisulfide (HS⁻) such as Na₂S or NaSH degrade on exposure to oxygen by forming sulfate or other sulfur-containing compounds (e.g. sulfite, thiosulfate, sulfur, polysulfides):

HS−+3O₂→>SO₃₂₋+2H+

2HS−+3O₂+2OH−→SO₃₂₋+2H2O

SO₃₂₋+O₂→2SO₄₂₋

2SO₃₂₋+2HS−+O₂→2 S2O₃₂₋+2 OH−

It is favorable to maintain sulfur species in the electrode or electrolyte as sulfide or bisulfide as the reduction of sulfate or other oxidized sulfur-containing compounds back to sulfide, bisulfide, or hydrogen sulfide is difficult.

In one embodiment, oxidized sulfur-containing species (e.g., Na₂SO₄, Na₂S₂O₃, Na₂SO₃, S metal) are added to the electrolyte in sufficient quantity to reduce or completely suppress formation of oxidized sulfur species by shifting the equilibrium in favor of the reduced sulfur species, in accordance with Le Chatelier's principle.

In one embodiment, oxidized sulfur-containing species (e.g., Na₂SO₄, Na₂S₂O₃, Na₂SO₃, S metal) are added to the electrode. Upon exposure to the electrolyte, these soluble additives may dissolve in the electrolyte, increasing the porosity of the electrode and reducing or suppressing the formation of oxidized sulfur species in solution.

In one embodiment, oxidized sulfur-containing species that also contain a metallic cation (e.g. FeSO₄, FeS₂O₃, FeSO₃) is added to suppress the oxidation of reduced sulfur species as well as suppress the dissolution of metallic species from the iron electrode.

DRI-based iron negative electrodes exhibit compatibility over a wide range of initial sulfide concentrations within the electrolyte. In addition, it has been shown that the initial sulfide concentration on a gS/gFe is the driving factor, not sulfide concentration in the electrolyte.

In certain embodiments, an initial sulfide concentration of 1 mM Na₂S (0.1 mgS/gFe) is sufficient for stable capacity performance.

In certain embodiments, an initial sulfide concentration of 10 mM Na₂S (1.4 mgS/gFe) is sufficient for stable capacity performance.

In certain embodiments, an initial sulfide concentration of 50 mM Na₂S (6.8 mgS/gFe) is sufficient for stable capacity performance.

In certain embodiments, an initial sulfide concentration of 175 mM Na₂S (23.6 gS/gFe) is sufficient for stable capacity performance.

In certain embodiments, an initial sulfide concentration of >=250 mM Na₂S (33.8 gS/gFe) is sufficient for stable capacity performance.

Further, the method of sulfide incorporation into the iron negative electrode can be achieved with a variety of techniques.

In certain embodiments, sulfide is incorporated through a high sulfide concentration electrolyte within the full cell.

In certain embodiments, sulfide is incorporated through a high sulfide concentration electrolyte soak prior to cycling, which can be completed in a non-sulfide containing electrolyte (may be beneficial for the positive electrodes).

In certain embodiments, sulfide is incorporated through a high sulfide concentration electrolyte soak prior to cycling, after which the positive electrodes are inserted into the full cell wherein the sulfide concentration can be in the range of 10-250 mM (1.4-33.8 mgS/gFe) or higher.

Optimal sulfide incorporation may also be achieved via maintenance methods including, but not limited to:1) periodic addition of high sulfide concentration solution or in solid form; and 2) continual addition of sulfide in solid or solution form, wherein the sulfide concentration can be in the range of 10-250 mM (1.4-33.8 mgS/gFe) or higher

In an embodiment, −325 mesh iron sponge powders with open porosity internal to the particles are thermally bonded via sintering to comprise the base for an iron electrode material. Bismuth oxide and iron sulfide are incorporated throughout the sintered electrode material, and the materials are thermally bonded to a current collecting, perforated sheet, and the sintered connections to the current collectors and between the powder particles obviate the need for compression to attain conduction. An alkaline electrolyte is comprised of a mixture of 80% potassium hydroxide, 15% sodium hydroxide, and 5% lithium hydroxide on a molar basis, with a total hydroxide concentration of 6 molar in an aqueous solution.

In one embodiment, the iron electrode material may comprise direct reduced iron pellets, with an electrolyte comprising six molar potassium hydroxide, 0.1 molar lithium hydroxide, 0.05 molar sodium sulfide. The iron electrode may further comprise 1 wt. % bismuth sulfide distributed finely among the direct reduced iron pellets. The electrode materials may be compressed in a rigid cage comprising nickel-plated current collecting stainless steel plates applying uniaxial pressure to compress the pellets within a rigid wall structure comprised of poly(methylmethacrylate), the current collecting plates held in place by stainless steel bolts which are electrically isolated from the current collectors. The bed thicknesses of such an embodiment may range from one to ten centimeters thick.

In an embodiment, the iron electrode material may comprise a carbonyl iron powder, lead oxide, and iron sulfide. The lead oxide is added at 0.1 wt. %, and the iron sulfide is included as 1.5 wt. %, both of the total weight of solids in the electrode. The solids are lightly sintered such that they bond and agglomerate, and are subsequently compressed in a nickel mesh textile which is compressed by inflation of a polyethylene balloon. The electrolyte is five molar sodium hydroxide with additives of 0.005 molar sodium sulfide and 0.01 molar octanethiol.

In another embodiment, direct reduced iron pellets are crushed to form particle sizes in the range of 1-6 mm. The particles are mixed with natural flake graphite with a particle size of 200 microns at 1 wt. % of the solids mix and 100 micron particle size iron sulfide at 0.05 wt. %. The electrolyte is aqueous with 6.5 molar potassium hydroxide, 0.5 molar lithium hydroxide, and 0.25 molar sodium sulfide, and 0.001 molar octanethiol. The solids mix is loaded into nickel mesh bag with a mesh size around 0.5 mm, and the bag is compressed via a cinching mechanism to compress the solids material lightly

Various embodiments may include a battery comprising: a first electrode; an electrolyte; and a second electrode, wherein at least one of the first electrode and the second electrode comprises atomized metal powder. Various embodiments may include a battery comprising: a first electrode; an electrolyte; and a second electrode, wherein at least one of the first electrode and the second electrode comprises iron agglomerates. In some embodiments, the iron agglomerates have an average length ranging from about 50 um to about 50 mm. In some embodiments, the iron agglomerates have an average internal porosity ranging from about 10% to about 90% by volume. In some embodiments, the iron agglomerates have an average specific surface area ranging from about 0.1 m²/g to about 25 m²/g. In some embodiments, the electrolyte is infiltrated between the iron agglomerates. In some embodiments, the electrolyte comprises 1-octanethiol. In some embodiments, the electrolyte comprises a molybdate anion and a sulfide anion. In some embodiments, the iron agglomerates are supported within a metal textile mesh providing compressive force and current collection for the iron agglomerates. In some embodiments, the iron agglomerates are bonded to one another and bonded to a current collector.

Various embodiments include a method of making an electrode, comprising: electrochemically producing metal powder; and forming the metal powder into an electrode. In some embodiments, electrochemically producing the metal powder comprises electrochemically producing the metal powder at least in part using a molten salt electrochemistry. In some embodiments, electrochemically producing the metal powder comprises electrochemically producing the metal powder at least in part using gas atomization. In some embodiments, electrochemically producing the metal powder comprises electrochemically producing the metal powder at least in part using water atomization.

In various embodiments, sacrificial pore formers, convertible pore formers, fugitive pore formers, removable pore formers, or techniques may be utilized. In these embodiments, the intermediate material with the pore former still present may have Fe total wt % in the range of 20 wt % to 90 wt %. The pore formers may be removed in part prior to utilization as an electrode, in whole prior to utilization as an electrode, or during utilization as an electrode, and combinations and variations of these. In an embodiment, an intermediate can have from 25 wt % to 50 wt % Fe total, and upon removal of the pore former, provide an electrode with 60 wt % to 90 wt % Fe total.

In embodiments, as set forth herein, the iron material can be processed, chemically modified, mechanically modified, or otherwise configured, to have one or more of its features changed. These methodologies are generally described herein as being performed on DRI material. It is understood that these methodologies can be used on other iron containing materials, such as, a reduced iron material, iron in a non-oxidized state, iron in a highly oxidized state, iron having a valence state between 0 and 3+ and combinations and variations of these. In this manner there are provided iron containing pellets for utilization in an electrode configuration for a long duration electrical storage cell that have predetermined features, for example, the features as set forth in this specification.

In certain embodiments, the DRI is subjected to mechanical operations to grind, abrade, or polish the surface, and/or remove fines. In one embodiment, DRI pellets are rolled in a trommel screen to abrade the surface and remove fine powder/dust from the surface. This operation may have the beneficial effect of reducing the reactivity of the pellet DRI, making it easier and safer to ship, without resorting to a briquetting or other compaction operation. In another embodiment, DRI blocks or sheets are passed under a rotary brush to remove fine powders from the surface, having a similar beneficial effect.

In one embodiment, porosity is increased by pre-treating the DRI by soaking in an acid bath (for example, concentrated HCl), which etches the iron and creates larger pores, increasing the total porosity. The etching time can be optimized to increase the total capacity of a DRI pellet without losing too much active material to the acid etching solution.

In another embodiment, desirable impurities or additives are incorporated into DRI. When these impurities are solids, they may be incorporated by ball-milling (for example, with a planetary ball mill or similar equipment) the powder additive with DRI pellets, the pellets serving as their own milling media. In this way the powder additive is mechanically introduced into the pores or surface of the DRI pellet. DRI may also be coated in beneficial additives, for example, by rolling or dipping in a slurry containing the additives. These desirable impurities may include alkali sulfides. Alkali sulfide salts have been demonstrated to vastly improve active material utilization in Fe anodes. Just as soluble alkali sulfides may be added to the electrolyte, insoluble alkali sulfides may be added to DRI, for example, by the above method.

In some embodiments, the surface area of cementite or iron carbide containing materials, such as DRI pellets containing cementite or iron carbide, is increased by using the material as the anode of an electrochemical cell and discharging it. In certain embodiments, the specific current densities may be 0.1-25 mA/g. This high surface area iron oxide may also be used for various applications other than in electrochemical cells.

In various embodiments, to increase electrical conductivity, pellets may be mixed with a more electrically conductive, but potentially more expensive, powder, to produce a higher conductivity composite bed. This powder may increase the areal capacity of the cell by filling voids in between the pellets. This may decrease the ratio of electrolyte volume to DRI pellets in a way that can be systematically varied and optimized. In one embodiment, this powder is used at the site of current collection to increase the contact surface area, reducing interfacial resistivity between the current collector and the small contact area of the spherical pellets, as described in more detail in a previous section. This ensures the ability to vary and control the effective current density at the pellet. Varying particle size in the composite bed may produce controllable cost and conductivity. In another example, the use of additional powder, wire, mesh, gauze, or wool conductive material enables the use of low-conductivity pellets such as DR taconite pellets or direct reduced pellets that are undermetallized (sometimes called “remet” in the trade) in the composite bed by increasing overall conductivity. In one embodiment, this conductive component may comprise DRI fines or other waste materials from the DRI process.

In one embodiment, porous sintered iron electrodes may be formed from DRI, which may have its particle size reduced or be made into a powder, for instance, by crushing or grinding. DRI fines or other waste materials may also be used to form a sintered iron electrode. The sintered electrode may be formed with a binder under heat and/or pressure, then the binder may be burned out and the green-form is sintered at high temperature. DRI pellets may also be directly fused together by sintering, without a binder, optionally with pressure applied, in a non-oxidizing atmosphere, in order to create electrical and physical connectivity between pellets.

In various embodiments, porous negative electrodes may be formed by crushing, shredding, or grinding of hot briquetted iron (HBI). In various embodiments, HBI may be preferable for shipment and transportation due to its lower surface area and reactivity, but the porosity of HBI may be too low for practical application in a thick electrode, due to ionic transport limitations. To achieve the optimal combination of transportation and performance, the DRI may be transported in a briquetted form to the cell assembly or manufacturing site whereat it is crushed, ground, and/or shredded to increase the porosity of the resulting electrode.

A packed bed of DRI pellets may be a desirable configuration of an iron-based electrode as it provides for an electronically conductive percolation path through the packed bed while leaving porosity available to be occupied by an electrolyte that facilitates ion transport. In certain embodiments, the ratio of electrolyte volume to DRI mass may be in the range of 0.5 mL/g to 5 mL/g, such as 0.6 mL/g or 1.0 mL/g. The DRI pellets are generally in contact with surrounding pellets through a small contact area compared to the surface area of the pellet, and in some instances the contact can be considered a “point contact.” Contacts of small cross-sectional area may be constrictions for the flow of electrical current that may result in a relatively low electrical conductivity for the pellet bed as a whole, which may in turn lead to high electrode overpotentials and low voltaic efficiency of the battery.

In various embodiments, the electrical conductivity of a DRI pellet bed may be increased in a number of ways. In some embodiments, the electrical conductivity of a DRI pellet bed may be increased by the use of an additional conductive material that may surround individual pellets, be embedded within individual pellets, surround the entire pellet bed, or penetrate through a pellet bed. The conductive material may be one or more of a metal, a metal oxide, a metal carbide, a metal nitride a semiconductor, carbon, a conductive polymer, or a composite comprising at least one of such electronically conducting materials. The electronically conductive material may be in the form of a powder, wire, mesh, or sheet. In certain embodiments, the conductive material may itself participate in an electrochemical reaction in the battery, including but not limited to providing storage capacity. In certain other embodiments the electronically conductive material is not substantially electrochemically active. In one embodiment, the conductive material is a powder, and the powder fills or partially fills the space between pellets or in between pellets and current collectors to improve inter-pellet or pellet-to-current collector electrical conduction. For example, the conductive powder may consist of DRI “fines”, which is a powderized waste product of the direct reduction process that is similar in composition to DRI. The fines may serve to both increase the electrical conductivity of the bed and to increase the storage capacity of the anode in this case. In another embodiment, the conductive material is a powder, and the powder is applied to the surfaces of the pellets to make a coating. Such a coating provides for a larger area for electrical contact between pellets.

In various embodiments, conductive coatings are applied to low-conductivity pellets to enable their usage in an electrode. In certain embodiments low-conductivity pellets such as taconite pellets or direct reduced pellets that are undermetallized (sometimes called “remet” in the trade) may be coated. The coating may be conductive to decrease electrical resistance from the current collector to the taconite pellet during the initial reduction step. The coating may or may not be removed during or after the reduction step. In one embodiment, the coating is a thin conformal metallic layer such as stainless steel that wraps circumferentially around each pellet. In another embodiment, the coating is a thin layer of lead that coats the outside of each pellet using a directional deposition technique such as sputtering, evaporation, or other physical vapor deposition techniques. In certain embodiments, the coating is applied by rolling DRI and the coating material together in a rotating vessel. In certain embodiments the DRI in the rotating vessel is substantially spherical in shape.

In another embodiment, some or all of the individual pellets in the pellet bed are wrapped with an electrically conductive wire, foil or sheet. In some embodiments a tightening mechanism, such as a screen, is used to apply tension to the wire, foil or sheet. Optionally, such current collectors surrounding individual pellets can be attached to wires that are gathered or connect to a larger current collector. In another example, a conductive mesh, gauze, or wool is interspersed in the space between the DRI pellets to increase electrical connectivity. In various embodiments the conductive material is a mesh with an opening (clear size) that is selected to be smaller than the pellets such that pellets do not pass through the mesh. The conductive material in this case may be stainless steel, nickel, or other metals and metal alloys. In another example, DRI pellets are directly connected to each other by conductive wire through or around the individual pellets. For example, a wire may be threaded through holes in the DRI pellets, similar to forming a string of beads, leading to electrical contact not only between pellets but to the interior of pellets. Optionally, a string of pellets may be held in contact using an electrical terminal or “stopper” at which tension is optionally applied to the wire. The electrical terminals may optionally be electrically connected to a larger current collecting fixture such as a plate.

In another embodiment, the electrical conductivity of a bed of pellets is improved by the application of a compressive load to the DRI pellet bed anode to increase inter-pellet force and/or pellet-to-pellet or pellet-to-current collector contact area, thus reducing contact resistance and enhancing electrochemical performance. Typical DRI pellets are approximately spherical in shape, have internal porosity, and can be elastically deformed to >5% linear strain before yielding. Applying a load that compresses the DRI bed can increase the effective contact area between pellets and at the interface between pellets and the current collector. It is advantageous to use pellets with yield strains that permit deformation to achieve desired increases in conductivity without undergoing fracture. In one embodiment, pellets with compressive strengths between 700 and 2500 psi are used in a pellet bed electrode to which a compressive load is applied. In addition, the mechanical assembly that provides the compressive load on the pellet bed may also serve as current collectors. The electrical resistance of such a bed of pellets, measured in the dry state before any filling with liquid electrolyte, may be reduced by a factor of two to a factor of 100 or more by applying a compressive load. In certain embodiments, the applied load can be in the range of 0.1 psi to 1000 psi, such as 50 psi or 100 psi. In certain embodiments, the applied load can be in the range of 0.1 psi to 10 psi, such as 1 psi or 5 psi. In one example, metal plates on opposing faces of a bed of pellets serve to provide both current collection and a compressive load on the pellet bed. Optionally, one or more of the plates may be replaced by a macro-porous current collector (e.g., metal mesh) to facilitate ionic transport throughout the electrode. The opposing current collectors are preferably joined so they are at the same electrical potential, advantageously making electrochemical reaction rates more uniform throughout the electrode. In another example, a container containing the pellet bed serves both as a current collector and as a method of applying compressive load. In another embodiment, an array of conductive posts (or rods) that connect to a common, bottom-facing current collector is implemented. Therefore, many areas of current collection can be placed throughout the pellet bed. This approach can also reduce the effective transport lengths within the electrode from the total pellet bed thickness to the inter-post spacing. Additionally, these posts can be used to affix a mechanical clamping mechanism, such as a plate or perforated plate at the top of the pellet bed, to incorporate down-force onto the pellet bed, while serving as a current collection element.

In some embodiments, a compressive load may be provided in part or in whole by a magnetic force. For example, force can be applied using a permanent magnet positioned on one or more sides of the bed, causing the pellets in the bed to be attracted to the magnet. For a DRI pellet bed that is predominantly metallic iron, the pellet bed is expected to be predominantly ferromagnetic, and the pellet bed would be attracted to the magnet. The magnet can also be embedded in other fixtures surrounding the pellet bed. The magnets and fixtures serve to hold the bed of pellets in place, and provide a compressive stress that results in improved electrical contact between pellets and between pellets and current collectors as described above.

In some embodiments, inter-pellet contact resistance in the pellet bed may be reduced through the use of a pre-treatment applied to the pellet bed before battery assembly and/or operation. Several such pre-treatment processes are described in the following paragraphs.

In some embodiments, whole DRI pellets are packed into a bed and sintered in an inert or reducing (i.e., non-oxidizing) atmosphere, optionally with the application of mechanical pressure during sintering, for example, using a material that is stable at the sintering temperature and atmosphere. The sintering temperature may range from 600-1100° C. The non-oxidizing atmosphere may consist partially or wholly of inert gases such as nitrogen or argon. The non-oxidizing atmosphere may also include mixtures of gases that tend to reduce iron, such as CO and CO₂, and H₂ and H₂O. The exact composition of the mixture may be optimized according to an Ellingham diagram to ensure that oxidation of the iron is thermodynamically unfavorable. In one embodiment, forming gas (5% H₂, 95% N₂) is used at a sintering temperature of about 600° C. to about 1100° C., such as 600° C. to about 850° C., 850° C., about 850° C. to about 1100° C., etc., to provide a non-oxidizing condition. The combination of high temperature and a non-oxidizing atmosphere may promote atom diffusion and particle coarsening at pellet contacts, causing the pellets to bond to each other. The result is a bed of DRI pellets that are fused together with low inter-pellet contact resistance. The pellets may also be fused to the current collector through the same process.

In another embodiment, the pellets are joined using a thermal treatment in which a flux or sintering aid is used to substantially reduce the heat treatment temperature required to form sinter necks between the pellets. Examples of fluxes or sintering aids include one or more metals of lower melting point than iron, such as zinc, tin, copper, aluminum, bismuth, and lead, or metals which form alloys with iron that have lower melting temperatures than iron, such as those which exhibit a lower-melting eutectic liquid. Other examples of sintering aids include one or more glass-forming compositions including but not limited to silicates, borates and phosphates.

In another embodiment, the pellets can be fused together electrically by a process such as welding. In some such embodiments, welding is accomplished by passing electrical current through the bed of pellets. In some such embodiments, such current is delivered by discharging a capacitor.

In various embodiments the anode electrode is an ordered array of pellets. In certain embodiments the pellets are arranged into cylinders. In certain embodiments the pellets are arranged into plates. In certain embodiments the pellets are arranged into discs. In certain embodiments the pellets are arranged into rectangular prisms. In certain embodiments the pellets are arranged into hexagonal prisms. In certain embodiments the pellets are arranged into arbitrary volumes.

In various embodiments, an electrolyte management system may be provided, in which different electrolyte additives or formulations are added to the battery when switching between states of operation. The optimal electrolyte formulation for operation during the charge, discharge, and idle states of a battery may be very different. The electrolyte management system of various embodiments may improve capacity utilization of the iron electrode, self-discharge of the cell, and suppress the hydrogen evolution reaction (HER). One or more such benefits may be realized simultaneously. In one embodiment of such an electrolyte management system, an arbitrary number of distinct electrolyte formulation reservoirs are provided, each connected to the electrochemical cell with separate flow controllers. During different stages of operation, different relative amounts of each electrolyte formulation are flowed into the cell based on the optimal concentrations of constituent species for the instantaneous mode of operation (charge, discharge, idle). The electrolyte management system may be configured to adjust the electrolyte composition based on the instantaneous state of charge of the battery.

Various embodiments may provide a method and apparatus for maintaining the liquid electrolyte level in a battery. A vessel containing water when exposed to air will experience evaporation until the partial pressure of water vapor in the air is equal to the vapor pressure of water at the system's temperature. Specifically, an electrochemical system where aqueous electrolyte is exposed to the environment will experience this same evaporation. Dehydration of the electrolyte can lead to issues stemming from reduced electrolyte volume, and changes in electrolyte concentration can alter electrochemical performance. To mitigate this issue, in various embodiments the electrolyte level may be maintained via constant or intermittent flow of electrolyte into the cell volume. Specifically, electrolyte liquid level can be maintained by introduction of electrolyte into the vessel until it pours over an overflow point. Since the liquid level cannot rise above this spill point, the level can be maintained in a relatively controlled manner. Specifically, several volumes can be arranged in a cascade such that overflow from one chamber can flow into the next, establishing “liquid communication” between cells. Linking these cells in series allows one source to supply liquid electrolyte to several cells simultaneously. Overflow from the final vessel can be re-circulated to the first. In a system that utilizes shared electrolyte, flowing in a cascading fashion between cells, attributes of the electrolyte can be monitored and treated at a central location for many cells. Electrolyte mediation such as performing compositional adjustments or adding components, in order to mitigate issues related to electrolyte carbonation, electrolyte dehydration, and the like, is beneficially conducted at such a collection source for the circulating electrolyte.

Various embodiments may provide compositions and methods for adding beneficial additives to the electrolyte of an aqueous electrochemical cell are provided. During charging of an aqueous secondary battery, electrolytic production of hydrogen can cause coulombic inefficiency, gas buildup in the cell housing, safety concerns, and consumption of electrolyte. Furthermore, metal electrode self-discharge can occur by spontaneous reaction of the metal with the electrolyte to form metal hydroxide, in which reaction hydrogen is produced as a product. Certain solid-phase hydrogen evolution inhibitors (e.g., Bi, Sb, As) can reduce these deleterious effects, but incorporating a solid-phase inhibitor into the porous metal electrode of a battery can be costly and present manufacturing challenges. Accordingly, various embodiments, a soluble salt of a desired hydrogen evolution inhibitor, which dissolves to provide in solution ions of the desired additive (e.g., Bi³⁺, Sb³⁺, As³⁺), is added to a liquid electrolyte. The additive is selected such that the redox potential of the inhibitor's ion-to-metal plating reaction (e.g., Bi³⁺→Bi⁰) occurs at a higher half-cell potential (as measured vs. RHE (but at a lower cell potential)) than the potential of the charging reaction of the anode active material. Thus, during charging of the battery (reduction of the metal electrode), the ionic form of the HER inhibitor is electrodeposited onto the surfaces of the metal electrode, providing an inexpensive and simple strategy for introducing an HER inhibitor to the battery electrolyte chemistry. The electrodeposited inhibitor suppresses the hydrogen evolution reaction at the surface of the electrode, which may be an electrode with open porosity. During the discharge mode, the deposit may dissolve back into the electrolyte. The salt additive is preferably selected so that it does not degrade the operation of the cathode during charge or discharge operations.

In another embodiment, the electrochemical cell includes an electrode at which the hydrogen oxidation reaction (HOR) is performed to recapture the hydrogen produced in the HER side reaction, mitigating the evolution of potentially dangerous hydrogen gas. Hydrogen gas bubbles generated during HER may be captured and exposed to the HOR electrode, which may be a working electrode of the battery cell or an additional electrode added to the system. In one embodiment, the hydrogen gas is captured by arranging the electrodes of the cell such that buoyancy forces carry the hydrogen gas bubbles to the HOR electrode. For example, the system may be tilted, or include a funnel designed to promote this flow.

In various embodiments, a liquid electrolyte is flowed through a collection or bed of DRI pellets. For a thick (up to multi-centimeter) battery electrode comprised of active material pellets, it can be challenging to achieve sufficient transport of reactants, reactant products, and additives through the thick bed on a time scale commensurate with the operating (charge and discharge) time scale of the battery. Inadequate transport rates in the electrolyte can have several detrimental impacts including but not limited to increasing overpotential losses in the pellet-based electrode and decreasing utilization of the active materials. In a metal-electrode battery with an alkaline electrolyte, bubble formation and pH gradient formation during both charge and discharge conditions may result in undesired performance decay or corrosion of one or both of the electrodes. In various embodiments, liquid electrolyte is flowed through the bed of DRI pellets in order to reduce the detrimental effects of limited transport. Flow of the electrolyte produces convective transport of electrolyte individual pellets. Amongst other benefits, electrochemical reaction rates and uniformity of reaction are improved by decreasing electrolyte concentration boundary layers that may arise through the thickness of the entire pellet bed or within macro-pores in the pellet bed. The electrolyte flow will generally decrease overpotential losses by homogenizing the electrolyte composition throughout the macro- and micro-structure of the electrode. In some embodiments, electrolyte flow is accomplished using active methods, such as mechanical pumping. The flow rate of the electrolyte may be low, as low as 1 mL/min/cm² or less. In other embodiments, electrolyte flow is accomplished by passive means, such as buoyancy-driven flow due to thermal or compositional gradients. In a specific example, a component of the battery at which resistive dissipation of heat occurs is located at or near the bottom of the electrode bed, causing electrolyte to be heated and to rise through the bed of pellets. In another specific example, an electrode at which an electrochemical reaction changes the density of the electrolyte, for example via an exothermic or endothermic reaction or a change in the composition of the electrolyte in contact with the electrode, is located within the battery so as to produce buoyancy-driven flow. In this example, an electrode reaction that produces a lower density electrolyte may be located at or near the bottom of a bed of DRI pellets, and a reaction that increases the density of the electrolyte may be located at the top of the bed of pellets.

In some embodiments, an additive that suppresses a side-reaction, such as a corrosion inhibitor that suppresses the HER reaction or suppresses self-discharge, is combined with an additive that improves capacity utilization. Additives to the electrolyte of a battery comprising a metal electrode, including iron electrodes, may beneficially perform several functions including increasing the capacity utilization of the iron, suppressing undesirable side reactions, or both. Different additives have different advantages, and these advantages can be combined by combining additives in the proper concentration. An example of a utilization enhancing additive is sulfur or a sulfide. In some embodiments, more than one corrosion inhibitor may be used with one or more sulfides. For example, sulfur aids in de-passivation of iron electrodes, but may be consumed during electrochemical cycling of the battery. Sulfur consumption may therefore contribute to a fade in capacity over many cycles. In one embodiment, a delivery system is used to replenish sulfur in order to maintain battery performance. One example of such a system is a pump that delivers sulfur-bearing liquid to the battery cell. Another example is a dry hopper that delivers polysulfide salts to a closed or open battery cell.

In one embodiment, iron sulfide (FeS) may added to a metal-air battery that uses an alkaline electrolyte as a sparingly soluble additive, thereby improving the electrochemical stability of the OER electrode and increasing the electrode lifetime. This embodiment aids in mitigating catalyst performance decay at an oxygen evolution reaction (OER) electrode under alkaline conditions, which may limit the operational lifetime of the electrode.

In certain embodiments sulfur may be added to DRI by an additional process operation. In certain embodiments DRI may be dipped in a molten sulfur bath, taking advantage of the low melting temperature of sulfur. In certain other embodiments, hydrogen sulfide gas may be flowed over hot or cold DRI to deposit a layer of sulfur and/or iron sulfide on the surface of the DRI. In certain other embodiments sulfur may be sublimed and vapor deposited on the surface of the DRI; the DRI may be hot or cold. In certain embodiments sulfur is melt diffused into the pores of DRI by melting sulfur and then wicking it into the pores of DRI.

In some embodiments, sulfur may be added to the DRI by a wet deposition process involving a process solvent. In certain embodiments, colloidal mixtures may be used to deposit sulfur or sulfide (e.g., FeS) species on/within the DRI. For example, a dispersion of sulfur in water may be prepared via sonication to which DRI is subsequently added. The water may be allowed to evaporate, depositing the sulfur or sulfide species on the surface and within the DRI pellets. In certain other embodiments, sulfur may be dissolved in an organic solvent (e.g., ethanol or acetone). Addition of DRI to the solution, and subsequent evaporation of the solvent, allows for a coating of sulfur.

In certain embodiments, electrolyte additives are delivered to the electrode as mixtures of solids. Electrolyte additives may have a range of solubilities, and some may have the most beneficial effect when they are intimately mixed with the solid electrode. In one embodiment, the solid pellets are primarily composed of additives, and these additive pellets are added to or mixed with a metal electrode, which in one embodiment comprises multiple DRI pellets. In another embodiment, the electrolyte additives are mixed with a metal, which may be the metal comprising the redox-active electrode, and this mixture, which may be pelletized, is mixed with a metal electrode, which in one embodiment comprises multiple DRI pellets. Non-limiting examples of additives include sodium sulfide (Na₂S), potassium sulfide (K₂S), lithium sulfide (Li₂S), iron sulfides (FeSₓ, where x=1-2), bismuth sulfide (Bi₂S₃), lead sulfide (PbS), zinc sulfide (ZnS), antimony sulfide (Sb₂S₃), selenium sulfide (SeS₂), tin sulfides (SnS, SnS₂, Sn₂S₃), nickel sulfide (NiS), molybdenum sulfide (MoS₂), and mercury sulfide (HgS), FeS, bismuth oxide (Bi₂O₃), combinations thereof, or the like. In some embodiments, pellets are prepared with varying proportions of redox-active metal to additive, and pellets differing in composition are mixed to create a blended electrode.

In some embodiments, an electrochemical formation cycling protocol is used to change the properties of starting DRI pellets and improve subsequent operational electrochemical performance of the DRI as an anode. As-made DRI pellets may not be in a form optimized for electrochemical cycling in a battery. For example, a native oxide may exist on the free surface of the DRI that blocks electrochemical access to active material; the specific surface area may be too low to reach desired specific capacity; and/or the pore structure may limit ionic transport and limit specific capacity. In one specific embodiment, initial cycling, referred to as “formation,” consists of one or more repetitions of one or more of the following steps. One step may be a brief charging step (“pre-charge”), during which any native oxide layer that detrimentally passivates the as-received DRI may be chemically reduced, or the specific surface area of the DRI pellet may be increased, in some cases by more than a factor of 10. These changes may increase the accessible capacity of the DRI in subsequent discharges. Another step may be a discharge step that oxidizes the metallic iron until one or more of the reactions from Fe to Fe²⁺, or Fe²⁺ to Fe³⁺, are fully or partially completed. The charge and discharge capacities may be different between repetitions of the formation cycle. In some embodiments, formation may comprise repeated pre-charge and discharge cycles of systematically increasing capacity. In one specific embodiment, the formation cycling consists of the following: Pre-charge to a capacity of 250 mAh/g, then cycle n times the following loop: discharge to 25+n*25 mAh/g, then charge to (25+n*25)*1.1 mAh/g, where n is the cycle number. The pre-charge step increases the specific surface area of the DRI from about 0.5 m²/g up to 12 m²/g or greater, which may enhance accessible capacity for subsequent discharges. The rest of the formation cycling is conducted over n cycles, in growing capacity increments of 25 mAh/g (assuming a 90% coulombic efficiency), gradually approaching charge and discharge capacities corresponding to deep cycling.

In various aspects, the negative electrodes described herein, such as negative electrodes 102, 231, 301, 403, 458, 502, etc., may be negative electrodes comprising iron such as those as discussed in any of U.S. Published Patent Application No. 2020/0036002, U.S. patent application Ser. No. 16/523,722, U.S. Provisional Patent Application No. 62/711,253, U.S. Provisional Application No. 62/790,668, and U.S. Provisional Patent Application No. 62/868,511, the entire contents of all five of which are hereby incorporated by reference for all purposes. Additionally, in various aspects, the negative electrodes described herein, such as negative electrodes 102, 231, 301, 403, 458, 502, etc., may be formed according to any of the methods discussed in any of U.S. Published Patent Application No. 2020/0036002, U.S. patent application Ser. No. 16/523,722, U.S. Provisional Patent Application No. 62/711,253, U.S. Provisional Application No. 62/790,668, and U.S. Provisional Patent Application No. 62/868,511.

Various embodiments may provide devices and/or methods for use in bulk energy storage systems, such as long duration energy storage (LODES) systems, short duration energy storage (SDES) systems, etc. As an example, various embodiments may provide batteries and/or components of batteries (e.g., any of cells/batteries 100, 131, 230, 240, 250, 260, 300, 410, 450, electrodes 502, 6102, 6202, 6500, 6600, 700, 802, 903, 1002, 1100, 1202, 1300, 1405, 1501, 1502, etc.) for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

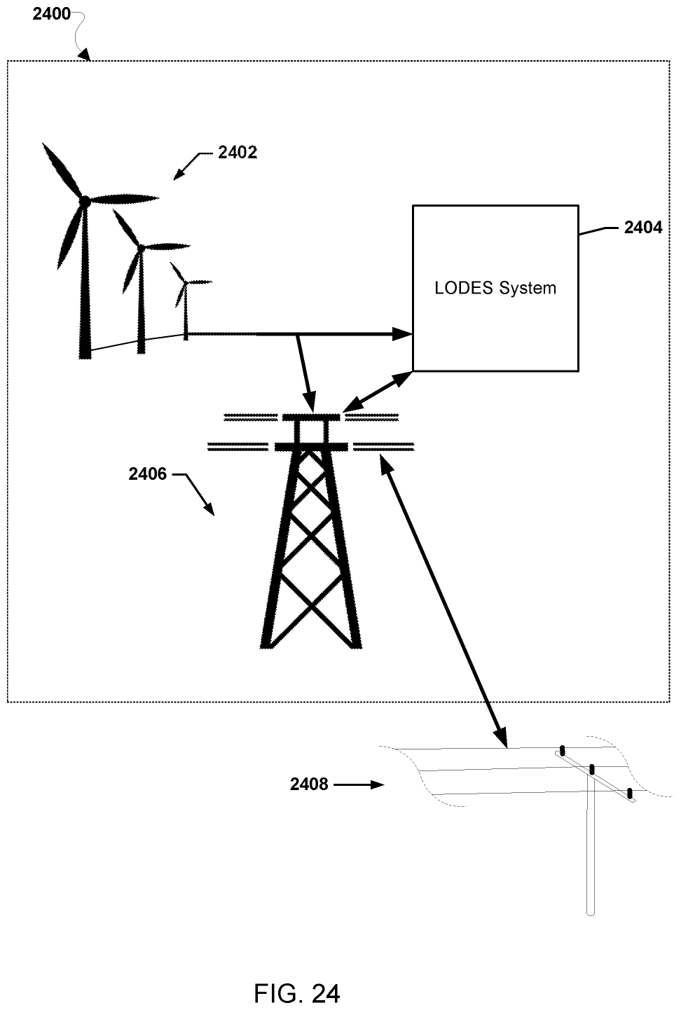

FIGS. 24-32 illustrate various example systems in which one or more aspects of the various embodiments may be used as part of bulk energy storage systems, such as LODES systems, SDES systems, etc. For example, various embodiments described herein with reference to FIGS. 1-23 (e.g., any of batteries 100, 200, 400, 800, 814, 900, 1000, 1100, 1200, 1300, 1310, pellets 105, 115, 305, 198, 199, systems 850, etc.) may be used as batteries for bulk energy storage systems, such as LODES systems, SDES systems, etc. and/or various electrodes as described herein may be used as components for bulk energy storage systems, such as those LODES systems described below with reference to FIGS. 24-32. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 24 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to the grid 2408. The wind farm 2402 may generate power and the wind farm 2402 may output generated power to the LODES system 2404 and/or the transmission facilities 2406. The LODES system 2404 may store power received from the wind farm 2402 and/or the transmission facilities 2406. The LODES system 2404 may output stored power to the transmission facilities 2406. The transmission facilities 2406 may output power received from one or both of the wind farm 2402 and LODES system 2404 to the grid 2408 and/or may receive power from the grid 2408 and output that power to the LODES system 2404. Together the wind farm 2402, the LODES system 2404, and the transmission facilities 2406 may constitute a power plant 2400 that may be a combined power generation, transmission, and storage system. The power generated by the wind farm 2402 may be directly fed to the grid 2408 through the transmission facilities 2406, or may be first stored in the LODES system 2404. In certain cases the power supplied to the grid 2408 may come entirely from the wind farm 2402, entirely from the LODES system 2404, or from a combination of the wind farm 2402 and the LODES system 2404. The dispatch of power from the combined wind farm 2402 and LODES system 2404 power plant 2400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2400, the LODES system 2404 may be used to reshape and “firm” the power produced by the wind farm 2402. In one such example, the wind farm 2402 may have a peak generation output (capacity) of 260 megawatts (MW) and a capacity factor (CF) of 41%. The LODES system 2404 may have a power rating (capacity) of 106 MW, a rated duration (energy/power ratio) of 150 hours (h), and an energy rating of 15,900 megawatt hours (MWh). In another such example, the wind farm 2402 may have a peak generation output (capacity) of 300 MW and a capacity factor (CF) of 41%. The LODES system 2404 may have a power rating of 106 MW, a rated duration (energy/power ratio) of 200 h and an energy rating of 21,200 MWh. In another such example, the wind farm 2402 may have a peak generation output (capacity) of 176 MW and a capacity factor (CF) of 53%. The LODES system 2404 may have a power rating (capacity) of 88 MW, a rated duration (energy/power ratio) of 150 h and an energy rating of 13,200 MWh. In another such example, the wind farm 2402 may have a peak generation output (capacity) of 277 MW and a capacity factor (CF) of 41%. The LODES system 2404 may have a power rating (capacity) of 97 MW, a rated duration (energy/power ratio) of 50 h and an energy rating of 4,850 MWh. In another such example, the wind farm 2402 may have a peak generation output (capacity) of 315 MW and a capacity factor (CF) of 41%. The LODES system 2404 may have a power rating (capacity) of 110 MW, a rated duration (energy/power ratio) of 25 h and an energy rating of 2,750 MWh.

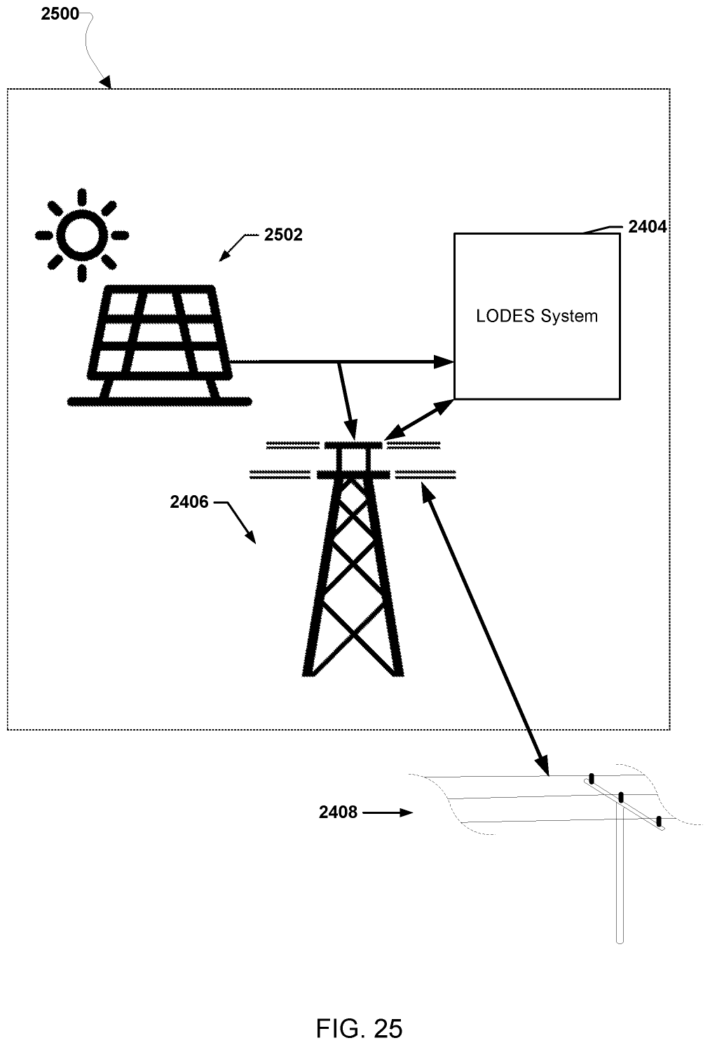

FIG. 25 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 25 may be similar to the system of FIG. 24, except a photovoltaic (PV) farm 2502 may be substituted for the wind farm 2402. The LODES system 2404 may be electrically connected to the PV farm 2502 and one or more transmission facilities 2406. The PV farm 2502 may be electrically connected to the transmission facilities 2406. The transmission facilities 2406 may be electrically connected to the grid 2408. The PV farm 2502 may generate power and the PV farm 2502 may output generated power to the LODES system 2404 and/or the transmission facilities 2406. The LODES system 2404 may store power received from the PV farm 2502 and/or the transmission facilities 2406. The LODES system 2404 may output stored power to the transmission facilities 2406. The transmission facilities 2406 may output power received from one or both of the PV farm 2502 and LODES system 2404 to the grid 2408 and/or may receive power from the grid 2408 and output that power to the LODES system 2404. Together the PV farm 2502, the LODES system 2404, and the transmission facilities 2406 may constitute a power plant 2500 that may be a combined power generation, transmission, and storage system. The power generated by the PV farm 2502 may be directly fed to the grid 2408 through the transmission facilities 2406, or may be first stored in the LODES system 2404. In certain cases the power supplied to the grid 2408 may come entirely from the PV farm 2502, entirely from the LODES system 2404, or from a combination of the PV farm 2502 and the LODES system 2404. The dispatch of power from the combined PV farm 2502 and LODES system 2404 power plant 2500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2500, the LODES system 2404 may be used to reshape and “firm” the power produced by the PV farm 2502. In one such example, the PV farm 2502 may have a peak generation output (capacity) of 490 MW and a capacity factor (CF) of 24%. The LODES system 2404 may have a power rating (capacity) of 340 MW, a rated duration (energy/power ratio) of 150 h and an energy rating of 51,000 MWh. In another such example, the PV farm 2502 may have a peak generation output (capacity) of 680 MW and a capacity factor (CF) of 24%. The LODES system 2404 may have a power rating (capacity) of 410 MW, a rated duration (energy/power ratio) of 200 h, and an energy rating of 82,000 MWh. In another such example, the PV farm 2502 may have a peak generation output (capacity) of 330 MW and a capacity factor (CF) of 31%. The LODES system 2404 may have a power rating (capacity) of 215 MW, a rated duration (energy/power ratio) of 150 h, and an energy rating of 32,250 MWh. In another such example, the PV farm 2502 may have a peak generation output (capacity) of 510 MW and a capacity factor (CF) of 24%. The LODES system 2404 may have a power rating (capacity) of 380 MW, a rated duration (energy/power ratio) of 50 h, and an energy rating of 19,000 MWh. In another such example, the PV farm 2502 may have a peak generation output (capacity) of 630 MW and a capacity factor (CF) of 24%. The LODES system 2404 may have a power rating (capacity) of 380 MW, a rated duration (energy/power ratio) of 25 h, and an energy rating of 9,500 MWh.

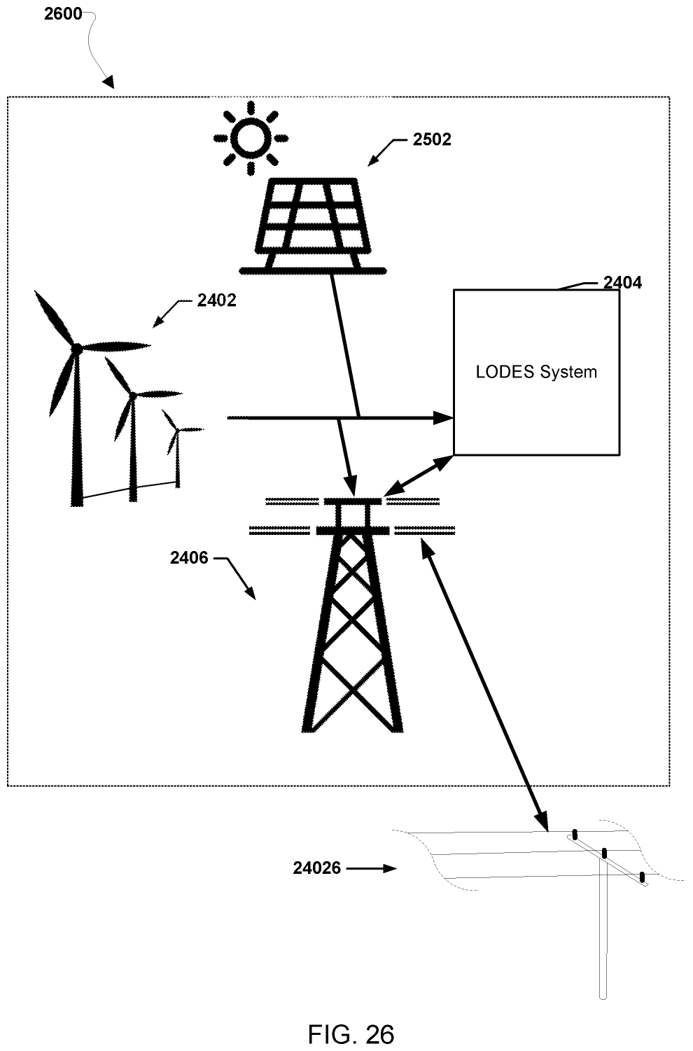

FIG. 26 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 26 may be similar to the systems of FIGS. 24 and 25, except the wind farm 2402 and the photovoltaic (PV) farm 2502 may both be power generators working together in the power plant 2600. Together the PV farm 2502, wind farm 2402, the LODES system 2404, and the transmission facilities 2406 may constitute the power plant 2600 that may be a combined power generation, transmission, and storage system. The power generated by the PV farm 2502 and/or the wind farm 2402 may be directly fed to the grid 2408 through the transmission facilities 2406, or may be first stored in the LODES system 2404. In certain cases the power supplied to the grid 2408 may come entirely from the PV farm 2502, entirely from the wind farm 2402, entirely from the LODES system 2404, or from a combination of the PV farm 2502, the wind farm 2402, and the LODES system 2404. The dispatch of power from the combined wind farm 2402, PV farm 2502, and LODES system 2404 power plant 2600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2600, the LODES system 2404 may be used to reshape and “firm” the power produced by the wind farm 2402 and the PV farm 2502. In one such example, the wind farm 2402 may have a peak generation output (capacity) of 126 MW and a capacity factor (CF) of 41% and the PV farm 2502 may have a peak generation output (capacity) of 126 MW and a capacity factor (CF) of 24%. The LODES system 2404 may have a power rating (capacity) of 63 MW, a rated duration (energy/power ratio) of 150 h, and an energy rating of 9,450 MWh. In another such example, the wind farm 2402 may have a peak generation output (capacity) of 170 MW and a capacity factor (CF) of 41% and the PV farm 2502 may have a peak generation output (capacity) of 110 MW and a capacity factor (CF) of 24%. The LODES system 2404 may have a power rating (capacity) of 57 MW, a rated duration (energy/power ratio) of 200 h, and an energy rating of 11,400 MWh. In another such example, the wind farm 2402 may have a peak generation output (capacity) of 105 MW and a capacity factor (CF) of 51% and the PV farm 2502 may have a peak generation output (capacity) of 70 MW and a capacity factor (CF) of 31 The LODES system 2404 may have a power rating (capacity) of 61 MW, a rated duration (energy/power ratio) of 150 h, and an energy rating of 9,150 MWh. In another such example, the wind farm 2402 may have a peak generation output (capacity) of 135 MW and a capacity factor (CF) of 41% and the PV farm 2502 may have a peak generation output (capacity) of 90 MW and a capacity factor (CF) of 24%. The LODES system 2404 may have a power rating (capacity) of 68 MW, a rated duration (energy/power ratio) of 50 h, and an energy rating of 3,400 MWh. In another such example, the wind farm 2402 may have a peak generation output (capacity) of 144 MW and a capacity factor (CF) of 41% and the PV farm 2502 may have a peak generation output (capacity) of 96 MW and a capacity factor (CF) of 24%. The LODES system 2404 may have a power rating (capacity) of 72 MW, a rated duration (energy/power ratio) of 25 h, and an energy rating of 1,800 MWh.

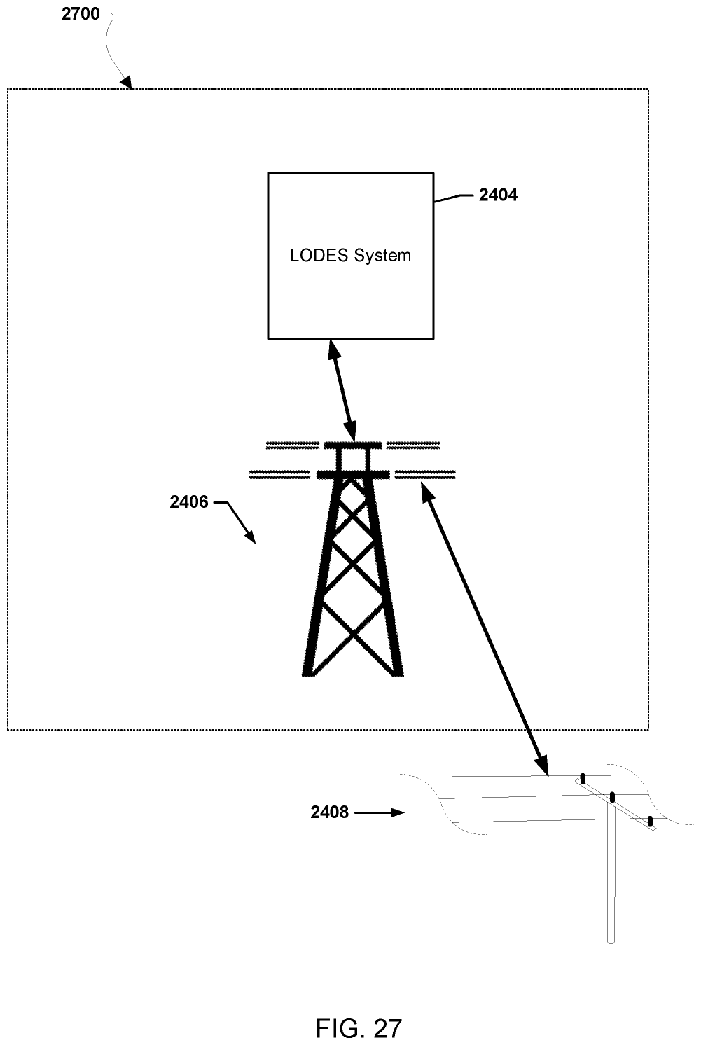

FIG. 27 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to one or more transmission facilities 2406. In this manner, the LODES system 2404 may operate in a “stand-alone” manner to arbiter energy around market prices and/or to avoid transmission constraints. The LODES system 2404 may be electrically connected to one or more transmission facilities 2406. The transmission facilities 2406 may be electrically connected to the grid 2408. The LODES system 2404 may store power received from the transmission facilities 2406. The LODES system 2404 may output stored power to the transmission facilities 2406. The transmission facilities 2406 may output power received from the LODES system 2404 to the grid 2408 and/or may receive power from the grid 2408 and output that power to the LODES system 2404.

Together the LODES system 2404 and the transmission facilities 2406 may constitute a power plant 900. As an example, the power plant 900 may be situated downstream of a transmission constraint, close to electrical consumption. In such an example downstream situated power plant 2700, the LODES system 2404 may have a duration of 24 h to 500 h and may undergo one or more full discharges a year to support peak electrical consumptions at times when the transmission capacity is not sufficient to serve customers. Additionally in such an example downstream situated power plant 2700, the LODES system 2404 may undergo several shallow discharges (daily or at higher frequency) to arbiter the difference between nighttime and daytime electricity prices and reduce the overall cost of electrical service to customer. As a further example, the power plant 2700 may be situated upstream of a transmission constraint, close to electrical generation. In such an example upstream situated power plant 2700, the LODES system 2404 may have a duration of 24 h to 500 h and may undergo one or more full charges a year to absorb excess generation at times when the transmission capacity is not sufficient to distribute the electricity to customers. Additionally in such an example upstream situated power plant 2700, the LODES system 2404 may undergo several shallow charges and discharges (daily or at higher frequency) to arbiter the difference between nighttime and daytime electricity prices and maximize the value of the output of the generation facilities.

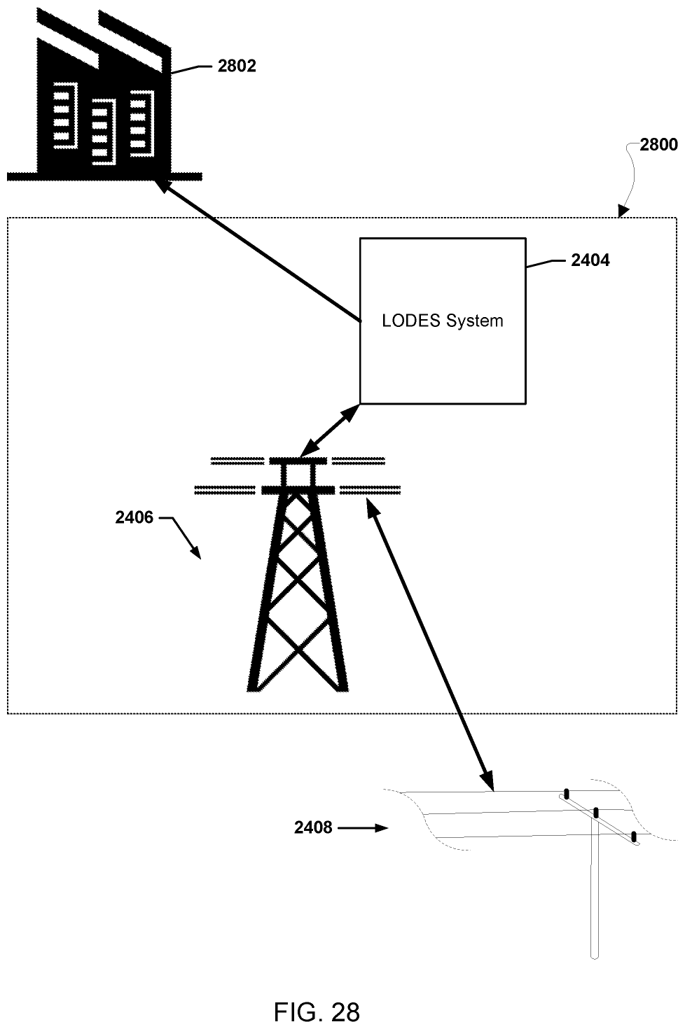

FIG. 28 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a commercial and industrial (C&I) customer 2802, such as a data center, factory, etc. The LODES system 2404 may be electrically connected to one or more transmission facilities 2406. The transmission facilities 2406 may be electrically connected to the grid 2408. The transmission facilities 2406 may receive power from the grid 2408 and output that power to the LODES system 2404. The LODES system 2404 may store power received from the transmission facilities 2406. The LODES system 2404 may output stored power to the C&I customer 2802. In this manner, the LODES system 2404 may operate to reshape electricity purchased from the grid 2408 to match the consumption pattern of the C&I customer 2802.

Together, the LODES system 2404 and transmission facilities 2406 may constitute a power plant 2800. As an example, the power plant 2800 may be situated close to electrical consumption, i.e., close to the C&I customer 2802, such as between the grid 2408 and the C&I customer 2802. In such an example, the LODES system 2404 may have a duration of 24 h to 500 h and may buy electricity from the markets and thereby charge the LODES system 2404 at times when the electricity is cheaper. The LODES system 2404 may then discharge to provide the C&I customer 2802 with electricity at times when the market price is expensive, therefore offsetting the market purchases of the C&I customer 2802. As an alternative configuration, rather than being situated between the grid 2408 and the C&I customer 2802, the power plant 2800 may be situated between a renewable source, such as a PV farm, wind farm, etc., and the transmission facilities 2406 may connect to the renewable source. In such an alternative example, the LODES system 2404 may have a duration of 24 h to 500 h, and the LODES system 2404 may charge at times when renewable output may be available. The LODES system 2404 may then discharge to provide the C&I customer 2802 with renewable generated electricity so as to cover a portion, or the entirety, of the C&I customer 2802 electricity needs.

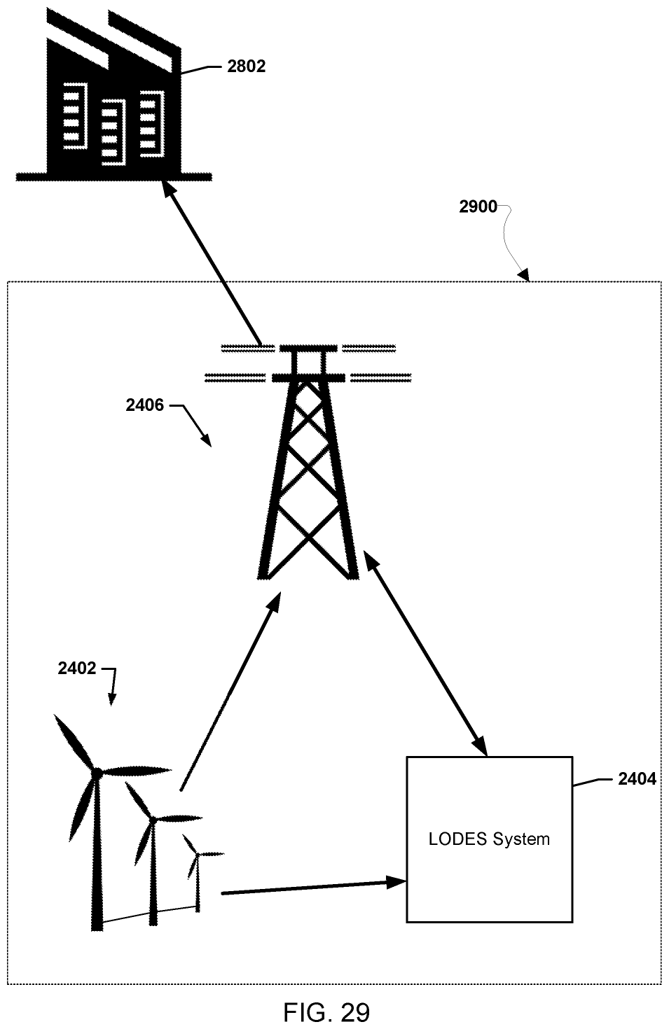

FIG. 29 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to a C&I customer 2802. The wind farm 2402 may generate power and the wind farm 2402 may output generated power to the LODES system 2404 and/or the transmission facilities 2406. The LODES system 2404 may store power received from the wind farm 2402.

The LODES system 2404 may output stored power to the transmission facilities 2406. The transmission facilities 2406 may output power received from one or both of the wind farm 2402 and LODES system 2404 to the C&I customer 2802. Together the wind farm 2402, the LODES system 2404, and the transmission facilities 2406 may constitute a power plant 2900 that may be a combined power generation, transmission, and storage system. The power generated by the wind farm 2402 may be directly fed to the C&I customer 2802 through the transmission facilities 2406, or may be first stored in the LODES system 2404. In certain cases, the power supplied to the C&I customer 2802 may come entirely from the wind farm 2402, entirely from the LODES system 2404, or from a combination of the wind farm 2402 and the LODES system 2404. The LODES system 2404 may be used to reshape the electricity generated by the wind farm 2402 to match the consumption pattern of the C&I customer 2802. In one such example, the LODES system 2404 may have a duration of 24 h to 500 h and may charge when renewable generation by the wind farm 2402 exceeds the C&I customer 2802 load. The LODES system 2404 may then discharge when renewable generation by the wind farm 2402 falls short of C&I customer 2802 load so as to provide the C&I customer 2802 with a firm renewable profile that offsets a fraction, or all of, the C&I customer 2802 electrical consumption.

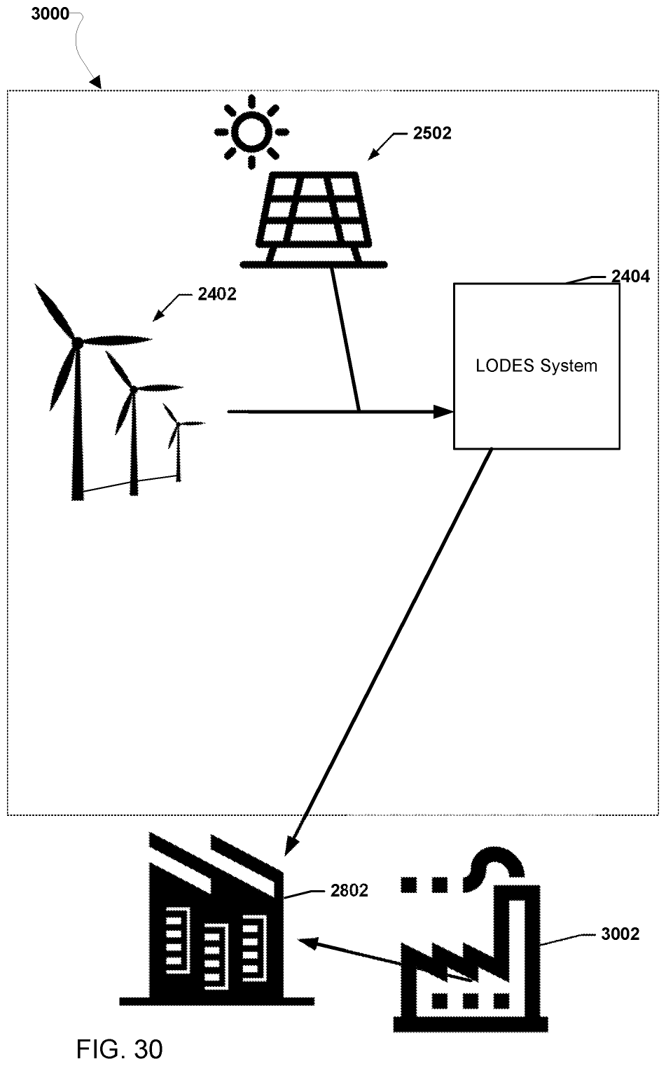

FIG. 30 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be part of a power plant 3000 that is used to integrate large amounts of renewable generation in microgrids and harmonize the output of renewable generation by, for example a PV farm 2502 and wind farm 2402, with existing thermal generation by, for example a thermal power plant 3002 (e.g., a gas plant, a coal plant, a diesel generator set, etc., or a combination of thermal generation methods), while renewable generation and thermal generation supply the C&I customer 2802 load at high availability. Microgrids, such as the microgrid constituted by the power plant 3000 and the thermal power plant 3002, may provide availability that is 90% or higher. The power generated by the PV farm 2502 and/or the wind farm 2402 may be directly fed to the C&I customer 2802, or may be first stored in the LODES system 2404.

In certain cases the power supplied to the C&I customer 2802 may come entirely from the PV farm 2502, entirely from the wind farm 2402, entirely from the LODES system 2404, entirely from the thermal power plant 3002, or from any combination of the PV farm 2502, the wind farm 2402, the LODES system 2404, and/or the thermal power plant 3002. As examples, the LODES system 2404 of the power plant 3000 may have a duration of 24 h to 500 h. As a specific example, the C&I customer 2802 load may have a peak of 100 MW, the LODES system 2404 may have a power rating of 14 MW and duration of 150 h, natural gas may cost $6/million British thermal units (MMBTU), and the renewable penetration may be 58%. As another specific example, the C&I customer 2802 load may have a peak of 100 MW, the LODES system 2404 may have a power rating of 25 MW and duration of 150 h, natural gas may cost $8/MMBTU, and the renewable penetration may be 65%.

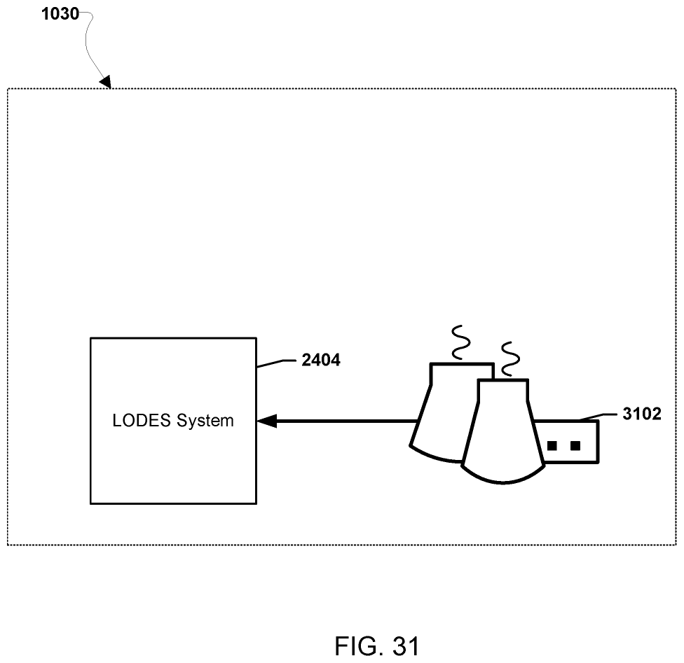

FIG. 31 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be used to augment a nuclear plant 3102 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 3100 constituted by the combined LODES system 2404 and nuclear plant 3102. The nuclear plant 3102 may operate at high capacity factor and at the highest efficiency point, while the LODES system 2404 may charge and discharge to effectively reshape the output of the nuclear plant 3102 to match a customer electrical consumption and/or a market price of electricity. As examples, the LODES system 2404 of the power plant 3100 may have a duration of 24 h to 500 h. In one specific example, the nuclear plant 3102 may have 1,000 MW of rated output and the nuclear plant 3102 may be forced into prolonged periods of minimum stable generation or even shutdowns because of depressed market pricing of electricity. The LODES system 2404 may avoid facility shutdowns and charge at times of depressed market pricing; and the LODES system 2404 may subsequently discharge and boost total output generation at times of inflated market pricing.

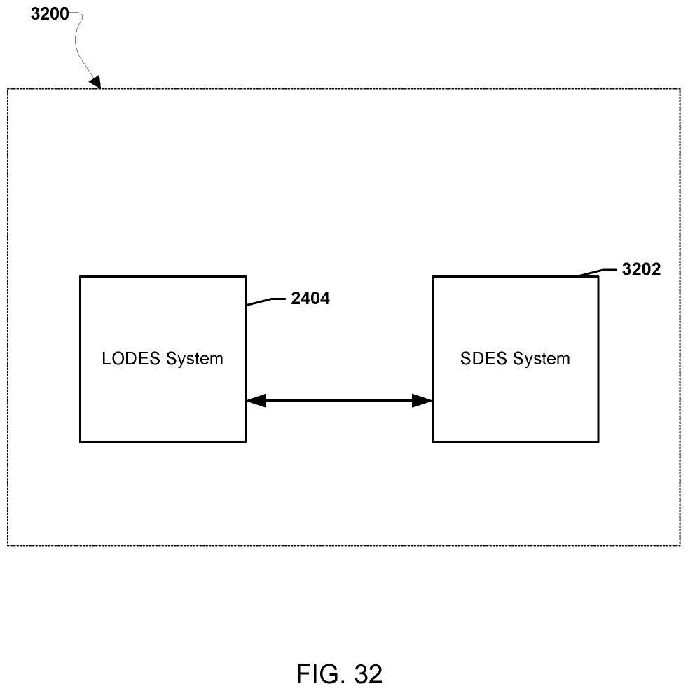

FIG. 32 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may operate in tandem with a SDES system 3202. Together the LODES system 2404 and SDES system 3202 may constitute a power plant 3200. As an example, the LODES system 2404 and SDES system 3202 may be co-optimized whereby the LODES system 2404 may provide various services, including long-duration back-up and/or bridging through multi-day fluctuations (e.g., multi-day fluctuations in market pricing, renewable generation, electrical consumption, etc.), and the SDES system 3202 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 3202 may have durations of less than 10 hours and round-trip efficiencies of greater than 80%. The LODES system 2404 may have durations of 24 h to 500 h and round-trip efficiencies of greater than 40%. In one such example, the LODES system 2404 may have a duration of 150 hours and support customer electrical consumption for up to a week of renewable under-generation. The LODES system 2404 may also support customer electrical consumption during intra-day under-generation events, augmenting the capabilities of the SDES system 3202. Further, the SDES system 3202 may supply customers during intra-day under-generation events and provide power conditioning and quality services such as voltage control and frequency regulation.

Various embodiments may include a battery, comprising: a first electrode, comprising a manganese oxide; an electrolyte; and a second electrode, comprising iron. In some embodiments, the iron comprises direct reduced iron (DRI). In some embodiments, the electrolyte is a liquid electrolyte. In some embodiments, the electrolyte comprises an alkali metal hydroxide comprising lithium hydroxide (LiOH), sodium hydroxide (NaOH), potassium hydroxide (KOH), cesium hydroxide (CsOH), or mixtures thereof. In some embodiments, the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof. In some embodiments, the second electrode is pelletized and comprises a multimodal distribution. In some embodiments, the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof. In some embodiments, the second electrode further comprises iron oxides, hydroxides, sulfides or mixtures thereof. In some embodiments, the second electrode further comprises one or more secondary phases including silica (SiO₂) or silicates, calcium oxide (CaO), magnesium oxide (MgO) or mixtures thereof. In some embodiments, the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof. In some embodiments, the second electrode further comprises one or more hydrogen evolution reaction suppressants. In some embodiments, the first electrode has a specific surface area less than about 50 m²/g. In some embodiments, the first electrode has a specific surface area less than about 1 m²/g. In some embodiments, the second electrode has a specific surface area less than about 5 m²/g. In some embodiments, the second electrode has a specific surface area less than about 1 m²/g. In some embodiments, the first electrode comprises a binder comprising polytetrafluoroethylene (PTFE), polyvinylidene difluoride (PVdF), polypropylene (PP), polyethylene (PE), fluorinated ethylene propylene (FEP), polyacrylonitrile, styrene butadiene rubber, carboxymethyl cellulose (CMC), sodium carboxymethyl cellulose (Na-CMC), polyvinyl alcohol (PVA), polypyrrole (PPy), or combinations thereof. In some embodiments, the first electrode comprises an additive comprising bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof. In some embodiments, a separator material is used between the first electrode and the second electrode. In some embodiments, the iron comprises concentrate. In some embodiments, the iron comprises at least one form of iron selected from the group consisting of pellets, BF grade pellets, DR grade pellets, hematite, magnetite, wustite, martite, goethite, limonite, siderite, pyrite, ilmenite, or spinel manganese ferrite. In some embodiments, the iron comprises iron ore. In some embodiments, the iron ore comprises at least 0.1% SiO₂ by mass. In some embodiments, the iron ore comprises at least 0.1% CaO by mass. In some embodiments, the iron comprises atomized iron powder. In some embodiments, the iron comprises iron agglomerates. In some embodiments, the iron agglomerates have an average length ranging from about 50 um to about 50 mm. In some embodiments, the iron agglomerates have an average internal porosity ranging from about 10% to about 90% by volume. In some embodiments, the iron agglomerates have an average specific surface area ranging from about 0.1 m²/g to about 25 m²/g. In some embodiments, the electrolyte comprises a molybdate anion and a sulfide anion.

Various embodiments may include a bulk energy storage system, comprising: a stack of one or more batteries, wherein at least one of the one or more batteries comprises: a first electrode, comprising a manganese oxide; an electrolyte; and a second electrode, comprising iron. In some embodiments, the bulk energy storage system is a long duration energy storage (LODES) system. In some embodiments, the iron comprises direct reduced iron (DRI). In some embodiments, the electrolyte is a liquid electrolyte. In some embodiments, the electrolyte comprises an alkali metal hydroxide comprising lithium hydroxide (LiOH), sodium hydroxide (NaOH), potassium hydroxide (KOH), cesium hydroxide (CsOH), or mixtures thereof. In some embodiments, the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof. In some embodiments, the second electrode is pelletized and comprises a multimodal distribution. In some embodiments, the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof. In some embodiments, the second electrode further comprises iron oxides, hydroxides, sulfides or mixtures thereof. In some embodiments, the second electrode further comprises one or more secondary phases including silica (SiO₂) or silicates, calcium oxide (CaO), magnesium oxide (MgO) or mixtures thereof. In some embodiments, the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof. In some embodiments, the second electrode further comprises one or more hydrogen evolution reaction suppressants. In some embodiments, the first electrode comprises an additive comprising bismuth (III) oxide (B₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof. In some embodiments, the iron comprises iron ore. In some embodiments, the iron ore comprises at least 0.1% SiO₂ by mass. In some embodiments, the iron ore comprises at least 0.1% CaO by mass. In some embodiments, the iron comprises iron agglomerates.

Various embodiments may include a method of making a battery, comprising: providing a first electrode comprising a manganese oxide; providing a second electrode, comprising direct reduced iron; and providing an electrolyte located between the first electrode and the second electrode. In some embodiments, the electrolyte comprises a liquid electrolyte.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

What is claimed is:

1. A battery, comprising:
a first electrode, comprising a manganese oxide;
an electrolyte; and
a second electrode, comprising iron.

2. The battery of claim 1, wherein the iron comprises direct reduced iron (DRI).

3. The battery of claim 1, wherein the electrolyte is a liquid electrolyte.

4. The battery of claim 3, wherein the electrolyte comprises an alkali metal hydroxide comprising lithium hydroxide (LiOH), sodium hydroxide (NaOH), potassium hydroxide (KOH), cesium hydroxide (CsOH), or mixtures thereof.

5. The battery of claim 4, wherein the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof.

6. The battery of claim 1, wherein the second electrode is pelletized and comprises a multimodal distribution.

7. The battery of claim 1, wherein the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof.

8. The battery of claim 1, wherein the second electrode further comprises iron oxides, hydroxides, sulfides or mixtures thereof.

9. The battery of claim 1, wherein the second electrode further comprises one or more secondary phases including silica (SiO₂) or silicates, calcium oxide (CaO), magnesium oxide (MgO) or mixtures thereof.

10. The battery of claim 1, wherein the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof.

11. The battery of claim 1, wherein the second electrode further comprises one or more hydrogen evolution reaction suppressants.

12. The battery of claim 1, wherein the first electrode has a specific surface area less than about 50 m²/g.

13. The battery of claim 1, wherein the first electrode has a specific surface area less than about 1 m²/g.

14. The battery of claim 1, wherein the second electrode has a specific surface area less than about 5 m²/g.

15. The battery of claim 1, wherein the second electrode has a specific surface area less than about 1 m²/g.

16. The battery of claim 1, wherein the first electrode comprises a binder comprising polytetrafluoroethylene (PTFE), polyvinylidene difluoride (PVdF), polypropylene (PP), polyethylene (PE), fluorinated ethylene propylene (FEP), polyacrylonitrile, styrene butadiene rubber, carboxymethyl cellulose (CMC), sodium carboxymethyl cellulose (Na-CMC), polyvinyl alcohol (PVA), polypyrrole (PPy), or combinations thereof.

17. The battery of claim 1, wherein the first electrode comprises an additive comprising bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof.

18. The battery of claim 1, wherein a separator material is used between the first electrode and the second electrode.

19. The battery of claim 1, wherein the iron comprises concentrate.

20. The battery of claim 1, wherein the iron comprises at least one form of iron selected from the group consisting of pellets, BF grade pellets, DR grade pellets, hematite, magnetite, wustite, martite, goethite, limonite, siderite, pyrite, ilmenite, or spinel manganese ferrite.

21. The battery of claim 1, wherein the iron comprises iron ore.

22. The battery of claim 21, wherein the iron ore comprises at least 0.1% SiO₂ by mass.

23. The battery of claim 21, wherein the iron ore comprises at least 0.1% CaO by mass.

24. The battery of claim 1, wherein the iron comprises atomized iron powder.

25. The battery of claim 1, wherein the iron comprises iron agglomerates.

26. The battery of claim 25, wherein the iron agglomerates have an average length ranging from about 50 um to about 50 mm.

27. The battery of claim 25, wherein the iron agglomerates have an average internal porosity ranging from about 10% to about 90% by volume.

28. The battery of claim 25, wherein the iron agglomerates have an average specific surface area ranging from about 0.1 m²/g to about 25 m²/g.

29. The battery of claim 25, wherein the electrolyte comprises a molybdate anion and a sulfide anion.

30. A bulk energy storage system, comprising:
a stack of one or more batteries, wherein at least one of the one or more batteries comprises:
a first electrode, comprising a manganese oxide;
an electrolyte; and
a second electrode, comprising iron.

31. The bulk energy storage system of claim 30, wherein the bulk energy storage system is a long duration energy storage (LODES) system.

32. The bulk energy storage system of claim 31, wherein the iron comprises direct reduced iron (DRI).

33. The bulk energy storage system of claim 31, wherein the electrolyte is a liquid electrolyte.

34. The bulk energy storage system of claim 33, wherein the electrolyte comprises an alkali metal hydroxide comprising lithium hydroxide (LiOH), sodium hydroxide (NaOH), potassium hydroxide (KOH), cesium hydroxide (CsOH), or mixtures thereof.

35. The bulk energy storage system of claim 34, wherein the electrolyte comprises alkali metal sulfide or polysulfide comprising lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or mixtures thereof.

36. The bulk energy storage system of claim 31, wherein the second electrode is pelletized and comprises a multimodal distribution.

37. The bulk energy storage system of claim 31, wherein the manganese oxide comprises manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or mixtures thereof.

38. The bulk energy storage system of claim 31, wherein the second electrode further comprises iron oxides, hydroxides, sulfides or mixtures thereof.

39. The bulk energy storage system of claim 31, wherein the second electrode further comprises one or more secondary phases including silica (SiO₂) or silicates, calcium oxide (CaO), magnesium oxide (MgO) or mixtures thereof.

40. The bulk energy storage system of claim 31, wherein the second electrode further comprises an inert conductive matrix comprising carbon black, activated carbon, graphite powder, carbon steel mesh, stainless steel mesh, steel wool, nickel-coated carbon steel mesh, nickel-coated stainless steel mesh, nickel-coated steel wool, or mixtures thereof.

41. The bulk energy storage system of claim 31, wherein the second electrode further comprises one or more hydrogen evolution reaction suppressants.

42. The bulk energy storage system of claim 31, wherein the first electrode comprises an additive comprising bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, nitrogen-doped carbon nanotubes, nitrogen-doped carbon nanofibers, nitrogen-doped graphene, or combinations thereof.

43. The bulk energy storage system of claim 31, wherein the iron comprises iron ore.

44. The bulk energy storage system of claim 43, wherein the iron ore comprises at least 0.1% SiO₂ by mass.

45. The bulk energy storage system of claim 43, wherein the iron ore comprises at least 0.1% CaO by mass.

46. The bulk energy storage system of claim 31, wherein the iron comprises iron agglomerates.

47. A method of making a battery, comprising:
providing a first electrode comprising a manganese oxide;
providing a second electrode, comprising direct reduced iron; and
providing an electrolyte located between the first electrode and the second electrode.

48. The method of claim 47, wherein the electrolyte comprises a liquid electrolyte.
